(19) United States
(12) Patent Application Publication
(10) Pub. No.: US 2024/0176818 A1
(43) Pub. Date: May 30, 2024

(54) CONTENT PLAYBACK SYSTEM, INFORMATION PROCESSING APPARATUS, AND CONTENT PLAYBACK CONTROLLING APPLICATION

(71) Applicant: SONY GROUP CORPORATION, Tokyo (JP)

(72) Inventors: Myungjin JUNG, Tokyo (JP); Asae IMAMURA, Tokyo (JP); Hideo NAGASAKA, Tokyo (JP); Yuji KAWABE, Tokyo (JP); Kazumasa HASHIMOTO, Tokyo (JP)

(73) Assignee: SONY GROUP CORPORATION, Tokyo (JP)

(21) Appl. No.: 18/551,949

(22) PCT Filed: Mar. 29, 2022
(86) PCT No.: PCT/JP2022/015307

§ 371 Date: Sep. 22, 2023

(30) Foreign Application Priority Data
Mar. 30, 2021 (JP) 2021-056342
Jun. 3, 2021 (WO) PCT/JP2021/021261
Nov. 29, 2021 (WO) PCT/JP2021/043551
Feb. 24, 2022 (WO) PCT/JP2022/007708
Mar. 22, 2022 (WO) PCT/JP2022/013225

(51) Int. Cl. G06F 16/687; G01S 19/01; G06F 16/635

(52) U.S. Cl. CPC G06F 16/687; G01S 19/01; G06F 16/636

(57) ABSTRACT

To provide a content playback system, an information processing apparatus, and a content playback controlling application that control output to a user properly regardless of state. A content playback system includes a wearable device; and an information processing apparatus that includes a control circuit that executes a content playback controlling application that includes a user state estimator that estimates a user state of a user who is wearing the wearable device, an environment estimator that estimates an environment state for the user on the basis of the user state, and a content controller that generates, on the basis of the environment state, a cue used by a content provision application providing content to select the content, outputs the cue to the content provision application, and causes the content provision application to select the content on the basis of the cue to cause the content to be played back.

### TECHNICAL FIELD

The present disclosure relates to a content playback system, an information processing apparatus, and a content playback controlling application that control output to a user.

### BACKGROUND ART

There is a technology that performs sound recognition on speech and environmental sound, selects content such as a piece of music on the basis of the recognized sound, and outputs the selected content (Patent Literature 1).

### CITATION LIST

### Patent Literature

Patent Literature 1: U.S. patent Ser. No. 10/891,948
Patent Literature 2: U.S. Pat. No. 9,398,361
Patent Literature 3: Japanese Patent Application Laid-open No. 2010-56589
Patent Literature 4: Japanese Patent Application Laid-open No. 2011-209162

### DISCLOSURE OF INVENTION

### Technical Problem

The technology that performs sound recognition on speech and environmental sound can only be applied to an environment in which sound is produced. Thus, there is a possibility that proper content will not be selected by a user who does not want to produce sound, or in a state in which sound is not allowed to be produced. Further, there is a need for a high computational performance to perform natural language processing. This results in difficulty in performing processing locally.

In view of the circumstances described above, it is an object of the present disclosure to provide a content playback system, an information processing apparatus, and a content playback controlling application that control output to a user properly regardless of state.

### Solution to Problem

A content playback system according to an embodiment of the present disclosure includes:
a wearable device; and
an information processing apparatus that includes a control circuit that executes a content playback controlling application that includes
   a user state estimator that estimates a user state of a user who is wearing the wearable device,
   an environment estimator that estimates an environment state for the user on the basis of the user state, and
   a content controller that
      generates, on the basis of the environment state, a cue used by a content provision application providing content to select the content,
      outputs the cue to the content provision application, and
      causes the content provision application to select the content on the basis of the cue to cause the content to be played back.

This enables the content provision application to play back proper content without there being no need for a user to actively perform selection.

The control circuit of the information processing apparatus may execute a plurality of the content provision applications different from each other, and
on the basis of the environment state, the content controller may select a specified one of the plurality of the content provision applications that is caused to play back the content.

This makes it possible to provide a user experience obtained by integrating services provided by the different content provision applications of the plurality of different content provision applications, without there being no need for a user to actively perform selection.

The control circuit of the information processing apparatus may execute a plurality of the content provision applications different from each other,
the wearable device may include an input apparatus, and
on the basis of one of different operations that is input by the user to the wearable device, the content controller may select a specified one of the plurality of the content provision applications that is caused to play back the content.

This makes it possible to provide a user experience obtained by integrating services provided by the different content provision applications of the plurality of different content provision applications, without there being no need for a user to actively perform selection.

The control circuit of the information processing apparatus may execute a preset application that assigns the different operations of a plurality of the different operations to selections of the content provision applications of the plurality of the content provision applications different from each other.

The preset application may be included in the content playback controlling application.

For example, the preset application can preassign the different operations to selections of the different content provision applications of the plurality of different content provision applications. The different operations (such as a single tap, a double tap, a triple tap, and pressing of radio buttons) input by a user to the input apparatus of the wearable device are reassigned to selections of the different content provision applications of the plurality of different content provision applications.

The wearable device may include a sensor section,
the content playback controlling application may further include
   a user location estimator that estimates a user location on the basis of a detection value input by the sensor section included in the wearable device worn by the user, and
   a location attribute estimator that estimates, on the basis of the user location, a location attribute that is an attribute of a location at which the user is, and
the user state estimator may estimate the user state on the basis of the location attribute.

The present embodiment makes it possible to control output to a user properly regardless of a state such as a state in which sound is not allowed to be produced, on the basis of a location of the user in a house and other user contexts.

The sensor section included in the wearable device may include at least one of an acceleration sensor, a gyroscope, a compass, a biological sensor, or a geomagnetic sensor.

The inside of a house is relatively narrow, which is different from the outdoors. Thus, there is generally a need for external equipment such as a high-accuracy beacon or camera in order to estimate a specific location in the house. On the other hand, the present embodiment makes it possible to specify, without external equipment, a location in a house using the acceleration sensor, the gyroscope, and/or the compass that are mounted on the wearable device.

The content provision application
may select a plurality of pieces of candidate content on the basis of the cue, and
may select a piece of playback-target content from the plurality of pieces of candidate content on the basis of the detection value input by the sensor section.

During the playback of the content, the content provision application may select an attribute of playback-target content on the basis of the detection value input by the sensor section to play back the selected content.

The content provision application may select a plurality of pieces of candidate content on the basis of a cue output from the content playback controlling application, and may select a piece of playback-target content from the plurality of pieces of candidate content on the basis of a detection value input by the sensor section of the wearable device. Further, the content provision application may select, for example, content with a fast tempo matched to a running speed of a user, on the basis of a detection value input by the sensor section.

the content controller may generate, on the basis of the environment state, a cue used by the content provision application to stop the playback of the content, may output the cue to the content provision application, and may cause the content provision application to stop the playback of the content on the basis of the cue.

For example, in some cases, it is better if music is stopped due to a change in state such as start of a meeting. The content playback controlling application can detect such a state to transmit a stop instruction to the content provision application.

The content playback controlling application may further include a context acquisition section that acquires a context of the user, and
the user state estimator may estimate the user state on the basis of the acquired context.

The user state can be estimated more accurately by estimating the user state not only on the basis of a location attribute but also on the basis of a context of a user.

The user location estimator may include
an angle correction section that calculates a correction value for an azimuth corresponding to the user on the basis of the detection value detected by the sensor section included in the wearable device worn by the user, and
an angle estimator that estimates the azimuth corresponding to the user on the basis of the detection value detected by the sensor section included in the wearable device worn by the user, and on the basis of the correction value, and
the user location estimator may estimate the user location using the azimuth.

An angle at which the wearable device is worn differs depending on each user. Thus, an angle formed by a sensor axis of each of the acceleration sensor and the gyroscope differs depending on each user. Thus, the user location estimator can estimate, for each user, an angle formed by the sensor axis of the sensor section, and can estimate an orientation (an angle) with a high degree of accuracy using the estimated angle as a correction value, without depending on an individual difference.

The sensor section included in the wearable device may include an acceleration sensor, and
the angle correction section
   may calculate an inclination of the user in a pitch direction and an inclination of the user in a roll direction, using gravitational acceleration that corresponds to the detection value detected by the acceleration sensor and occurs when the user faces the roll direction,
   may calculate an inclination of the user in a yaw direction using gravitational acceleration that corresponds to the detection value detected by the acceleration sensor and occurs when the user faces the pitch direction, and using the inclination in the pitch direction and the inclination in the roll direction, and
   may determine, to be the correction values, the inclination in the pitch direction, the inclination in the roll direction, and the inclination in the yaw direction.

According to the present embodiment, a correction value for an azimuth corresponding to a user can be calculated only using an acceleration sensor. This makes it possible to calculate the correction value even in an environment with fewer mounted sensors. This makes it possible to reduce costs, to reduce power consumption, and to make an apparatus smaller.

The content controller may successively play back related pieces of content for respective environment states that are identical to each other but provided for different periods of time.

The content playback system may further include:
a database generator that associates a registration-use detection value detected by the sensor section with an environment state to be provided to the user when the registration-use detection value is detected, and registers the associated registration-use detection value and environment state; and
a matching section that checks a new detection value detected by the sensor section against the registered registration-use detection value to perform matching, and determines whether a difference between the new detection value and the registration-use detection value is less than or equal to a matching threshold, in which
when the difference is determined to be less than or equal to the matching threshold, the content controller may generate the cue on the basis of the environment state registered in association with the registration-use detection value, and may output the generated cue.

When the user is at a stop for a first period of time, the matching section may check the new detection value with the registration-use detection value to perform matching, and
when a period of time for which the user is at a stop from the user stopping to the user starting moving is longer than a second period of time, the database generator may associate the new detection value detected for the period of time from the user stopping to the user starting moving with an environment state to be provided to the user when the new detection value is detected, and may newly register the associated new detection value and environment state.

The database generator may register, as the registration-use detection value, an average of a plurality of the detection values detected by the sensor section for a specified period of time.

A content playback system according to an embodiment of the present disclosure includes:
a wearable device; and
an information processing apparatus that includes a control circuit that executes a content playback controlling application that includes
   a database generator that associates a registration-use detection value detected by a sensor section included in the wearable device worn by a user with an environment state to be provided to the user when the registration-use detection value is detected, and registers the associated registration-use detection value and environment state,
   a matching section that checks a new detection value detected by the sensor section against the registered registration-use detection value to perform matching, and determines whether a difference between the new detection value and the registration-use detection value is less than or equal to a matching threshold, and
   a content controller that
      generates, when the difference is determined to be less than or equal to the matching threshold, a cue on the basis of the environment state registered in association with the registration-use detection value, the cue being used by a content provision application providing content to select the content,
      outputs the cue to the content provision application, and
      causes the content provision application to select the content on the basis of the cue to cause the content to be played back.

An information processing apparatus according to an embodiment of the present disclosure includes
a control circuit that executes a content playback controlling application that includes
   a user state estimator that estimates a user state of a user who is wearing a wearable device,
   an environment estimator that estimates, on the basis of the user state, an environment state to be provided to the user, and
   a content controller that
      generates, on the basis of the environment state, a cue used by a content provision application providing content to select the content,
      outputs the cue to the content provision application, and
      causes the content provision application to select the content on the basis of the cue to cause the content to be played back.

A content playback controlling application according to an embodiment of the present disclosure causes a control circuit of an information processing apparatus to operate as
a user state estimator that estimates a user state of a user who is wearing a wearable device,
an environment estimator that estimates, on the basis of the user state, an environment state to be provided to the user, and
a content controller that
   generates, on the basis of the environment state, a cue used by a content provision application providing content to select the content,
   outputs the cue to the content provision application, and
   causes the content provision application to select the content on the basis of the cue to cause the content to be played back.

### BRIEF DESCRIPTION OF DRAWINGS

FIG. 1 illustrates a configuration of an information processing system according to an embodiment of the present disclosure.

FIG. 2 schematically illustrates a worn wearable device.

FIG. 3 schematically illustrates an individual difference in worn wearable device.

FIG. 4 schematically illustrates an idea of an angle correction.

FIG. 5 illustrates a flow of an operation of an angle correction section.

FIG. 6 schematically illustrates movement of a user.

FIG. 7 schematically illustrates an idea of angle correction.

FIG. 8 illustrates specific processing performed by the angle correction section.

FIG. 9 illustrates a specific calculation example.

FIG. 10 illustrates a relationship between initial frames.

FIG. 11 illustrates a method for specifying a frontal side in a natural state.

FIG. 12 is a diagram used to describe processing performed by a location estimator.

FIG. 13 illustrates an example of applying the processing performed by the location estimator.

FIG. 14 illustrates an example of recognizing the processing performed by the location estimator.

FIG. 15 illustrates a flow of an operation of the location estimator.

FIG. 16 illustrates an additional flow of the operation of the location estimator.

FIG. 17 illustrates an operation performed when routes are identified as being the same route in different ways of walking.

FIG. 18 illustrates a modification of a method for location estimation performed by the location estimator.

FIG. 19 is a flow performed to estimate, from a context, an environment state to be provided to a user.

FIG. 20 illustrates an operation of a user state estimator.

FIG. 21 illustrates a mapping relationship between a context and a user state.

FIG. 22 illustrates a method for determination of a user state that is performed by the user state estimator.

FIG. 23 illustrates an operation of an environment estimator.

FIG. 24 illustrates an operation of a content controller of an output controller.

FIG. 25 illustrates an operation of a notice controller of the output controller.

FIG. 26 illustrates a configuration of a content playback system according to the present embodiment.

FIG. 27 illustrates an example of a GUI of a preset application.

FIG. 28 illustrates a flow of an operation of a content playback controlling application.

FIG. 29 illustrates an example of a table used to select a content provision application.

FIG. 30 illustrates a functional configuration of an angle correction section according to an embodiment.

FIG. 31 illustrates a flow of an operation of the angle correction section.

FIG. 32 illustrates a definition of a device coordinate system.

FIG. 33 illustrates a method for obtaining an angle β.

FIG. 34 illustrates a gravity axis when a user faces the front.

FIG. 35 illustrates a gravity axis when the user faces downward.

FIG. 36 illustrates calculation of a yaw rotation that is performed using measurement data, and a measurement singularity.

FIG. 37 illustrates a flowchart used to determine whether a condition is satisfied.

FIG. 38 illustrates a definition of a yaw rotation, with a front direction being used as a reference.

FIG. 39 illustrates an impact that an upward and downward movement and a bend angle have on a calculation result.

FIG. 40 illustrates a selection of a playlist according to a scene.

FIG. 41 illustrates an example of successively playing a playlist set for scenes that are identical to each other but occur for separate periods of time.

FIG. 42 illustrates another example of a user experiencing content suitable for a scene.

FIG. 43 illustrates a first implementation (a content control application controls the content provision application).

FIG. 44 illustrates a second implementation (the content control application records information regarding content last played back in a scene, and specifies a content ID for each context).

FIG. 45 illustrates an example of switching between playlists according to a scene and suggesting a playlist according to a scene.

FIG. 46 illustrates an example of a method for acquiring content information.

FIG. 47 illustrates a state in which one playlist is successively played for scenes that are identical to each other but occur for different periods of time.

FIG. 48 illustrates an example of a table of the content playback controlling application.

FIG. 49 illustrates an example of a table of the content playback controlling application.

FIG. 50 illustrates an idea of characteristics of a user front end.

FIG. 51 is a diagram used to describe characteristics of a user front end using a search as an example.

FIG. 52 is a diagram used to describe characteristics of a user front end according to the present embodiment.

FIG. 53 is a diagram used to describe the characteristics of the user front end according to the present embodiment.

FIG. 54 illustrates a state in which a playlist is specified by a creator.

FIG. 55 illustrates a method for providing content suitable for a scene.

FIG. 56 illustrates a method for playing back music content when a user wants to hear.

FIG. 57 illustrates an example of dynamically changing pieces of content on the basis of a tag.

FIG. 58 illustrates a configuration of an information processing system according to another embodiment of the present disclosure.

FIG. 59 illustrates an overview of a registration-and-matching section.

FIG. 60 illustrates a configuration of the registration-and-matching section.

FIG. 61 illustrates a flow of an operation of processing of registration and checking.

FIG. 62 illustrates an example of a GUI used for registration and checking.

FIG. 63 illustrates an example of an instruction screen displayed on a smartphone and used to give an instruction to move the head.

FIG. 64 illustrates an example of an instruction screen displayed on a personal computer and used to give an instruction to move the head.

FIG. 65 illustrates a flow of an operation of performing registration for a plurality of locations.

FIG. 66 illustrates an example of a GUI used to perform registration for a plurality of locations.

FIG. 67 illustrates a flow of an operation of additional registration performed using buttons.

FIG. 68 illustrates a flow of an operation of additional registration performed using a layout.

FIG. 69 illustrates a flow of an operation of automatically performed additional registration.

FIG. 70 illustrates a method (using a table) that includes registering a registration-use detection value and performing matching.

FIG. 71 illustrates a method (using machine learning) that includes registering a registration-use detection value and performing matching.

FIG. 72 illustrates calculation of an average.

FIG. 73 schematically illustrates an example of an algorithm for the user state estimator and the environment estimator.

FIG. 74 schematically illustrates the example of the algorithm for the user state estimator and the environment estimator.

### MODE(S) FOR CARRYING OUT THE INVENTION

Embodiments according to the present disclosure will now be described below with reference to the drawings.

### 1. Configuration of Information Processing System

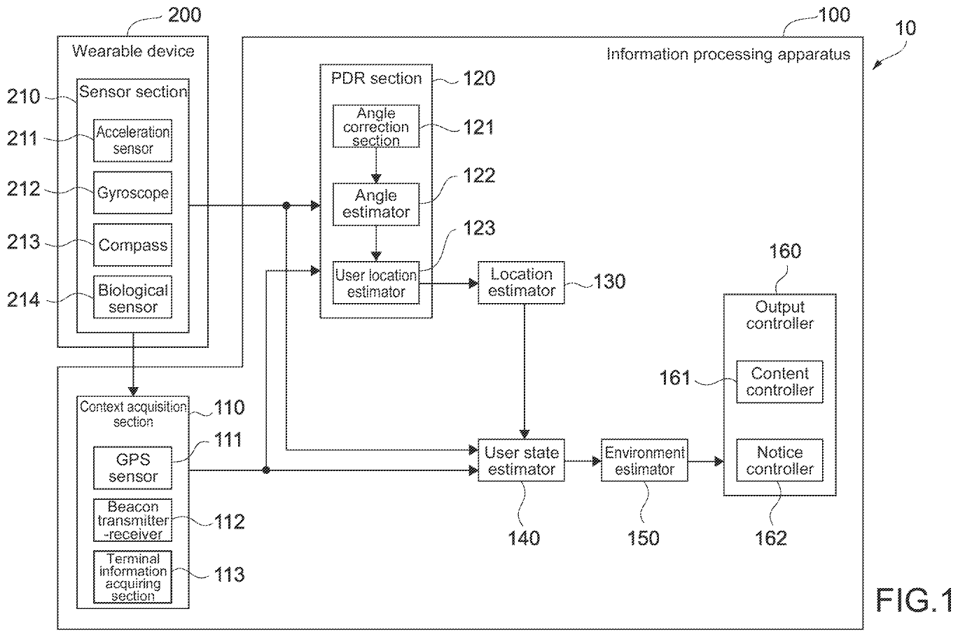

FIG. 1 illustrates a configuration of an information processing system according to an embodiment of the present disclosure.

An information processing system 10 includes an information processing apparatus 100 and a wearable device 200.

The information processing apparatus 100 is a terminal apparatus, such as a smartphone, a tablet computer, or a personal computer, that is used by an end user. The information processing apparatus 100 is connected to a network such as the Internet.

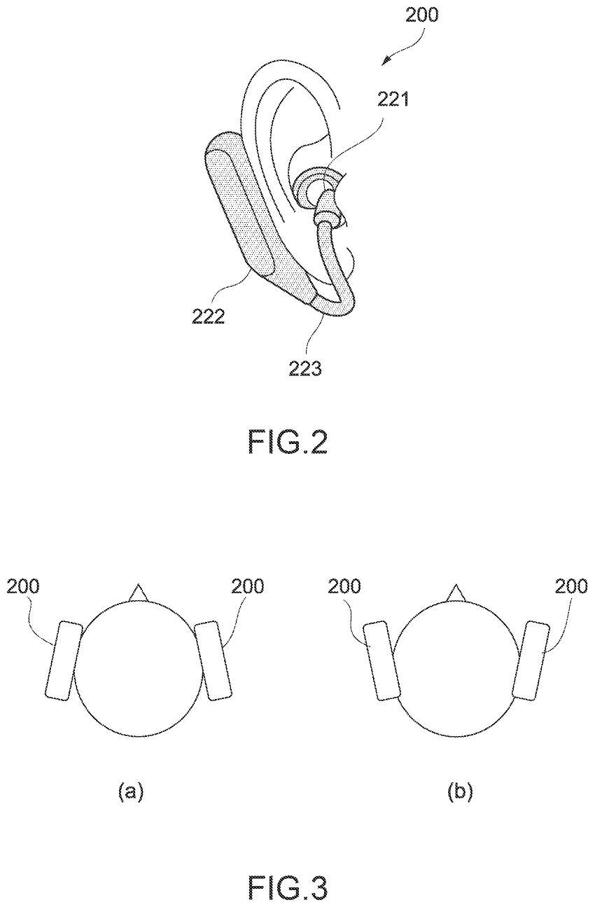

The wearable device 200 is a device used by being worn on a head of a user. Typically, the wearable device 200 is a wireless earphone (FIG. 2), but may be, for example, a wireless headphone, a wired headphone, a wired earphone, or a head-mounted display (HMD) for augmented reality (AR) or virtual reality (VR). Further, FIG. 2 illustrates an open-ear earphone with which the ear is not completely plugged up. However, the wearable device 200 may be, for example, an in-the-ear canal earphone, a hearing aid, or a sound collector. The information processing apparatus 100 and the wearable device 200 are connected to each other to be capable of communicating with each other using various kinds of near-field communication such as Bluetooth (registered trademark) (specifically, Bluetooth Low Energy (BLE), Generic Attribute Profile (GATT)) or Wi-Fi (registered trademark). The wearable device 200 includes a sensor section 210. The sensor section 210 includes an acceleration sensor 211 that detects acceleration, a gyroscope 212 that detects angular velocity, and a compass 213 that detects an azimuth. The sensor section 210 further includes a biological sensor 214 such as a heartbeat sensor, a blood flow sensor, and a brain wave sensor. The sensor section 210 may further include a geomagnetic sensor. The wearable device 200 supplies the information processing apparatus 100 with a detection value detected by the sensor section 210.

In the information processing apparatus 100, a processor such as a CPU of a control circuit operates as a context acquisition section 110, a pedestrian dead reckoning (PDR) section 120 (a user location estimator), a location estimator 130 (a location attribute estimator), a user state estimator 140, an environment estimator 150, and an output controller 160 by loading, into a RAM, an information processing program recorded in a ROM and executing the information processing program.

The context acquisition section 110 acquires a context of a user. The context of a user includes location information and terminal information. Here, the context refers to, for example, a sensor value acquired from the sensor section 210 and schedule information regarding a schedule of a user that is acquired from a calendar app. The context acquisition section 110 includes apparatuses such as a GPS sensor 111 and a beacon transmitter-receiver 112 that acquire location information as a context. The context acquisition section 110 further includes a terminal information acquiring section 113 that acquires terminal information as a context. As the terminal information corresponding to a context, the terminal information acquiring section 113 acquires, for example, screen lock information (locked or unlocked), behavior information regarding the behavior of a user (such as running, a bicycle, at rest, walking, or on board), a location (a specific location or an unspecific location at home, at the office, or the like), calendar app information (having or not having a schedule for a meeting), time information (on duty or off duty), phone app information (on the phone), sound-recognition-app information (during speech), an automatic do-not-disturb (DND) setting (in a time frame or outside of the time frame), and a manual do-not-disturb (DND) setting (on or offline).

The PDR section 120 (a user location estimator) estimates a user location on the basis of detection values (acceleration, angular velocity, and an azimuth) detected by the sensor section 210 included in the wearable device 200 worn by the user. Specifically, the PDR section 120 includes an angle correction section 121, an angle estimator 122, and a user location estimator 123. The angle correction section 121 calculates a correction value for an azimuth corresponding to the user on the basis of detection values (acceleration, angular velocity, and an azimuth) detected by the sensor section 210 included in the wearable device 200 worn by the user. The angle estimator 122 estimates the azimuth corresponding to the user on the basis of the detection values (acceleration, angular velocity, and an azimuth) detected by the sensor section 210 included in the wearable device 200 worn by the user, and on the basis of the correction value. The user location estimator 123 uses the azimuth after correction to estimate the location of the user. Pedestrian dead reckoning (PDR) is a technology used to measure a relative location from a certain reference point on the basis of detection values from autonomously operating sensors of a plurality of autonomously operating sensors. In this example, on the basis of acceleration, angular velocity, and an azimuth that are respective detection values from the acceleration sensor 211, the gyroscope 212, and the compass 213, the PDR section 120 estimates a change in user location from a certain room to another room, that is, a route of movement of a user location.

The location estimator 130 (a location attribute estimator) estimates an attribute (a location attribute) of a location at which a user is, on the basis of a change in a user location estimated by the PDR section 120. In other words, the location estimator 130 estimates a location attribute after movement of a user on the basis of a movement route estimated by the PDR section 120. The location attribute refers to a portion, in a building, that is smaller than, for example, the building itself. The location attribute refers to, for example, a living room, a bedroom, a toilet, a kitchen, and a washroom in a house. Alternatively, the location attribute refers to, for example, a desk and a meeting room in a co-working space. However, the location attribute is not limited thereto, and the location attribute may represent, for example, a building itself, or may represent both a building itself and a portion in the building.

The user state estimator 140 estimates a user state on the basis of a context acquired by the context acquisition section 110, detection values (acceleration, angular velocity, and an azimuth) detected by the sensor section 210 included in the wearable device 200, and a location attribute estimated by the location estimator 130. The user state includes activity states of a user at a plurality of levels. For example, the user state includes activity states at four levels that respectively correspond to “break time”, “neutral”, “do not disturb (DND)”, and “offline”. “Break time” refers to a most relaxed state of activity, “neutral” refers to an ordinary state of activity, “DND” refers to a relatively busy state of activity, and “offline” refers to a busiest state of activity. Further, in addition to the four levels described above, any number of levels may be set in a system, or a user may be allowed to set the number of levels as appropriate.

The environment estimator 150 estimates an environment state to be provided to a user, on the basis of a user state estimated by the user state estimator 140. The environment estimator 150 may further estimate an environment state to be provided to a user, on the basis of a location attribute estimated by the location estimator 130. The environment state to be provided to a user is, for example, an environment state that enables the user to focus his/her mind (concentrate) or an environment state that enables the user to feel relaxed.

The output controller 160 controls output on the basis of an environment state estimated by the environment estimator 150. Specifically, the output controller 160 includes a content controller 161 and a notice controller 162. The content controller 161 plays back content (such as a piece of music and a video) that is selected on the basis of an environment state estimated by the environment estimator 150. For example, it is sufficient if the content controller 161 notifies an environment state to a digital service provider (DSP) through a network, receives content (such as content that enables a user to focus his/her mind or content that enables a user to feel relaxed) selected by the DSP on the basis of the notified environment state, and plays back the received content. The notice controller 162 controls the number of notices provided to a user, on the basis of the environment state. For example, the notice controller 162 may perform processing such as reducing the number of notices (such as a new-reception notice from an app or for a message) or stopping the notice such that the user can focus his/her mind, and causing a usual number of notices to be provided while the user is feeling relaxed.

### 2. Operation of Angle Correction Section of PDR Section

FIG. 2 schematically illustrates the worn wearable device.

Typically, the wearable device 200 is a wireless earphone. The wearable device 200, which is a wireless earphone, includes a speaker 221, a driver unit 222, and a sound tube 223 that connects the speaker 221 and the driver unit 222. The speaker 221 is inserted into an earhole to determine a position of the wearable device 200 relative to the ear, and the driver unit 222 is situated behind the ear. The sensor section 210 including the acceleration sensor 211 and the gyroscope 212 is included within the driver unit 222.

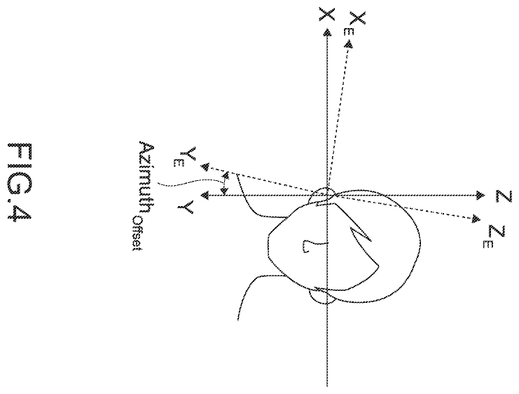

FIG. 3 schematically illustrates an individual difference in worn wearable device.

An angle that the driver unit 222 of the wearable device 200 forms with a frontal facial side differs depending on each user. Thus, an angle that a sensor axis of each of the acceleration sensor 211 and the gyroscope 212 of the sensor section 210 included within the driver unit 222 forms with a frontal facial side differs depending on each user. For example, a state in which the wearable device 200 is worn by a user by being shallowly inserted into an ear of the user is given in (a), and a state in which the wearable device 200 is immovably worn by a user by being deeply inserted into the ear of the user is given in (b). In some cases, a difference between the user of (a) and the user of (b) in an angle formed by a sensor axis with a frontal facial side is greater than or equal to 30 degrees. Thus, the PDR section 120 estimates, for each user, an angle formed by the sensor axis of the sensor section 210 with the frontal facial side, and estimates an orientation (an angle) of a face with a high degree of accuracy using the estimated angle as a correction value, without depending on an individual difference.

FIG. 4 schematically illustrates an idea of an angle correction.

With respect to an azimuth corresponding to the wearable device 200, there is the following relationship between an update value Azimuth_{E} obtained using sensor values acquired by the sensor section 210, and a difference Azimuth_{Offset} in an orientation relative to a frontal facial side that is obtained when the wearable device 200 is worn: “Azimuth=Azimuth_{E}+Azimuth_{Offset}”. Here, Azimuth_{E} is obtained from a three-dimensional pose obtained by summing sensor values acquired by the gyroscope 212 detecting angular velocity. On the other hand, Azimuth_{Offset} differs depending on each user, and thus is not measured only by the wearable device 200 being worn. Thus, there is a need to estimate Azimuth_{Offset} for each user.

In order to estimate a pose, two coordinate systems are defined in a state in which the two ears are horizontalized. A coordinate system (1) corresponds to a global frame (fixed), and is a coordinate system formed by a Z axis that is a perpendicular that extends upward over the head, an X axis that is formed by connecting the two ears and of which a right direction represents a positive value, and a Y axis orthogonal to the X axis and the Z axis. A coordinate system (2) corresponds to a sensor frame, and is a coordinate system (X_{E},Y_{E},Z_{E}) that is fixed relative to the sensor section 210 of the wearable device 200. A pose difference (Azimuth_{Offset}) that corresponds to a correction value represents an amount of rotation of the coordinate system (2) relative to the coordinate system (1).

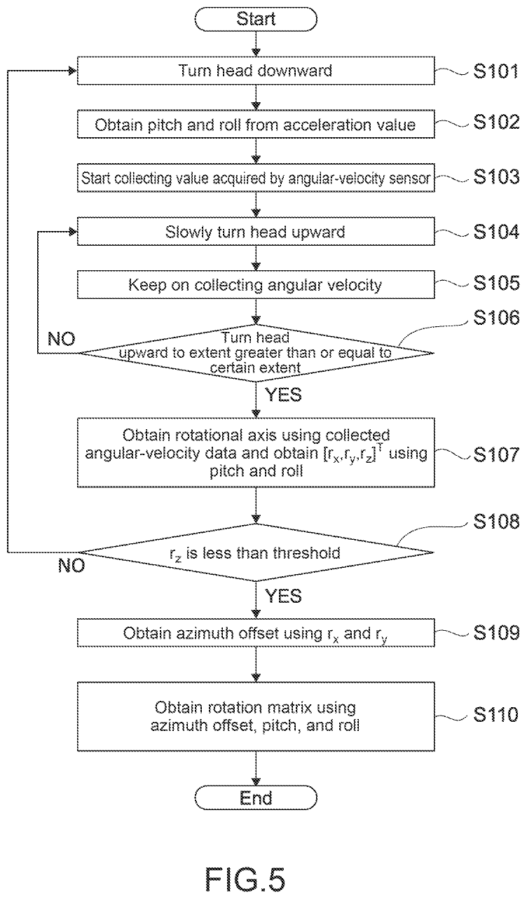

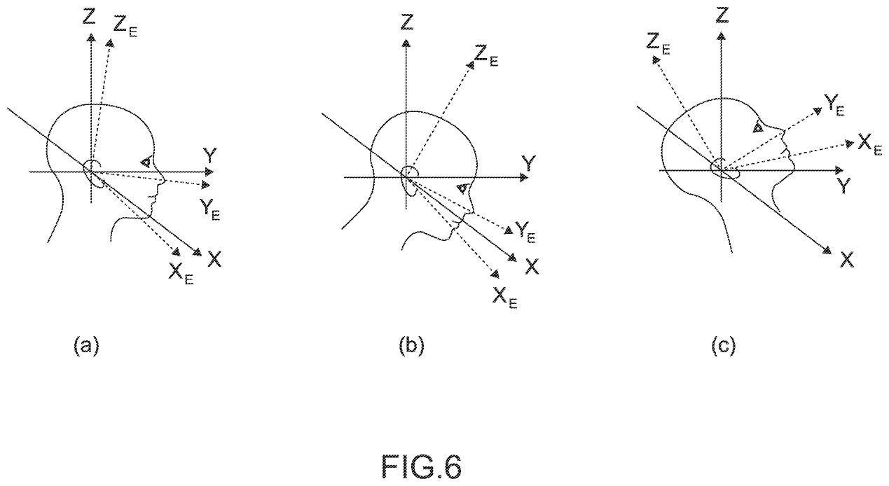

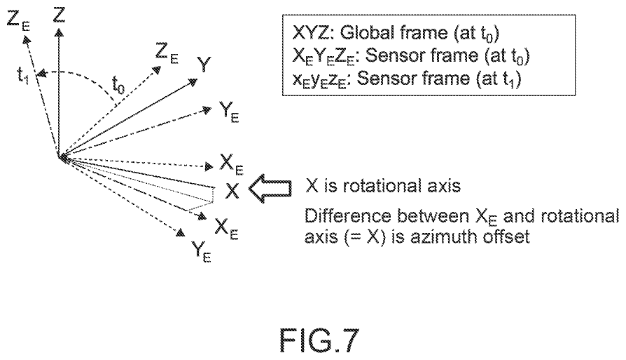

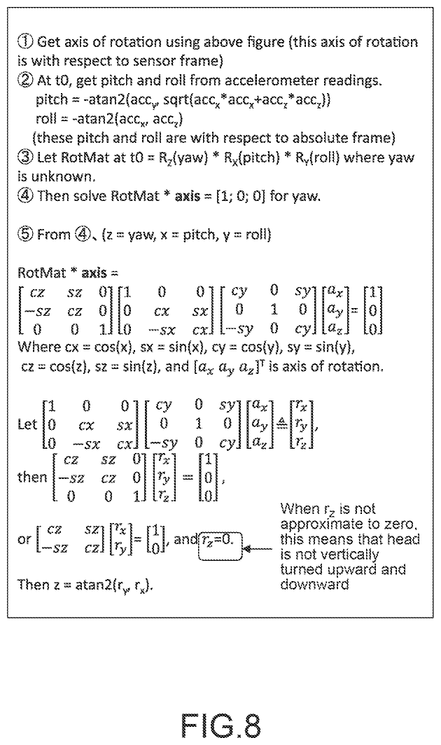

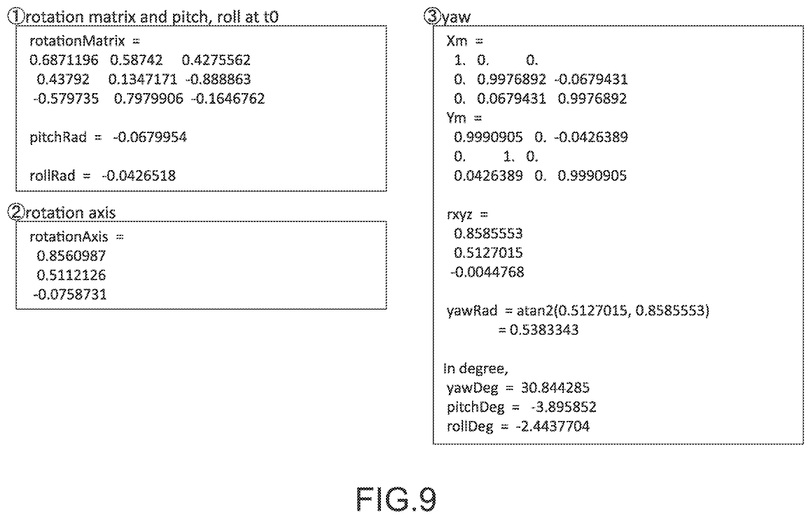

FIG. 5 illustrates a flow of an operation of the angle correction section. FIG. 6 schematically illustrates movement of a user. FIG. 7 schematically illustrates an idea of angle correction. FIG. 8 illustrates specific processing performed by the angle correction section. FIG. 9 illustrates a specific calculation example.

A user wears the wearable device 200, and turns his/her head downward from a state of facing the front ((a) of FIG. 6) to look obliquely downward in a front direction ((b) of FIG. 6) (Step S101). The angle correction section 121 calculates pitch and roll in the global-frame coordinate system (X,Y,Z) using a value of acceleration occurring when the head is turned downward (Step S102). The angle correction section 121 starts collecting a value of angular velocity acquired by the gyroscope 212. A point in time at this time is represented by t0 (Step S103) (the process of (2) in FIG. 8). Next, the user slowly turns his/her head upward to look obliquely upward in the front direction, such that the head is not moved from side to side ((c) of FIG. 6) (Step S104). The angle correction section 121 keeps on collecting the value of angular velocity acquired by the gyroscope 212 (Step S105). When the user turns his/her head upward to the very limits, the angle correction section 121 stops collecting the value of angular velocity acquired by the gyroscope 212. A point in time at this time is represented by t1 (Step S106, YES).

The angle correction section 121 obtains an axis of rotation [α_{X},α_{y},α_{z},]^{T} using the collected values of angular velocity acquired by the gyroscope 212. This axis of rotation is obtained with respect to the sensor axis. Next, the following is a rotation matrix (RotMat) at t0 that is defined by the angle correction section 121: “RotMat at t0=R_{Z}(yaw)*R_{X}(pitch)*R_{Y}(roll)”. RotMat is obtained with respect to a frontal facial side. R_{Z}(·), R_{X}(·), and R_{Y}(·) respectively represent rotation matrices of the Z axis, the Y axis, and the X axis. Pitch and roll with respect to a frontal facial side are obtained using an acceleration sensor, whereas yaw is unknown. The angle correction section 121 can calculate yaw using the following relationship: RotMat*axis=[1;0;0] (the process of (4) in FIG. 8). First, [r_{X},r_{y},r_{z}]^{T} is defined as RotMat*axis (Step S107). When r_{Z} is outside of a range of a threshold (when there is a great difference from zero), the angle correction section 121 fails in the calculation, and the processes are performed again (Step S108, NO). When r_{Z} is in the range of the threshold, the process moves on to the next step (Step S108, YES). The angle correction section 121 obtains a correction value (Azimuth_{Offset}) using r_{X} and r_{Y} (Step S109) (the process of (5) in FIG. 8). The angle correction section 121 obtains a rotation matrix (RotMat) using Azimuth_{Offset}, pitch, and roll (Step S110). RotMat is obtained with respect to an axis of a frontal facial side.

Next, a method for specifying a frontal side in a natural state, not in a state in which the head is turned downward, is described.

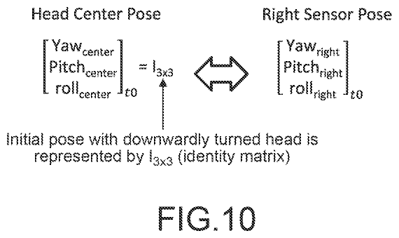

FIG. 10 illustrates a relationship between initial frames.

An initial pose (a head center pose) with a downwardly turned head is represented by I_{3×3} (an identity matrix). A pose of a sensor (referred to as a right sensor pose on the assumption that the sensor is worn in a right ear) is represented by Rₜ₀ (RotMat in FIG. 8).

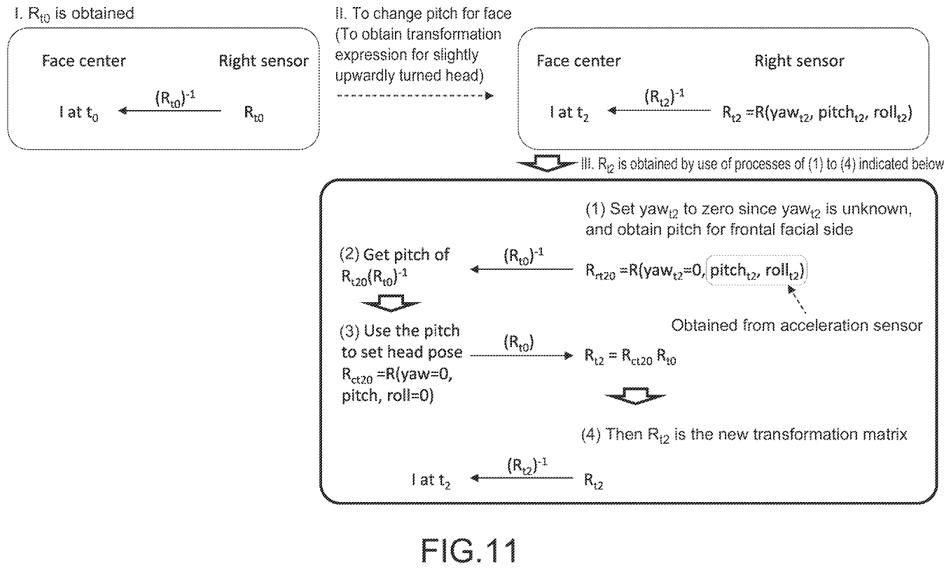

FIG. 11 illustrates a method for specifying a frontal side in a natural state.

If Rₜ₀, which represents a pose (the right sensor pose) of a right sensor, is obtained using the method in FIG. 9, a relational expression Rₜ₂ for a new pose can be obtained, without calculation, using Rₜ₀ and an acceleration-sensor value for the new pose by use of the method in FIG. 9 when pitch for a face is changed (that is, when a pose corresponding to a slightly upwardly turned head is used as a reference).

### 3. Operation of Location Estimator

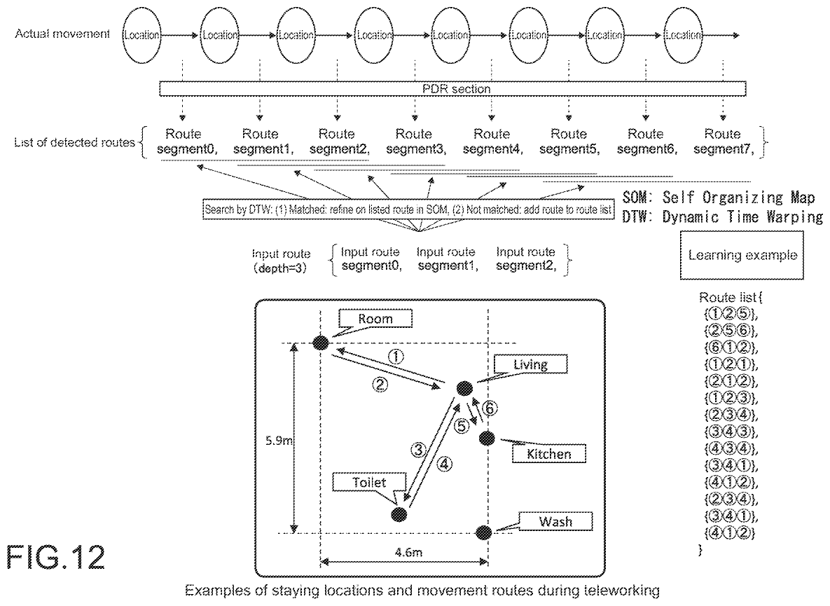

FIG. 12 is a diagram used to describe processing performed by the location estimator.

A user moves usually in a house wearing the wearable device 200. The location estimator 130 stores a pattern and an order of the movement. The number of locations to which the user moves in the house and a number for the order of the movement are often determined to be finite numbers. The location estimator 130 specifies a location from N (for example, N=3) most recent movement patterns.

In FIG. 12, (1) indicates a route for going to a bedroom (Room) from a living room (Living), (2) indicates a route for returning to the living room from the bedroom, (3) indicates a route for going to a toilet (Toilet) from the living room, (4) indicates a route for returning to the living room from the toilet (Toilet), (5) indicates a route for going to a kitchen (Kitchen) from the living room, and (6) indicates a route for returning to the living room from the kitchen.

For example, the use wears the wearable device 200, and starts working in the living room. After a while, the user goes to the toilet, then washes his/her hands in the washroom, and then returns to his/her desk. Then, after a while, the user moves to the kitchen for a drink, and returns to the living room with the drink. The following are movement patterns in this case. From the living room to the toilet (the route (3)). From the toilet to the living room (the route (4)). From the living room to the kitchen (the route (5)). From the kitchen to the living room (the route (6)).

The location estimator 130 stores the four patterns and an order of the patterns. When the user moves next time, a pattern of the movement is checked against the stored patterns to perform matching. The location estimator 130 can specify a location after the movement when the matching succeeds, and the location estimator 130 adds the movement pattern to a route list as a new pattern when the matching fails. The route list (on the right in FIG. 12) is a list that includes learned N (for example, N=3) most recent movement patterns. For example, the route list registers therein N (for example, N=3) most recent movement patterns such as a set of movement patterns of “(1) from the living room to the bedroom, (2) from the bedroom to the living room, and (5) from the living room to the kitchen” (in the uppermost line) and a set of “(2) from the bedroom to the living room, (5) from the living room to the kitchen, and (6) from the kitchen to the living room” (the second line from the top).

As described above, the location estimator 130 holds a plurality of movement routes, and performs matching by checking a movement route estimated by the PDR section 120 against the plurality of held movement routes. Accordingly, the location estimator 130 can estimate a location attribute (such as a living room, a bedroom, a toilet, a kitchen, and a washroom) after movement. Further, the location estimator 130 may estimate the location attribute by determining a staying period of time for which a user stays at a location at which the user is. The location attribute can be estimated more accurately by determining a staying period of time in addition to a movement route.

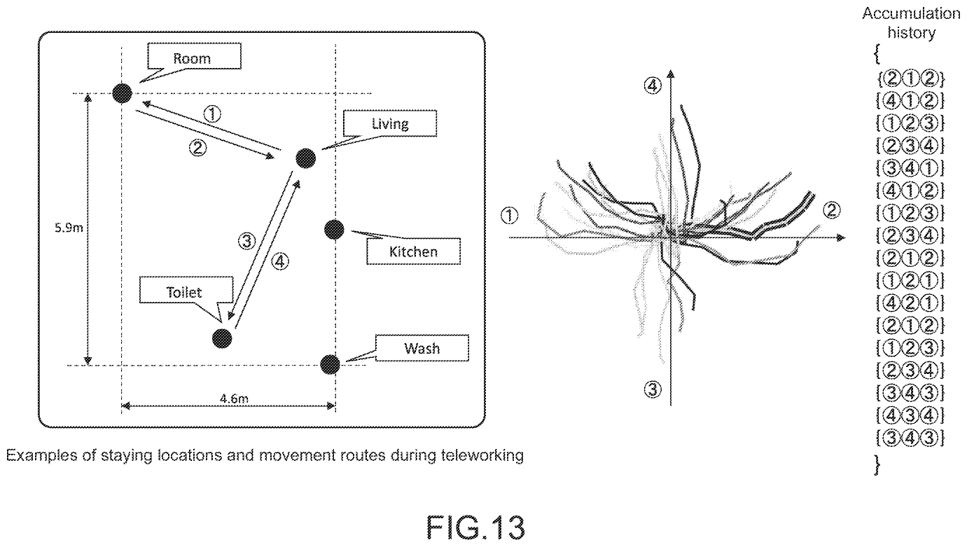

FIG. 13 illustrates an example of applying the processing performed by the location estimator.

Patterns for leaving the same departure point for the same destination in different ways of walking, may fail to be matched. Thus, learning is performed by adding the pattern as a stored pattern. Thus, a plurality of patterns is learned even for a movement between locations of the same pair of locations. A change in a location of a user is given in a coordinate system illustrated in FIG. 13, where an origin is defined as a departure point and the location of the user moving from the origin (the departure point) to another room is plotted regularly (for example, for each second). An axis of (1) represents a movement route from the living room (the origin) to the bedroom. An axis of (2) represents a movement route (a distance) from the bedroom (the origin) to the living room. An axis of (3) represents a movement route from the living room (the origin) to the toilet. An axis of (4) represents a movement route from the toilet (the origin) to the living room.

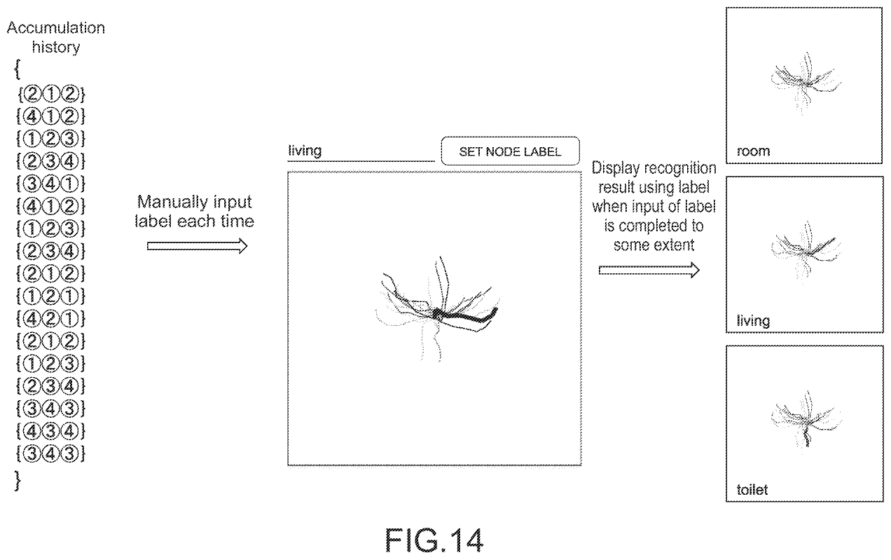

FIG. 14 illustrates an example of recognizing the processing performed by the location estimator.

The location estimator 130 assigns, to a route, a label used to indicate an attribute of the route when the location estimator 130 learns the route. This makes it possible to automatically display a label used to indicate an attribute when matching succeeds. Next, an operation of the location estimator 130 is more specifically described.

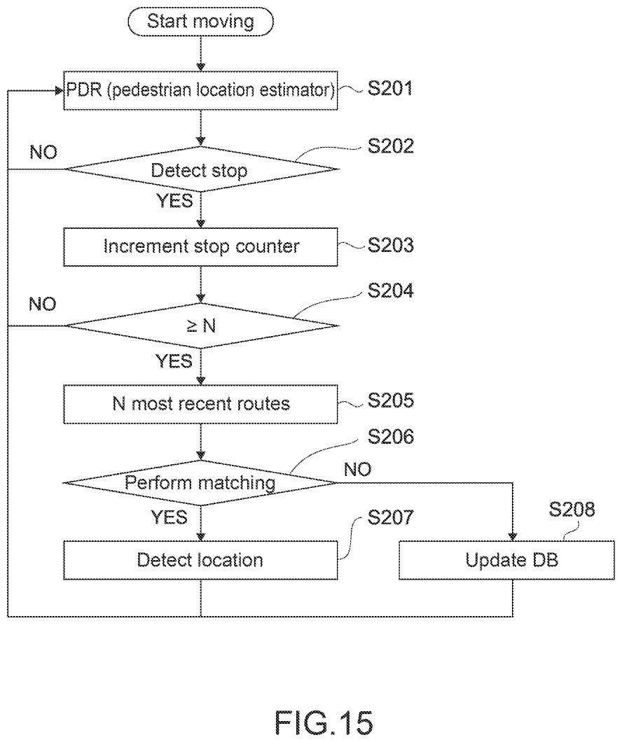

FIG. 15 illustrates a flow of the operation of the location estimator.

The PDR section 120 estimates a change in user location from a certain room to another room, that is, a route of movement of a user location (Step S201). The location estimator 130 detects that the user has stopped, on the basis of the change in user location that is detected by the PDR section 120 (Step S202, YES). The location estimator 130 increments (+1) a stop counter (Step S203). When the number of movements from a certain room to another room reaches N (for example, N=3) or more (Step S204, YES), the location estimator 130 performs matching by checking N (for example, N=3) most recent routes against a plurality of held movement routes (Step S205). When matching succeeds (Step S206, YES), the location estimator 130 specifies a location after movement (Step S207). On the other hand, when matching fails (Step S206, NO), the location estimator 130 adds the route to a route list as a new pattern (Step S208).

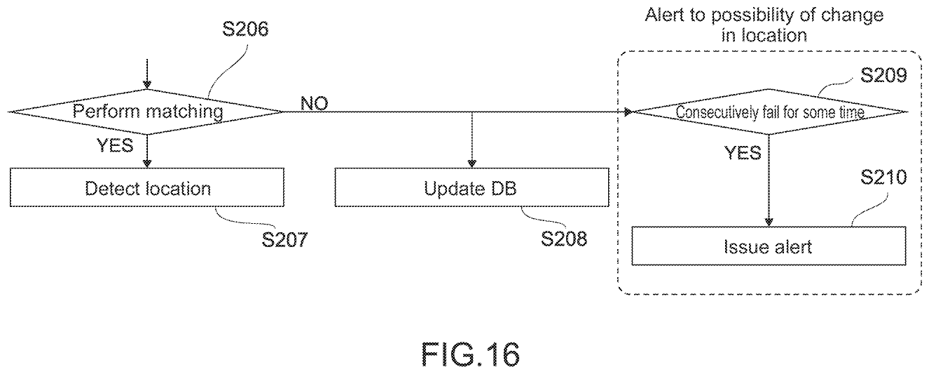

FIG. 16 illustrates an additional flow of the operation of the location estimator.

Here, there is a possibility that a movement route that is completely different from any of a plurality of held movement routes will be consecutively detected due to a user moving into a different building (such as a co-working space) from his/her own house. In this case, the location estimator 130 consecutively fails to perform matching (Step S206, NO) for some time (Step S209, YES). On the other hand, when the number of new movement routes sufficient to succeed in performing matching are accumulated in a route list (Step S208), matching succeeds (Step S206, YES), and this makes it possible to specify a location after movement (Step S207). When matching fails consecutively a specified number of times (Step S209, YES), the location estimator 130 outputs an alert indicating that the location may be another location that is not registered in the route list (Step S210). This makes it possible to notify a user that a location attribute after movement is to be estimated from a new movement route.

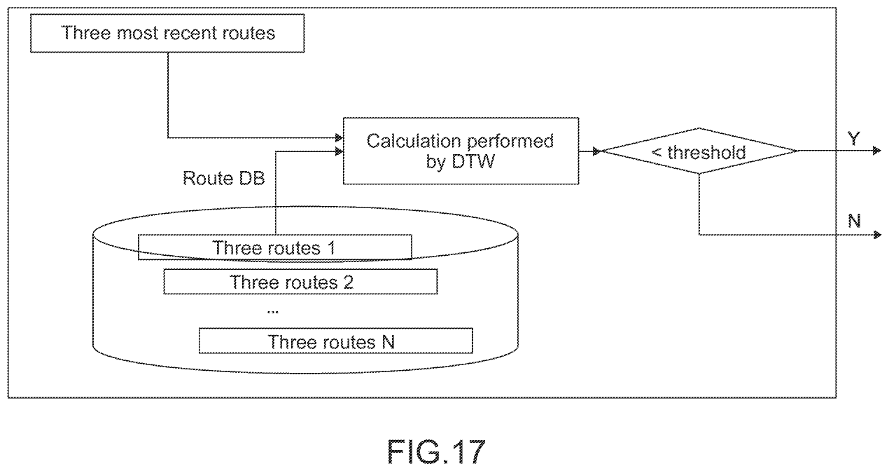

FIG. 17 illustrates an operation performed when routes are identified as being the same route in different ways of walking.

As described above, patterns for leaving the same departure point for the same destination in different ways of walking, may fail to be matched. Thus, learning is performed by adding the pattern as a stored pattern. A method for performing such learning is described. A distance between a set of N most recent routes and each of N patterns stored in a database is calculated by dynamic time warping (DTW), and the calculated distance is compared to a threshold. The dynamic time warping (DTW) is an approach used to measure a distance or similarity between pieces of time-series data. When ways of walking are different, a calculated distance or similarity may be greater than a threshold for DTW. In this case, the calculated distance or similarity is stored as other data.

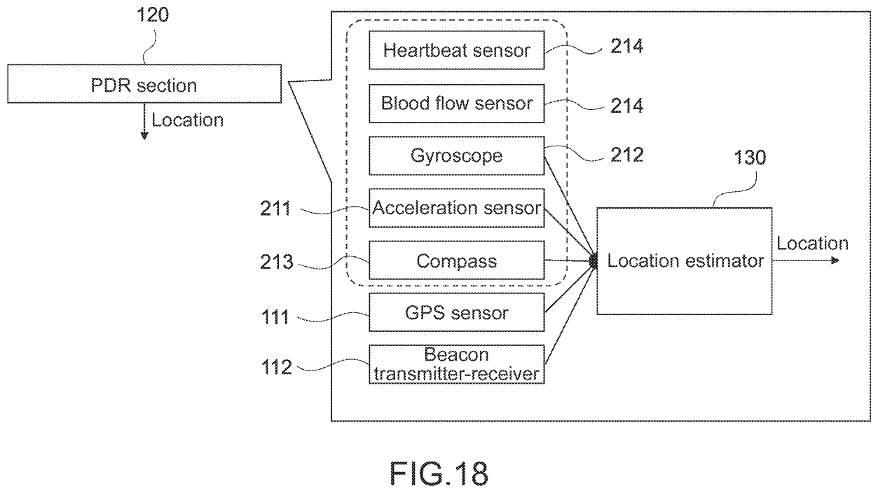

FIG. 18 illustrates a modification of the method for location estimation performed by the location estimator.

The location estimator 130 may estimate an attribute (a location attribute) of a location, outdoors in particular, at which a user is, on the basis of pieces of location information acquired by the GPS sensor 111 and the beacon transmitter-receiver 112. The location estimator 130 may estimate the attribute (a location attribute) of a location at which a user is, on the basis of biological information acquired by the biological sensor 214. For example, when it is determined, using the biological sensor 214 (such as a heartbeat sensor), that a user is falling asleep, the location estimator 130 may estimate a bedroom as a location attribute.

### 4. Operation of User State Estimator

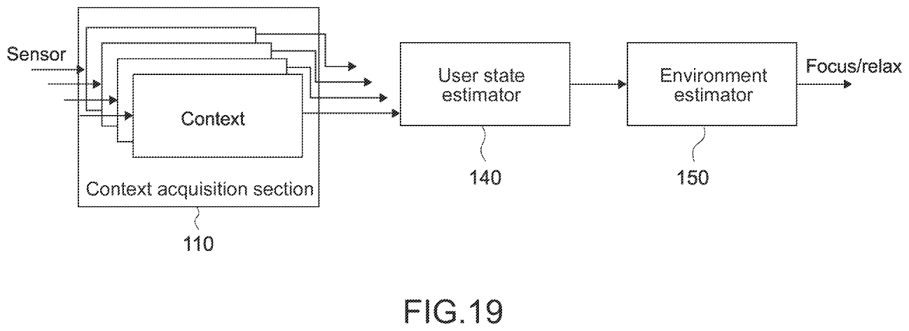

FIG. 19 is a flow performed to estimate, from a context, an environment state to be provided to a user.

The context acquisition section 110 acquires a context of a user. The user state estimator 140 estimates a user state on the basis of the context acquired by the context acquisition section 110, detection values (acceleration, angular velocity, and an azimuth) detected by the sensor section 210 included in the wearable device 200, and a location attribute estimated by the location estimator 130. The environment estimator 150 estimates an environment state to be provided to a user (such as “focus” (“concentration”) or “relax”).

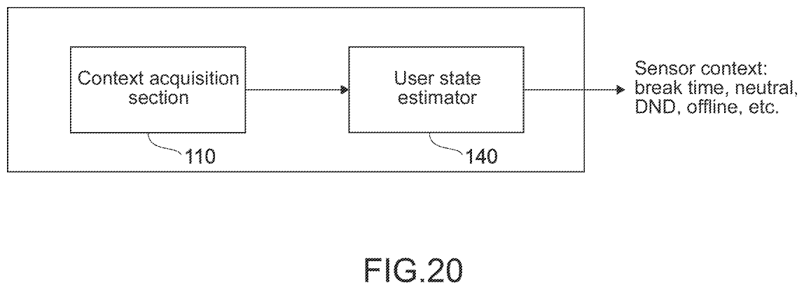

FIG. 20 illustrates an operation of the user state estimator.

The user state estimator 140 estimates a user state on the basis of a context acquired by the context acquisition section 110, detection values (acceleration, angular velocity, and an azimuth) detected by the sensor section 210 included in the wearable device 200, and a location attribute estimated by the location estimator 130. The context of a user includes location information and terminal information. Examples of the terminal information includes screen lock information (locked or unlocked), behavior information regarding the behavior of a user (such as running, a bicycle, at rest, walking, or on board), a location (a specific location or an unspecific location at home, at the office, or the like), calendar app information (having or not having a schedule for a meeting), time information (on duty or off duty), phone app information (on the phone), sound-recognition-app information (during speech), an automatic do-not-disturb (DND) setting (in a time frame or outside of the time frame), and a manual do-not-disturb (DND) setting (on or offline). The user state includes activity states of a user at a plurality of levels. For example, the user state includes activity states at four levels that respectively correspond to “break time”, “neutral”, “do not disturb (DND)”, and “offline”. “Break time” refers to a most relaxed state of activity, “neutral” refers to an ordinary state of activity, “DND” refers to a relatively busy state of activity, and “offline” refers to a busiest state of activity.

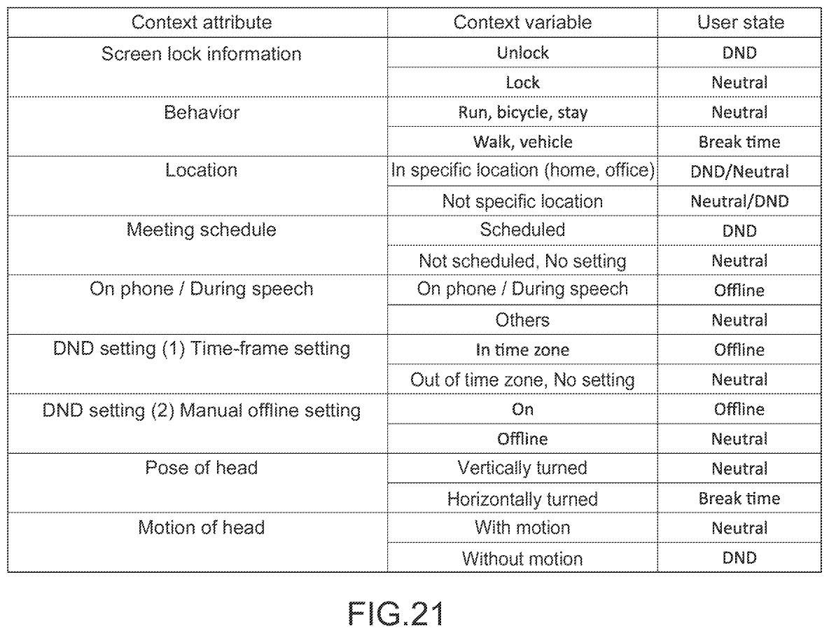

FIG. 21 illustrates a mapping relationship between a context and a user state.

The user state estimator 140 estimates a user state by mapping a context to the user state. For example, the user state estimator 140 estimates the user state to be “DND” when screen lock information that is a context is “unlocked”, and estimates the user state to be “neutral” when the screen lock information is “locked”. The user state estimator 140 estimates the user state for each context other than the screen lock information. Further, the context is not limited to what is illustrated in FIG. 21, and anything that represents a context may be adopted.

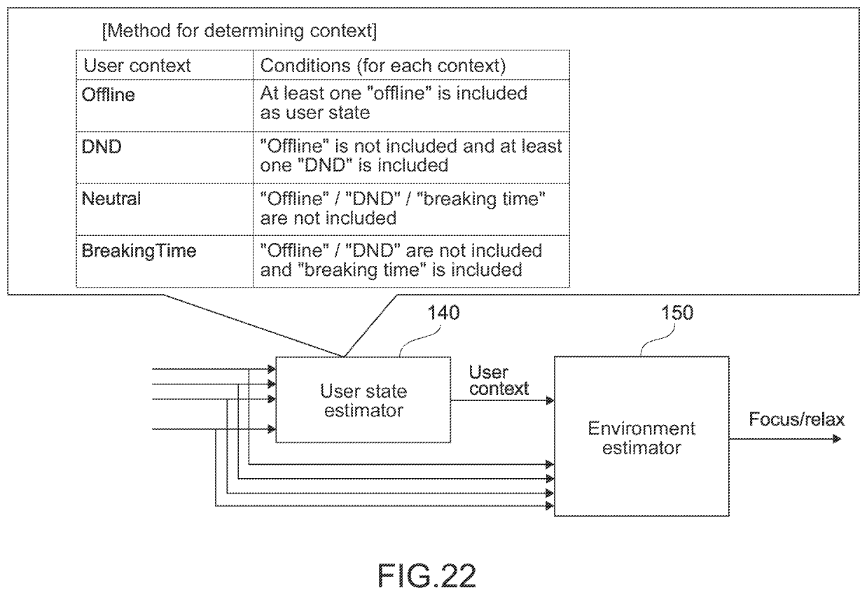

FIG. 22 illustrates a method for determination of a user state that is performed by the user state estimator.

The user state estimator 140 estimates the user state to be “offline” when at least one “offline” is included with respect to a plurality of contexts. The user state estimator 140 estimates the user state to be “DND” when “offline” is not included and at least one “DND” is included with respect to a plurality of contexts. The user state estimator 140 estimates the user state to be “neutral” when “offline”/“DND”/“break time” are not included with respect to a plurality of contexts. The user state estimator 140 estimates the user state to be “break time” when “offline”/“DND” are not included and “break time” is included.

### 5. Operation of Environment Estimator

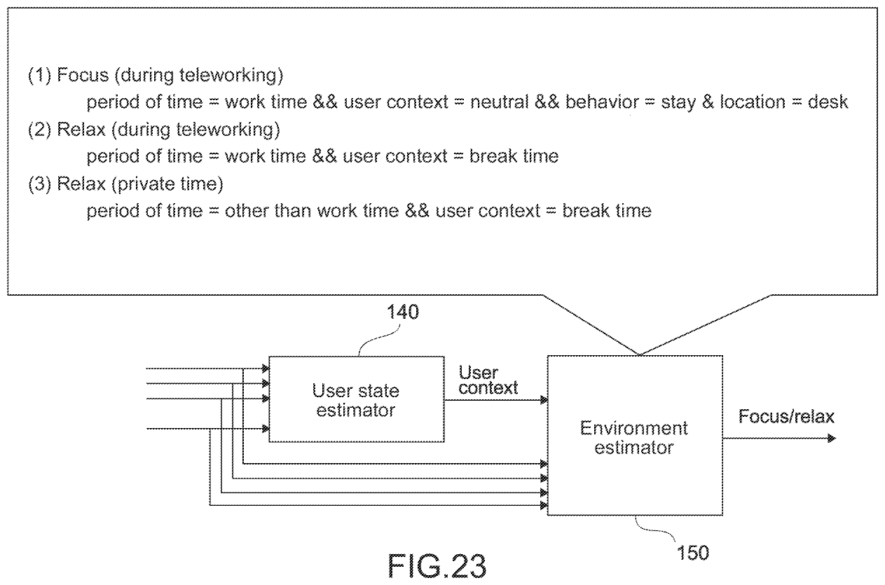

FIG. 23 illustrates an operation of the environment estimator.

The environment estimator 150 estimates an environment state to be provided to a user, on the basis of a user state estimated by the user state estimator 140 and a location attribute estimated by the location estimator 130. The environment state to be provided to a user is, for example, an environment state that enables the user to focus his/her mind (concentrate) or an environment state that enables the user to feel relaxed. For example, (1) when the period of time is “on duty”, the user state is “neutral”, the behavior is “stay”, and the location is “desk”, the environment estimator 150 estimates, to be “focus”, the environment state to be provided to a user. (2) When the period of time is “on duty” and the user state is “break time”, the environment estimator 150 estimates, to be “relax”, the environment state to be provided to a user. (3) When the period of time is “off duty” and the user state is “break time”, the environment estimator 150 estimates, to be “relax”, the environment state to be provided to a user.

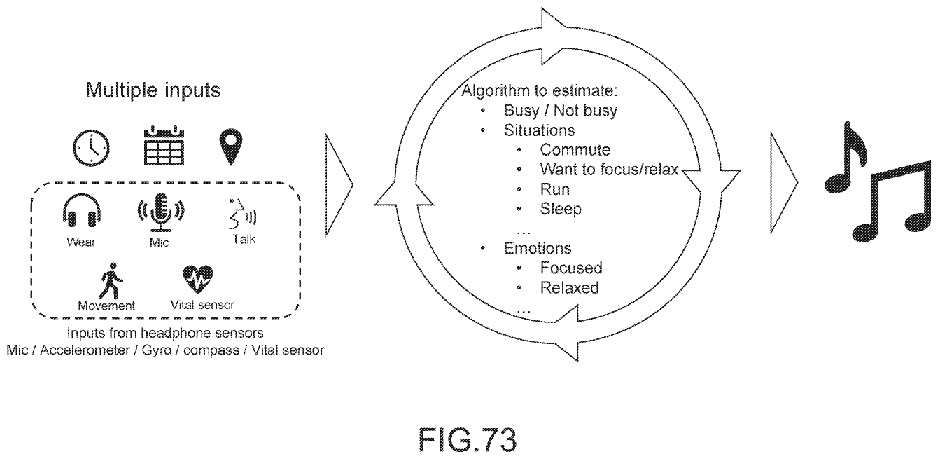

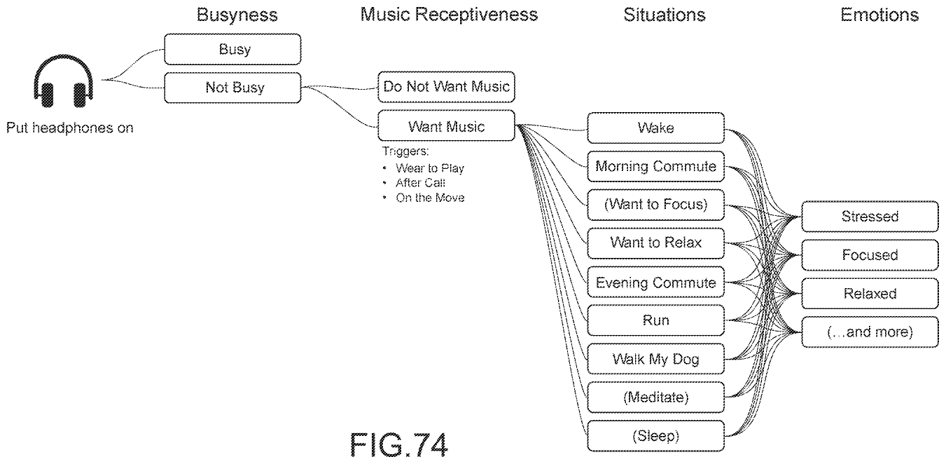

FIGS. 73 and 74 schematically illustrate an example of an algorithm for the user state estimator and the environment estimator. The user state estimator 140 acquires, from the wearable device 200, data regarding, for example, being worn, microphone input, speech, a movement of a body, and vital information (including biological information and feeling information), and acquires, from the context acquisition section 110 of the information processing apparatus 100, data of, for example, time, a calendar, and a location. The user state estimator 140 determines, from the acquired pieces of data, whether the state is “busy” or “not busy”. When the state has been determined to be “not busy”, the user state estimator 140 determines whether music content is allowed to be output to a user. For example, when the user state estimator 140 detects a trigger such as wear of the wearable device 200, finishing of a call, or during movement, the user state estimator 140 determines that the music content is allowed to be output to the user. Then, the user state estimator 140 determines a situation (such as going to work in the morning, wanting to focus his/her mind or to feel relaxed, going home from the office, running, dog-walking, meditation, or a sleep). The environment estimator 150 estimates an environment state (such as “stress”, “focus”, or “relax”) on the basis of the situation determined by the user state estimator 140.

### 6. Operation of Output Controller

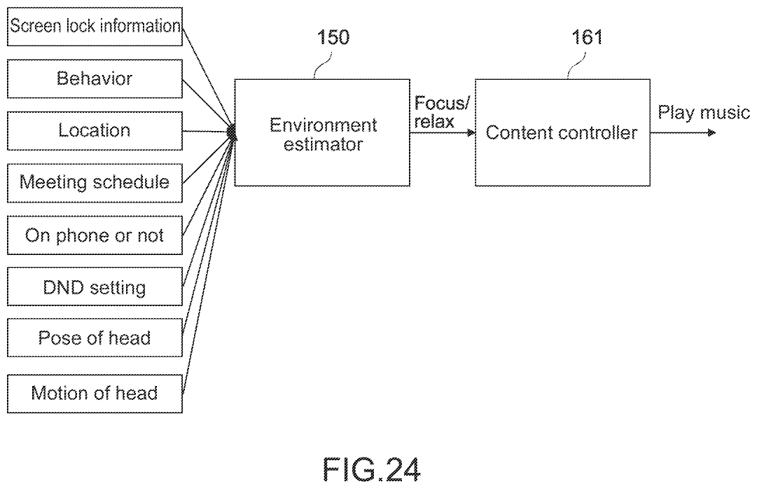

FIG. 24 illustrates an operation of the content controller of the output controller.

The content controller 161 of the output controller 160 plays back content (such as a piece of music and a video) that is selected on the basis of an environment state estimated by the environment estimator 150. For example, it is sufficient if the content controller 161 notifies an environment state to a digital service provider (DSP) through a network, receives content (content that enables a user to focus his/her mind or content that enables a user to feel relaxed) selected by the DSP on the basis of the notified environment state, and plays back the received content. For example, when a user is on duty and the user state is “focus”, the content controller 161 plays music that enables the user to concentrate, and when the user state is “relax”, the content controller 161 plays music that enables the user to feel relaxed. For example, when a user is falling asleep and the user state is “relax”, the content controller 161 plays music that promotes sleep, and when the user is asleep, the content controller 161 stops the music.

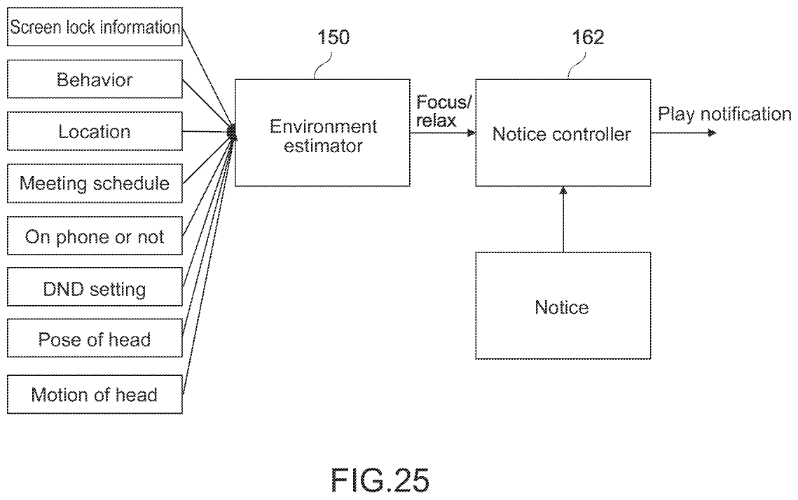

FIG. 25 illustrates an operation of the notice controller of the output controller.

The notice controller 162 of the output controller 160 controls the number of notices provided to a user, on the basis of an environment state. For example, it is sufficient if the notice controller 162 reduces the number of notices (such as a new-reception notice from an app or for a message) or stops the notice such that the user can focus his/her mind, and causes a usual number of notices to be provided while the user is feeling relaxed. For example, when a user is on duty and the user state is “focus”, the notice controller 162 reduces the number of notices, and when the user state is “relax”, the notice controller 162 causes a usual number of notices to be provided.

### 7. Summary

There is a technology that performs sound recognition on speech and environmental sound, selects content such as a piece of music on the basis of the recognized sound, and outputs the selected content. The technology that performs sound recognition on speech and environmental sound can only be applied to an environment in which sound is produced. Thus, there is a possibility that proper content will not be selected by a user who does not want to produce sound, or in a state in which sound is not allowed to be produced. Further, there is a need for a high computational performance to perform natural language processing. This results in difficulty in performing processing locally.

On the other hand, the present embodiment makes it possible to output content that encourages a user to focus his/her mind (concentrate) or to get relaxed, on the basis of a location of the user in a house and other user contexts. The present embodiment makes it possible to control output to a user properly regardless of a state such as a state in which sound is not allowed to be produced. For example, on the basis of the user context, content that enables a user to focus his/her mind can be output when the user is at his/her desk for work during telecommuting, and music that enables the user to feel relaxed can be provided when the user is in a resting space.

The inside of a house is relatively narrow, which is different from the outdoors. Thus, there is generally a need for external equipment such as a high-accuracy beacon or camera in order to estimate a specific location in the house. On the other hand, the present embodiment makes it possible to specify, without external equipment, a location in a house using the sensor section 210 (the acceleration sensor 211, the gyroscope 212, and the compass 213) mounted on the wearable device 200. Specifically, a pattern of movement between locations and an order of the movement are stored, and a location of a user after movement can be specified using N most recent movement patterns.

Telecommuting is a common practice these days. Not only does a user get relaxed in a house, but the user focuses his/her mind on duty in the house for a long time. It is conceivable that there could be an increase in the number of users who do not want to produce sound in such a case, or there could be an increase in the number of states in which sound is not allowed to be produced in such a case, compared to when telecommuting was not widespread in the past.

Thus, an approach with no speech, such as the present embodiment, that includes specifying a location in a house, estimating an environment state to be provided to a user, and controlling output to the user will offer a higher value in use in the future.

Further, in the present embodiment, a context acquired from each piece of sensor information is mapped to a user state to estimate the user state. This makes it possible to estimate the user state without producing sound by speech. In the present embodiment, a context acquired from each piece of sensor information is mapped to a user state. Thus, a calculation amount is greatly smaller, and this makes it easier to perform processing locally, compared to when natural language processing is applied.

### 8. Content Playback System

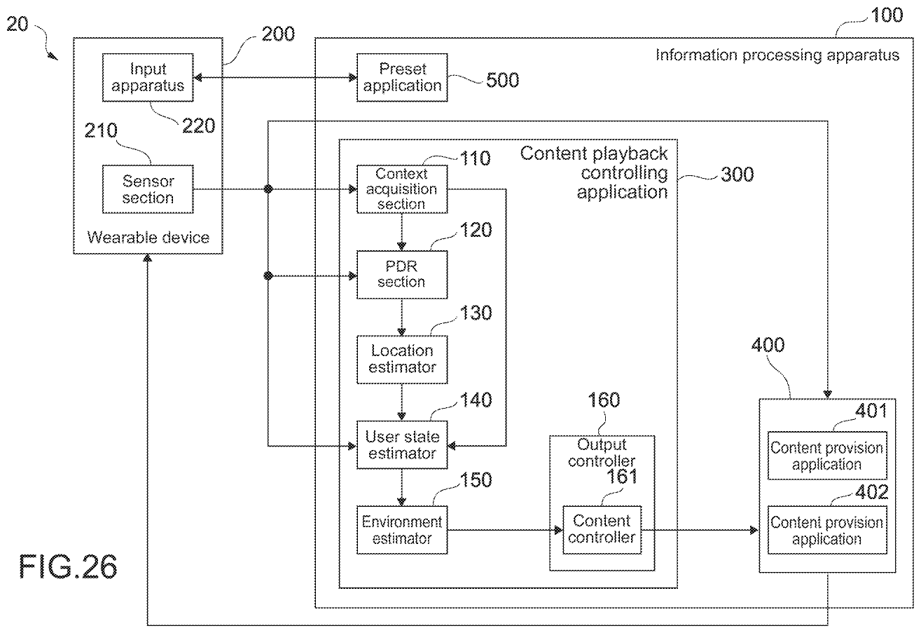

FIG. 26 illustrates a configuration of a content playback system according to the present embodiment.

A content playback system 20 includes the information processing apparatus 100 and the wearable device 200.

In the information processing apparatus 100, a processor such as a CPU of a control circuit loads, into a RAM, a content playback controlling application 300, a content provision application 400, and a preset application 500 that are recorded in a ROM, and executes the applications. Note that the content playback controlling application 300 does not have to be installed on the information processing apparatus 100, but may be installed on the wearable device 200 to be executed by the wearable device 200.

As described above, examples of the wearable device 200 include a wireless earphone (refer to FIG. 2), a wireless headphone, a wired headphone, and a wired earphone. The wearable device 200 includes the sensor section 210 and an input apparatus 220. The sensor section 210 includes the acceleration sensor 211, the gyroscope 212, the compass 213, and the biological sensor 214 such as a heartbeat sensor, a blood flow sensor, and a brain wave sensor (refer to FIG. 1). The wearable device 200 inputs a detection value detected by the sensor section 210 to the content playback controlling application 300 and the content provision application 400. Examples of the input apparatus 220 include a touch sensor, a physical button, and a noncontact sensor, and the input apparatus 220 inputs a contact or noncontact operation performed by a user. For example, the input apparatus 220 is provided to an outer surface of the driver unit 222 (refer to FIG. 2) of the wearable device 200.

The content provision application 400 provides content. The content provision application 400 is a group of applications including different content provision applications 401 and 402 of a plurality of different content provision applications. For example, the different content provision applications 401 and 402 of the plurality of different content provision applications provide different genres of content (that is specifically sound content) such as a piece of music, environmental sound, healing sound, and a radio program. The different content provision applications 401 and 402 of the plurality of different content provision applications are each simply referred to as the “content provision application 400” when they are not particularly to be distinguished.

The content playback controlling application 300 includes the context acquisition section 110, the pedestrian dead reckoning (PDR) section 120 (a user location estimator), the location estimator 130 (a location attribute estimator), the user state estimator 140, the environment estimator 150, and the content controller 161 of the output controller 160 that are described above (refer to FIG. 1). The content controller 161 selects the content provision application 400 on the basis of an environment state estimated by the environment estimator 150 or on the basis of one of different operations that is input by a user to the input apparatus 220 of the wearable device 200. The content controller 161 generates, on the basis of the environment state, a cue used by the content provision application 400 to select content, outputs the generated cue to the selected content provision application 400, and causes the content provision application 400 to select content on the basis of the cue to cause the content to be played back by the wearable device 200.

The preset application 500 preassigns, to different functions of a plurality of different functions, different operations of a plurality of operations input by a user to the input apparatus 220 of the wearable device 200, the different functions of the plurality of different functions being related to services provided by the content provision application 400. For example, the preset application 500 preassigns the different operations to selections of the different content provision applications 401 and 402 of the plurality of different content provision applications. The different operations (such as a single tap, a double tap, a triple tap, and pressing of radio buttons) input by a user to the input apparatus 220 of the wearable device 200 are reassigned to selections of the different content provision applications 401 and 402 of the plurality of different content provision applications. The preset application 500 may be independent of the content playback controlling application 300, or may be included in the content playback controlling application 300.

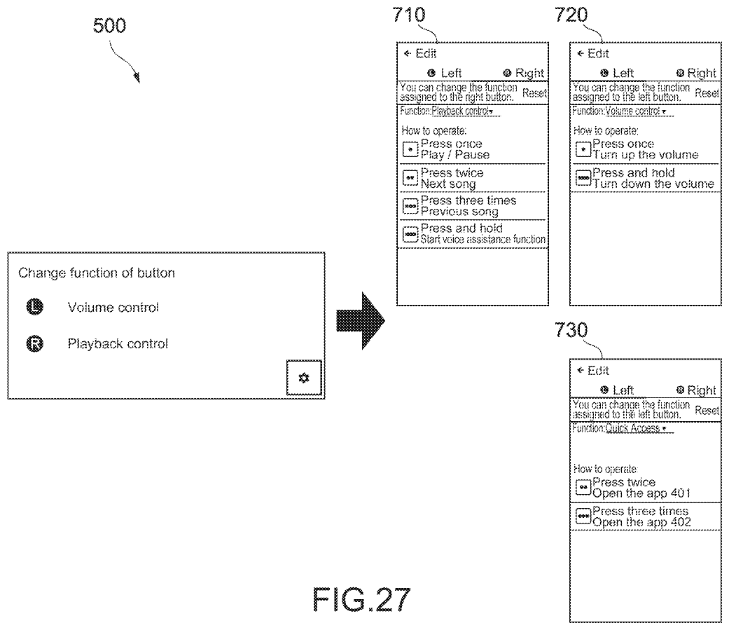

FIG. 27 illustrates an example of a GUI of the preset application.

For example, the preset application 500 includes a playback control GUI 710, a volume control GUI 720, and a quick access controlling GUI 730. Note that the kind of GUI provided by the preset application 500 and a settable combination of a function and an operation differ depending on a model of the wearable device 200.

Using the playback control GUI, a user can assign, to functions performed upon content playback, different operations of a plurality of different operations respectively input by the user to the input apparatuses 220 of the right and left wearable devices 200. For example, the user can assign a single-tap operation of the wearable device 200 on the right to playing and pausing, can assign a double-tap operation of the wearable device 200 on the right to playing of a next piece of music, can assign a triple-tap operation of the wearable device 200 on the right to playing of a previous piece of music, and can assign a long-press operation of the wearable device 200 on the right to start of a voice assistance function. Note that the functions assigned to the respective operations may be functions other than the functions described above, or the functions may be assigned to the operations by default.

Using the volume control GUI 720, a user can assign, to functions performed to control volume, different operations of a plurality of different operations respectively input by the user to the input apparatuses 220 of the right and left wearable devices 200. For example, the user can assign a single-tap operation of the wearable device 200 on the left to volume up, and can assign a long-press operation of the wearable device 200 on the left to volume down.

Using the quick access controlling GUI 730, a user can assign, to quick access functions, different operations of a plurality of different operations respectively input by the user to the input apparatuses 220 of the right and left wearable devices 200, each quick access function being performed to select and open a corresponding one of the different content provision applications 401 and 402 of the plurality of different content provision applications. For example, the user can assign a double-tap operation of the wearable device 200 on the left to opening of the content provision application 401, and can assign a triple-tap operation of the wearable device 200 on the left to opening of the content provision application 402.

As described above, the preset application 500 can assign different operations of a plurality of different operations not only to playback control and volume control that are performed while the content provision application 400 is running, but also to selection and opening of the content provision application 400, the different operations of the plurality of different operations being respectively input by the user to the input apparatuses 220 of the right and left wearable devices 200.

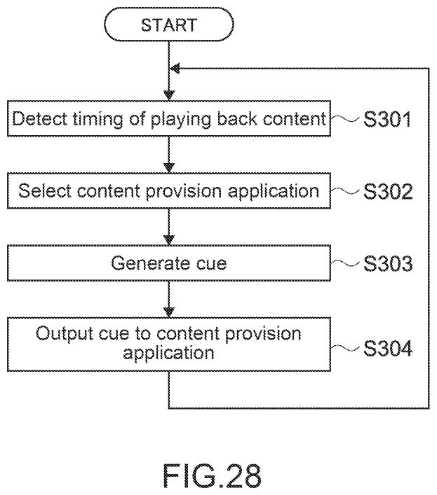

FIG. 28 illustrates a flow of an operation of the content playback controlling application.

In the content playback controlling application 300, the context acquisition section 110 acquires a context of a user. The user state estimator 140 estimates a user state (activity states at four levels including “break time”, “neutral”, “do not disturb (DND)”, and “offline”) on the basis of the context acquired by the context acquisition section 110, detection values (acceleration, angular velocity, and an azimuth) detected by the sensor section 210 included in the wearable device 200, and a location attribute estimated by the location estimator 130. Here, the user states at four levels are described as an example, but the number of levels may be greater than or less than four. Further, any number of user states may be set by a user. On the basis of the user state estimated by the user state estimator 140, the environment estimator 150 estimates an environment state to be provided to a user (such as “focus” (“concentration”) or “relax”) (refer to FIG. 19). On the basis of the environment state estimated by the environment estimator 150, the content controller 161 of the output controller 160 detects an appropriate timing at which playback of content is to be started (Step S301).

In the content playback controlling application 300, the content controller 161 of the output controller 160 selects the content provision application 400. For example, the content controller 161 selects the content provision application 400 on the basis of one of different operations that is input by a user to the input apparatus 220 of the wearable device 200. For example, the content controller 161 selects the content provision application 401 when the operation input by a user to the input apparatus 220 of the wearable device 200 is a double tap, and the content controller 161 selects the content provision application 402 when the operation input by the user to the input apparatus 220 of the wearable device 200 is a triple tap. Further, the content controller 161 selects the content provision application 400 on the basis of an environment state (a scenario described later) estimated by the environment estimator 150 (Step S302). Furthermore, the content controller 161 may select the content provision application 400 on the basis of training performed such that, despite the fact that the condition remains unchanged, a certain scenario no longer comes about as a result of repetition of refusal, or on the basis of setting performed by a user (such as setting the content provision application 400 in advance according to the state).

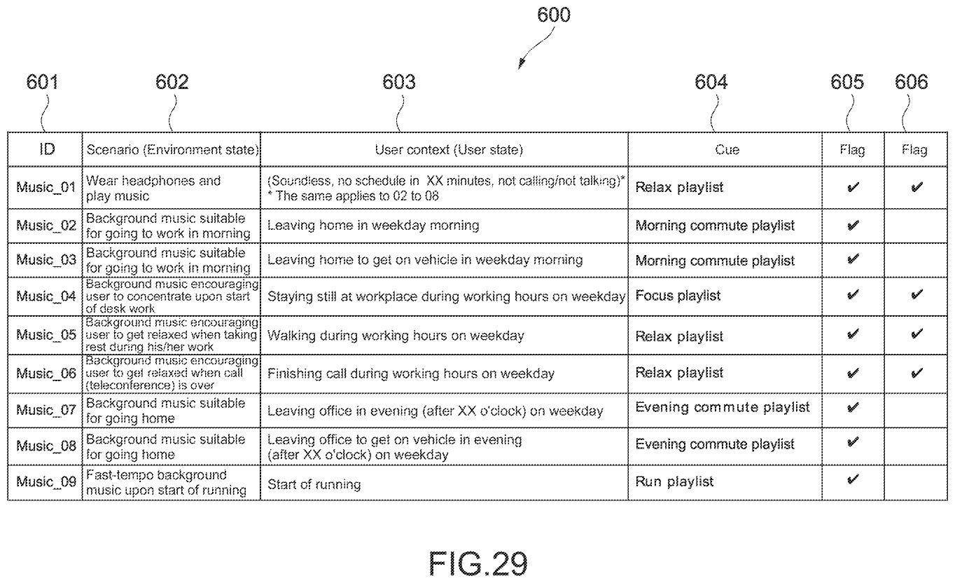

FIG. 29 illustrates an example of a table used to select the content provision application.

For example, the content controller 161 refers to a table 600 to select the content provision application 400. The table 600 includes an ID 601, a scenario 602, a user context 603, and a cue 604. The scenario 602 corresponds to an environment state estimated by the environment estimator 150. The user context 603 corresponds to a user state estimated by the user state estimator 140 on the basis of a context of a user that is acquired by the context acquisition section 110. The cue 604 is a cue used by the content provision application 400 to select content. The table 600 records therein a selection flag 605 for the content provision application 401 and a selection flag 606 for the content provision application 402 for each of nine records respectively assigned Music_01 to Music_09 given as the ID 601. The record for which only the selection flag 605 is recorded means that the content provision application 401 is selected when the scenario 602 (an environment state) corresponding to that record comes about. On the other hand, the record for which both of the selection flags 605 and 606 are recorded means that one of the content provision applications 401 and 402 is selected under a different condition when the scenario 602 (an environment state) corresponding to that record comes about. For example, the content controller 161 may learn in advance, for example, which of the content provision applications 400 is executed oftener at a current time and which of the content provision applications 400 is used oftener, and may perform selection.

In the content playback controlling application 300, the content controller 161 of the output controller 160 generates, on the basis of the scenario 602 (an environment state), a cue 604 used by a selected content provision application 400 to select content (Step S303). The content controller 161 outputs the generated cue to the selected content provision application 400, causes the content provision application 400 to select content on the basis of the cue, and causes the content to be played back by the wearable device 200 (Step S304). For example, the content provision application 400 may select a plurality of pieces of candidate content on the basis of a cue output from the content playback controlling application 300, and may select a piece of playback-target content from the plurality of pieces of candidate content on the basis of a detection value input by the sensor section 210 of the wearable device 200. Further, the content provision application 400 may select, for example, content with a fast tempo matched to a running speed of a user, on the basis of a detection value input by the sensor section 210.

After playback is started, the content controller 161 of the content playback controlling application 300 detects, on the basis of the environment state, a timing at which playback of other content is to be started (Step S301), selects the content provision application 400 (Step S302, which can be skipped), generates the cue 604 (Step S303), and causes the content to be played back by the wearable device 200 (Step S304). In other words, the content playback controlling application 300 has user information (that is, the user context 603 (a user state) and the scenario 602 (an environment state)) that is not available to the content provision application 400. Thus, the content playback controlling application 300 knows about a case in which it is desirable that content that is being played back by the content provision application 400 be changed. For example, a change in the feelings of a user can be led by changing content that is being played back, with a state of being going to work or finishing of work being used as a trigger. When the user information (that is, the user context 603 (a user state) and the scenario 602 (an environment state)) becomes available to the content playback controlling application 300, the content playback controlling application 300 transmits, to the content provision application 400, a cue used to change content that is being played back. This makes it possible to provide a user with more desirable content (such as a piece of music or healing sound).

Further, the content controller 161 of the content playback controlling application 300 generates a cue used by the content provision application 400 to stop (but not change) playback of content on the basis of the scenario 602 (an environment state) (Step S303), outputs the cue to the content provision application, and causes the content provision application 400 to stop the playback of the content on the basis of the cue (Step S304). For example, in some cases, it is better if music is stopped due to a change in state such as start of a meeting. The content playback controlling application 300 detects such a state to transmit a stop instruction to the content provision application 400.

Furthermore, during playback of content, the content provision application 400 may select content with a fast tempo matched to a running speed of a user, on the basis of a detection value input by the sensor section 210, that is, according to a specified value of, for example, a heart rate or acceleration, and may plays back the selected content. In other words, during playback of content, the content provision application 400 can actively select, without receiving a cue from the content controller 161 of the content playback controlling application 300, an attribute (such as a tempo and a pitch) of playback-target content on the basis of a detection value input by the sensor section 210, and can play back the selected content. In short, the content provision application 400 can actively change playback-target content during playback of content.

### 9. Conclusion

According to the content playback system 20 of the present embodiment, the content playback controlling application 300 selects the content provision application 400 and outputs a cue to the selected content provision application 400. This results in there being no need to consider, on the side of the content provision application 400, whether the different content provision applications 401 and 402 of the plurality of different content provision applications compete with each other upon content playback.

Further, the content playback controlling application 300 generates, on the basis of an environment state corresponding to sensitive information regarding a user, a cue used by the content provision application 400 to select content. Thus, the content provision application 400 can play back content in which an environment state corresponding to sensitive information regarding a user is reflected, without the content playback controlling application 300 sharing the environment state corresponding to sensitive information regarding a user with the content provision application 400. This makes it possible to reduce the security risk and to provide an improved user experience.

Furthermore, the content playback controlling application 300 selects the content provision application 400, and the selected content provision application 400 plays back content. Moreover, the preset application 500 enables the content playback controlling application 300 to select the content provision application 400 on the basis of one of different operations that is input by a user to the input apparatus 220 of the wearable device 200. This makes it possible to provide a user experience obtained by integrating services provided by the different content provision applications 401 and 402 of the plurality of different content provision applications, without there being no need for a user to actively perform selection.

### 10. Embodiment of Angle Correction Section

### (1) Functional Configuration and Operation of Angle Correction Section

As described with reference to FIG. 3, a shape of an ear of a user, how the user wears the wearable device 200, and how the sensor section 210 is mounted on the wearable device 200 differ depending on the individual and the environment. For this reason, the “front as viewed by a user” and the “front as viewed from the sensor section 210 of the wearable device 200” are not the same but shifted from each other. It is necessary that the wearable device 200 worn on a head of a user be able to be oriented toward a proper direction in any coordinate system.

Thus, in the embodiments above, the angle correction section 121 calculates an inclination in a pitch direction and an inclination in a roll direction using a value of acceleration acquired by the acceleration sensor 211 when a user turns his/her head downward ((b) of FIG. 6, Step S101 of FIG. 5) (Step S102). The angle correction section 121 can calculate an inclination in a yaw direction using a value of angular velocity acquired by the gyroscope 212 when the user slowly turns his/her head upward to look obliquely upward in the front direction ((c) of FIG. 6, Step S104) (the process (4) of FIG. 8).

On the other hand, how the angle correction section 121 calculates not only the inclination in the pitch direction and the inclination in the roll direction but also the inclination in the yaw direction only using the value of angular velocity acquired by the gyroscope 212 without the value of angular velocity acquired by the gyroscope 212, is described below.

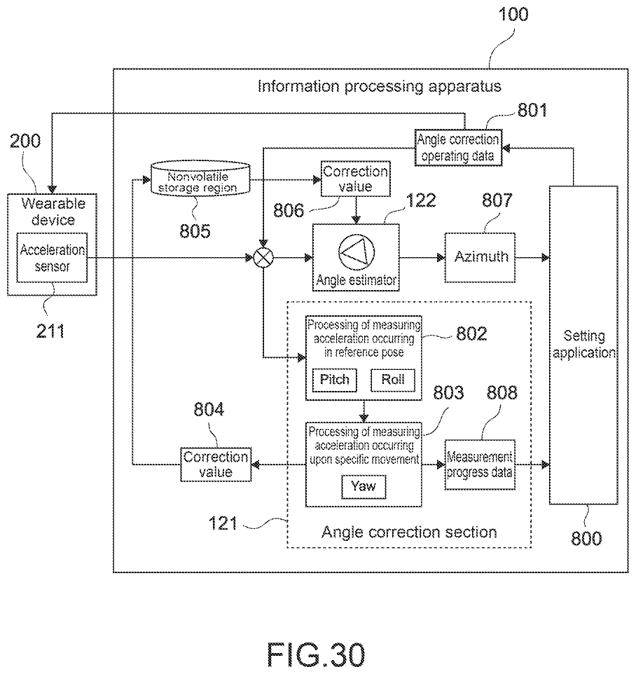

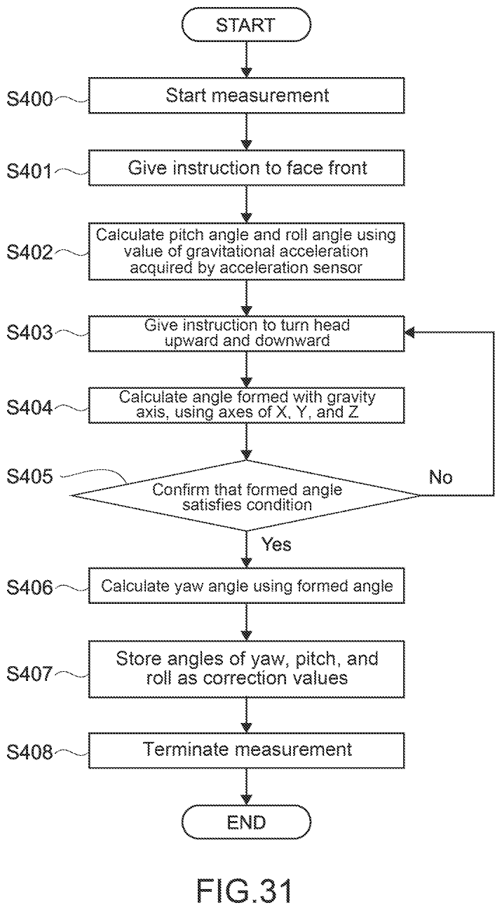

FIG. 30 illustrates a functional configuration of the angle correction section according to an embodiment. FIG. 31 illustrates a flow of an operation of the angle correction section.

It is assumed that a setting application 800 that is a user interface is installed on the information processing apparatus 100 (such as a smartphone, a tablet computer, or a personal computer) and that a user can use the setting application 800 by use of a display apparatus and an operation apparatus (such as a touch panel) of the information processing apparatus 100.

First, a user operates the operation apparatus to cause the setting application 800 to give an instruction to start measurement. The setting application 800 outputs angle correction operating data 801 to the wearable device 200 (Step S400).

In response to receiving the instruction (the angle correction operating data 801) given by the setting application 800, the wearable device 200 starts transmitting, to the angle correction section 121, gravitational acceleration that is a detection value detected by the acceleration sensor 211.

The setting application 800 outputs, to the user wearing the wearable device 200, an instruction to face the front ((a) of FIG. 6) (displays the instruction on the display apparatus) (Step S401).

The angle correction section 121 calculates inclinations 802 in a pitch direction and in a roll direction using a value of gravitational acceleration occurring when the user faces the front (in the roll direction) ((a) of FIG. 6) (Step S402). A method of the calculation will be described in detail later.

Next, the setting application 800 outputs, to the user wearing the wearable device 200, an instruction to slowly turn his/her head upward and downward such that the head is not moved from side to side and then to stop the head for about one second ((b) and (c) of FIG. 6) (displays the instruction on the display apparatus) (Step S403).

The angle correction section 121 calculates an angle formed with a gravity axis, using axes of X, Y, and Z (Step S404). The angle correction section 121 determines whether the calculated angle satisfies a specified condition (Step S405). When a user faces the front, axes of X and Y for the acceleration sensor are nearly orthogonal to the gravity axis, and thus a measurement value gets closer to zero. The specified condition is a condition applied to avoid such a state, and is satisfied when an angle formed with a Z axis is a sufficient angle of bend and an error occurring due a state in operation is not measured (which will be described in detail later). When the condition is not satisfied, the angle correction section 121 outputs measurement progress data 808 used to give an instruction to move the head upward and downward again (to display the instruction on the display apparatus) (Step S405, No).

On the other hand, when the condition is satisfied (Step S405, Yes), the angle correction section 121 calculates an inclination 803 of the user in a yaw direction using values of gravitational acceleration occurring when the user turns his/her head upward and downward (the pitch direction) ((b) and (c) of FIG. 6), and using the inclinations 802 in the pitch direction and in the roll direction (Step S406). A method of the calculation will be described in detail later. The angle correction section 121 stores, in a nonvolatile storage region 805, the inclinations 802 in the pitch direction and in the roll direction as well as the inclination 803 in the yaw direction as correction values 804 (Step S407), and terminates the measurement (Step S408).

The angle estimator 122 reads correction values 806 (the inclinations 802 in the pitch direction and in the roll direction as well as the inclination 803 in the yaw direction) stored in the nonvolatile storage region 805. The angle estimator 122 estimates an azimuth 807 corresponding to the user on the basis of a detection value (acceleration) detected by the acceleration sensor 211 of the sensor section 210 of the wearable device 200 worn by the user, and on the basis of the read correction values 806. The angle estimator 122 may output the azimuth 807 to the setting application 800.

### (2) Calculation of Inclinations in Pitch Direction and in Roll Direction (Step S402)

A coordinate system that is fixed to a user in a reference pose is represented using (X,Y,Z). An X axis (a pitch axis) as viewed by the user is horizontally oriented to the right, a Y axis (a roll axis) as viewed by the user is horizontally oriented toward the front (forwardly), and a Z axis (a yaw axis) as viewed by the user is vertically oriented upward. On the other hand, a three-dimensional local coordinate system of the acceleration sensor 211 mounted on the wearable device 200 is represented using (x,y,z). The three-dimensional coordinate systems are both a right-handed system.

Due to an individual difference in how a user wears the wearable device 200, there are relative shifts between the two coordinate systems respectively represented using (X,Y,Z) and (x,y,z) with respect to three degrees of freedom. The user coordinate system (X,Y,Z) can be obtained from the local coordinate system (x,y,z) of the wearable device 200 by specifying the shifts. Here, components of two degrees of freedom that represent inclinations with respect to a horizontal plane from among the shifts are calculated using a value measured by the acceleration sensor 211 of the wearable device 200 in a state in which a user is at rest in the reference pose.

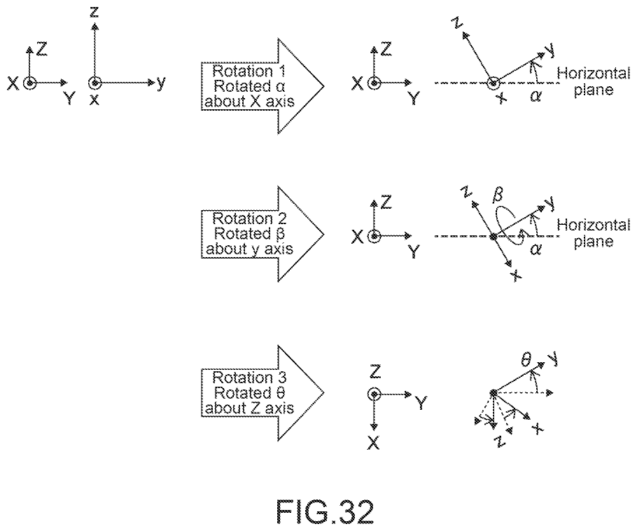

FIG. 32 illustrates a definition of a device coordinate system.

Three angles that respectively represent amounts of relative shifts are defined. Various methods for defining an angle are conceivable. Here, in order to be suitable for quaternions described later, definition is made such that a coordinate axis corresponding to the user coordinate system is rotated three times to be a coordinate axis corresponding to the coordinate system of the wearable device 200. For example, a coordinate axis corresponding to the user coordinate system is rotated by an angle α about the X axis. The angle α is caused to be identical to an angle finally formed by the y axis with the horizontal plane. Next, about the y axis after the rotation, the coordinate axis is rotated by an angle 3. Here, an angle formed by the x axis with the horizontal plane is caused to be identical to an angle (γ) finally formed by the x axis with the horizontal plane. At the end, the coordinate axis is rotated by an angle θ about the Z axis. The angle θ is caused to be identical to an angle formed by a horizontal-plane component of a finally obtained y-axis vector with the Y axis. The angles α and β are calculated using a value acquired by the acceleration sensor 211 when a user is at rest. Note that 0 is obtained by another method since 0 is not obtained by calculation (every value could be a solution).

(Ax,Ay,Az) is assumed to be a measurement value measured by the acceleration sensor 211 in an (x,y,z) direction. Formula 1 is represented by defining a.

$$α = {tan}^{- 1} \frac{{A}_{y}}{\sqrt{{A}_{x}^{2} + {A}_{z}^{2}}} \qquad [ Math . 1 ]$$

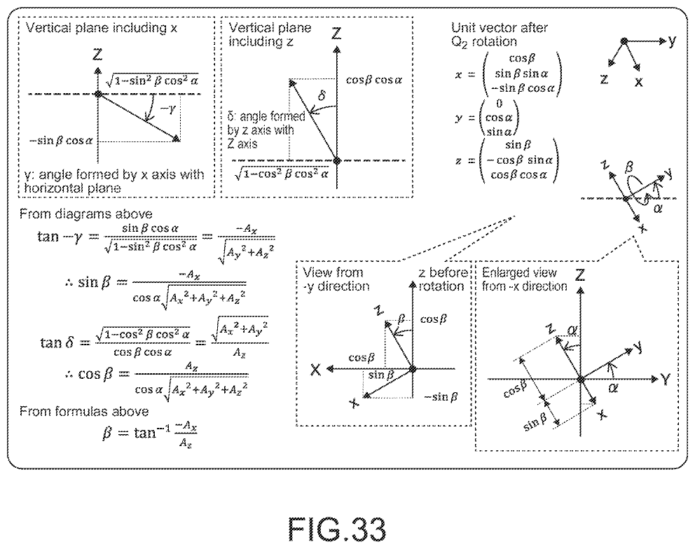

FIG. 33 illustrates a method for obtaining the angle β.

There are a vertical plane including an orientation vector of the x axis, and a vertical plane including an orientation vector of the z axis. Formula 2 is obtained using angles γ and δ respectively formed by the axes of x and z with the horizontal plane.

$$tan - γ = \frac{sin β cos α}{\sqrt{1 - {sin}^{2} β {cos}^{2} α}} = \frac{- {A}_{x}}{\sqrt{{A}_{y}^{2} + {A}_{z}^{2}}} \qquad [ Math . 2 ]$$

$$∴ sin β = \frac{- {A}_{x}}{cos α \sqrt{{A}_{x}^{2} + {A}_{y}^{2} + {A}_{z}^{2}}}$$

$$tan δ = \frac{\sqrt{1 - {cos}^{2} β {cos}^{2} α}}{cos β cos α} = \frac{\sqrt{{A}_{x}^{2} + {A}_{y}^{2}}}{{A}_{z}}$$

$$∴ cos β \frac{{A}_{z}}{cos α \sqrt{{A}_{x}^{2} + {A}_{y}^{2} + {A}_{z}^{2}}}$$

The angle β is obtained using Formula 3 by use of Formula 2.

$$β = {tan}^{- 1} \frac{- {A}_{x}}{{A}_{z}} \qquad [ Math . 3 ]$$

Using the angles α and β obtained from results described above, the coordinate system of the wearable device 200 that is represented using (x,y,z) is transformed into a coordinate system of the wearable device 200 that is represented using (x′,y′,Z) and in which inclinations with respect to the horizontal plane have been corrected. Both x′ and y′ are situated in the horizontal plane, and are respectively obtained by x and y being rotated by the angle θ about the Z axis. An acceleration value acquired in a coordinate system of the wearable device 200 after correction performed by correcting inclinations is used to calculate 0 as described later. This makes it possible to perform calculation with a high degree of accuracy without an axial shift.

An example of rotation calculation performed using quaternions to transform an acceleration vector (Ax,Ay,Az) in a coordinate system of the wearable device 200 into an acceleration vector (Ax′,Ay′,Az′) in a coordinate system of the wearable device 200 after correction, is described. A relationship between the two coordinate systems is obtained by combining the first two rotations from among the rotations illustrated in FIG. 32. When respective rotation quaternions are represented by Q1 and Q2, Q1 and Q2 are obtained using Formula 4.

$${Q}_{1} = ( \begin{matrix}sin α / 2 \\ 0 \\ 0 \\ cos α / 2\end{matrix} ) \qquad [ Math . 4 ]$$

$${Q}_{2} = ( \begin{matrix}0 \\ cos α sin β / 2 \\ sin α sin β / 2 \\ cos β / 2\end{matrix} )$$

A quaternion R that represents rotation and is obtained by combining those rotation quaternions can be obtained using a formula indicated below. Here, * represents a quaternion conjugate.

R=Q₁*Q₂*

The calculation performed to transform a vector of acceleration measured in a coordinate system of the wearable device 200 into a vector in a coordinate system of the wearable device 200 after correction, can be represented using a formula indicated below by use of R.

(Ax′,Ay′,Az′)=R*(Ax,Ay,Az)R

### (3) Calculation of Inclination in Yaw Direction (Steps S404 to S406)

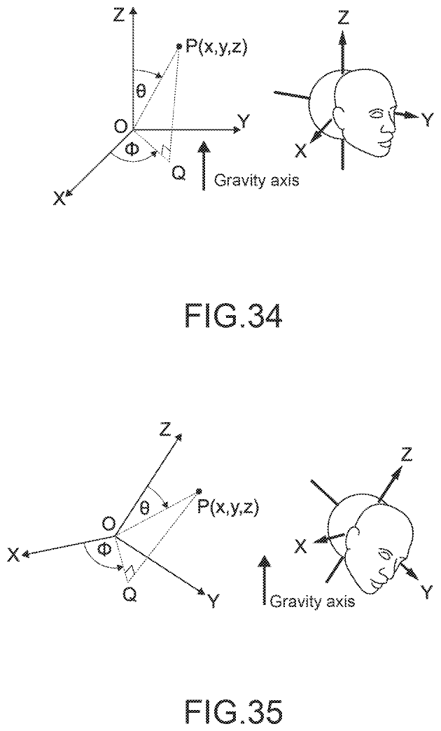

FIG. 34 illustrates a gravity axis when a user faces the front.

A value (x,y,z) of gravitational acceleration measured by the acceleration sensor 211 in three axes is transformed into polar coordinates to calculate a yaw rotation. A distance from an origin is defined as r, an angle formed with the Z axis is defined as θ, and an angle formed with the X axis is defined as Φ. Here, (x,y,z) and (r,θ,Φ) are included in relational expressions indicated below.

x=r sin θ cos θ,y=r sin θ sin Φ,z=r cos θ

These expressions are used to re-form expressions corresponding to Formula 5 (Step S404). Here, sgn represents a signum function.

$$r = \sqrt{{x}^{2} + {y}^{2} + {z}^{2}} \qquad [ Math . 5 ]$$

$$θ = Arc cos \frac{z}{\sqrt{{x}^{2} + {y}^{2} + {z}^{2}}}$$

$$∅ = sgn ( y ) \cdot Arccos \frac{x}{\sqrt{{x}^{2} + {y}^{2}}}$$

A shift between the front as viewed by a user and the front as viewed from a sensor of the wearable device 200 that is to be obtained here using Φ, corresponds to the inclination in the yaw direction (Step S406).

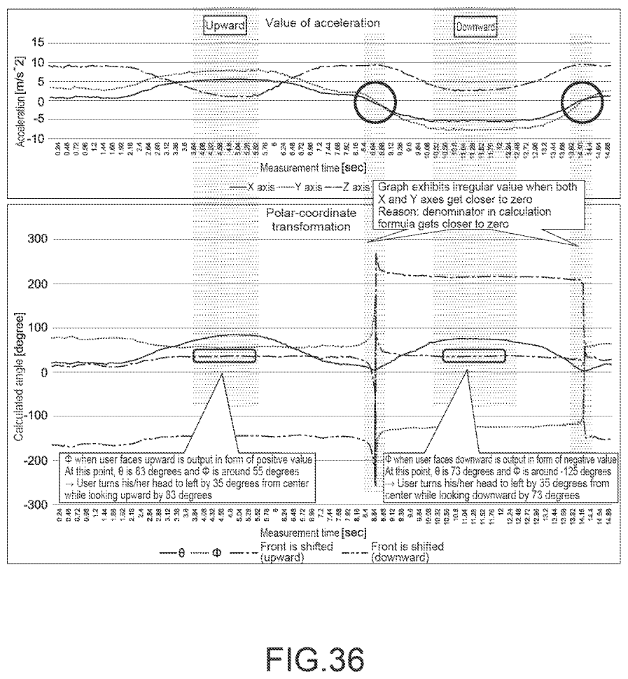

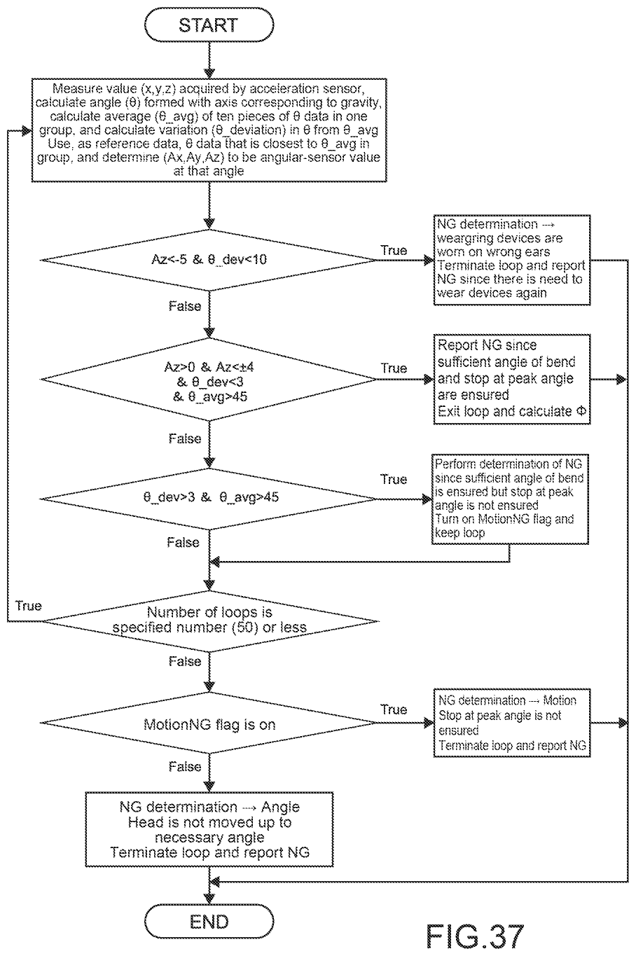

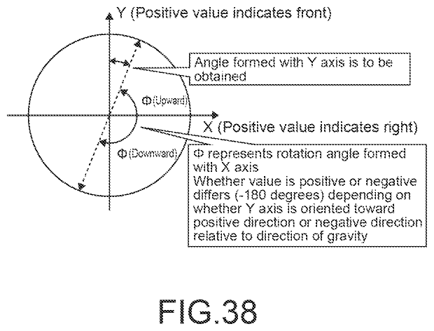

FIG. 35 illustrates a gravity axis when the user faces downward. FIG. 36 illustrates calculation of a yaw rotation that is performed using measurement data, and a measurement singularity. FIG. 37 illustrates a flowchart used to determine whether a condition is satisfied. FIG. 38 illustrates a definition of a yaw rotation, with a front direction being used as a reference.

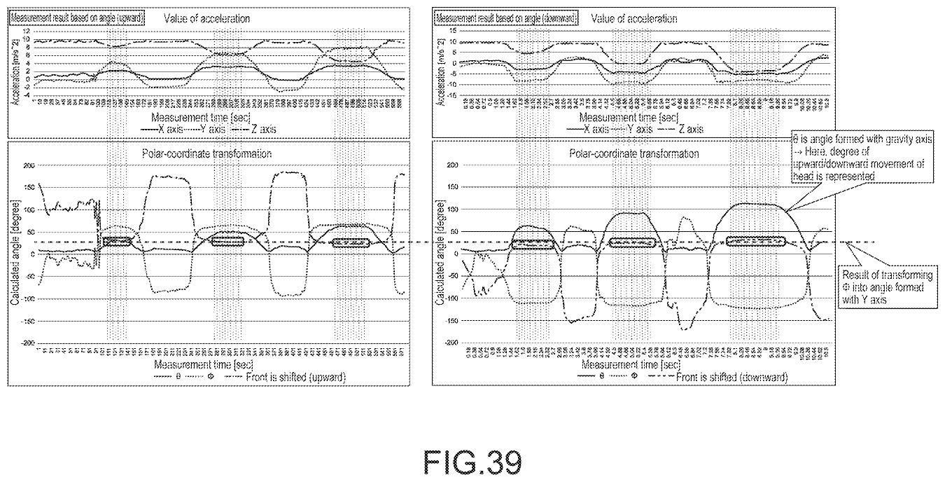

FIG. 39 illustrates an impact that an upward and downward movement and a bend angle have on a calculation result.

Φ is calculated using results of measurement performed when a user faces upward and downward (FIG. 35). When a user faces the front, axes of X and Y for the acceleration sensor 211 are nearly orthogonal to the gravity axis, and thus a measurement value gets closer to zero. The above-described calculation of (is performed to prevent the measurement value from getting closer to zero. In this state, a denominator in Formula 5 gets closer to zero, and thus a proper value is not calculated (FIG. 36). A measurement result obtained when “θ>45” and “a standard deviation for Φ<3” are satisfied is used to perform calculation such that a sufficient angle (θ) of bend is obtained and such that an error occurring due a state in operation is not measured (Step S405) (FIG. 37).

There is a possibility that, depending on a shape of an ear of a user and how the user wears the wearable device 200, the conditions will not be satisfied when the user faces upward or downward. Thus, two patterns of an upward movement and a downward movement are adopted. FIGS. 36, 38, and 39 show that there is no difference in calculation result between measurement using an upward movement and measurement using a downward movement.

### (4) Conclusion

Patent Literature 1 discloses detecting and adjusting turning of a head of a user. A rotation angle is measured by a gyroscope, a tilt of the gyroscope is measured by an acceleration sensor, and the “turning of the head of the user” is calculated to correct a location for localizing a sound image. A direction of the front is set by a user operation, and a turning movement from the front can be traced. However, all of the measurement is relative measurement using the “front as viewed by a user” as a reference. This is not allowed to be applied to an absolute coordinate system such as azimuth.

Patent Literature 2 discloses calculating, after removing an impact that a tilt of a road has, an angle at which a navigation apparatus is attached to an automobile. An acceleration sensor is used in combination with a gyroscope, a traveling speed sensor, or a GPS with respect to the yaw direction. Data is collected while a state of a vehicle such as being stopped or traveling is being detected, and acceleration of a vehicle in a traveling direction and in a right-and-left direction is detected to calculate the attachment angle using the detected data. This technology is dependent on automobile-specific characteristics, and thus is not allowed to be applied to a device worn by a human. Further, there is a need for an auxiliary sensor in addition to an acceleration sensor.

On the other hand, according to the present embodiment, a difference between a coordinate system of a sensor in a device that is worn on a head of a user, and a coordinate system that is determined by the user in any direction is measured to perform correction. This makes it possible to obtain a constant output result regardless of a shape of an ear of the user, a shape of the head of the user, and how the device is worn by the user. Correction is not performed with respect to relative coordinates. Thus, the present technology can also be applied to an absolute coordinate system such as azimuth.

According to the present embodiment, a user moves his/her head upward or downward (turns his/her head in the pitch direction) to calculate an inclination in the yaw direction using gravitational acceleration. When the yaw axis and the gravity axis are close to each other, it is difficult to calculate the inclination in the yaw report using gravitational acceleration. However, a tilt of the head in the pitch direction results in a change in gravitational acceleration applied to each axis. This makes it possible to calculate the inclination in the yaw direction. Depending on an ear shape, it may be difficult to calculate the inclination in the yaw direction even if the head is tilted in a specific pitch direction. However, calculation can be performed by measuring two patterns that are an upward pattern and a downward pattern.

According to the present embodiment, a correction value for an azimuth corresponding to a user can be calculated only using an acceleration sensor. This makes it possible to calculate the correction value even in an environment with fewer mounted sensors. This makes it possible to reduce costs, to reduce power consumption, and to make an apparatus smaller.

Further, a drift may occur in a gyroscope itself depending on an environment in which the gyroscope is used or due to a continuous use of the gyroscope, whereas no drift occurs in an acceleration sensor. This results in an increase in the reliability in calculation.

### 11. Selection of Playlist According to Scene

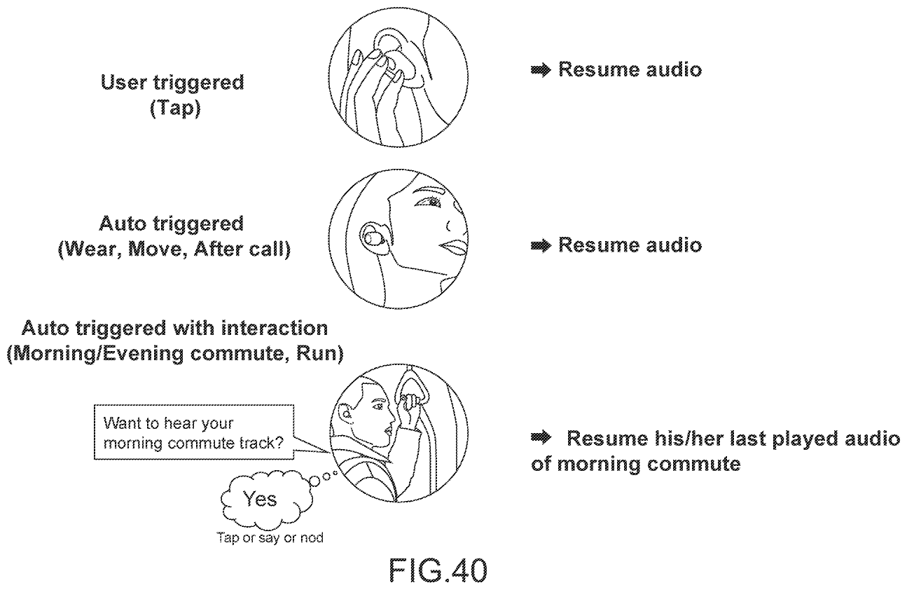

FIG. 40 illustrates a selection of a playlist according to a scene.

On the assumption that the wearable device 200 is worn at all times, the content controller 161 (FIG. 26) of the output controller 160 suggests, at a timing at which no content is played back while the wearable device 200 is being worn, content playback performed at an appropriate timing, on the basis of a result of estimation performed by the environment estimator 150. Some specific examples of such suggestion are described.

For example, the content controller 161 may resume playing back content on the basis of a trigger (such as a tap or a gesture) pulled by a user (in an upper portion in FIG. 40). The content controller 161 may resume playing back content on the basis of an automatic trigger (such as wearing, movement, or finishing of a call) (in a middle portion in FIG. 40). The content controller 161 may resume playing back content on the basis of an automatic trigger with interaction (such as going to work in the morning, going home in the evening, or running) (in a lower portion in FIG. 40). For example, the content controller 161 may interact with a user to resume playing back content that was being played back during user's last morning commute to work.

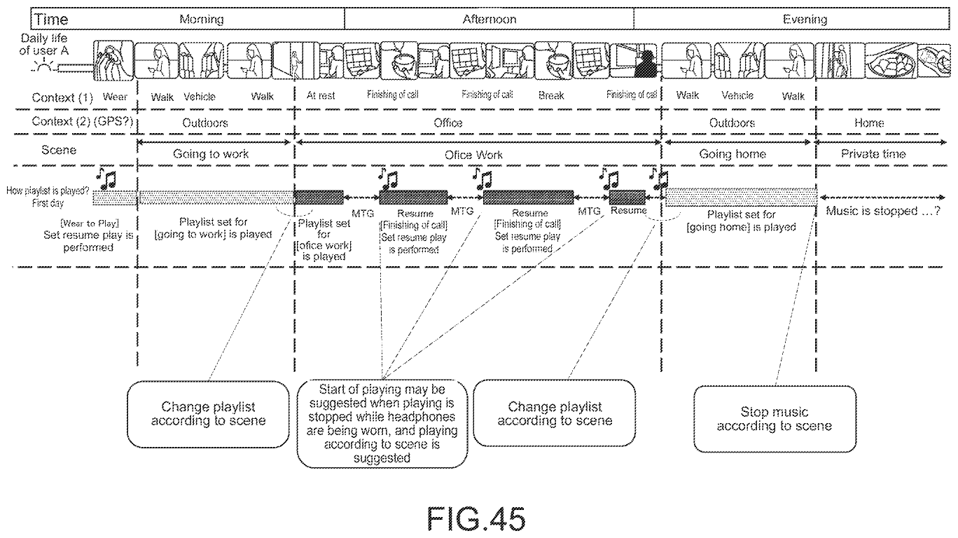

FIG. 45 illustrates an example of switching between playlists according to a scene and suggesting a playlist according to a scene.

As an example, when the wearable device 200 is worn in the morning, the content controller 161 starts performing set resume play. When a user goes to work, the content controller 161 plays a playlist set for “going to work”. When the user arrives at the office, the content controller 161 changes the playlist according to the scene by playing a playlist set for “working at the office”. The content controller 161 stops playing the playlist when the user is at a meeting or is calling. When the meeting or the call is over, the content controller 161 resumes playing the playlist set for “working at the office”. For example, when the playing of a playlist is stopped in a state in which the wearable device 200 is being worn, the content controller 161 suggests starting playing a playlist according to the scene. When the user goes home, the content controller 161 plays a playlist set for “going home”. When the user arrives home, the content controller 161 stops content according to the scene by stopping content playback.

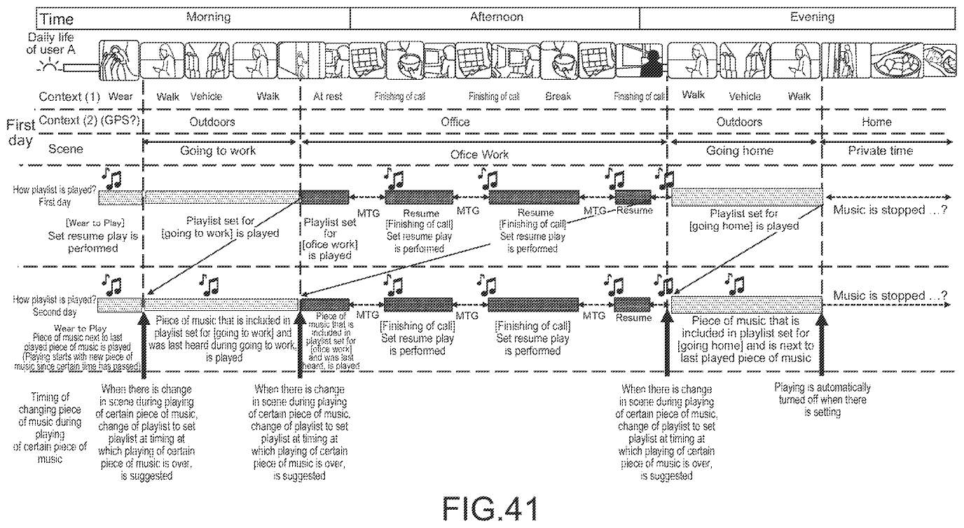

FIG. 41 illustrates an example of successively playing a playlist set for scenes that are identical to each other but occur for separate periods of time.

A previous day (the first day) has been already described with reference to FIG. 45. As an example, on a current day (the second day), when the wearable device 200 is worn in the morning, the content controller 161 plays a piece of music next to a piece of music last played (on the previous day), that is, the content controller 161 starts playing a new piece of music since a certain time has passed. When the user goes to work, the content controller 161 resumes playing a piece of music last played (on the previous day) in the playlist set for “going to work”. In other words, the content controller 161 successively plays one playlist on different days. Further, when scenes that are identical to each other but occur for different periods of time on the same day (for example, running in the morning, and also running in the evening), the content controller 161 successively plays one playlist for the different periods of time. When the user arrives at the office, the content controller 161 resumes playing a piece of music last played (on the previous day) in the playlist set for “working at the office”. When the user goes home, the content controller 161 resumes playing a piece of music last played (on the previous day) in the playlist set for “going home”. In other words, the content controller 161 plays back content (the same content or next content in the same playlist) related to content played back in the same environment state (scene) last time. Accordingly, the content controller 161 can successively play back related pieces of content for respective environment states (scenes) that are identical to each other but provided for different periods of time.

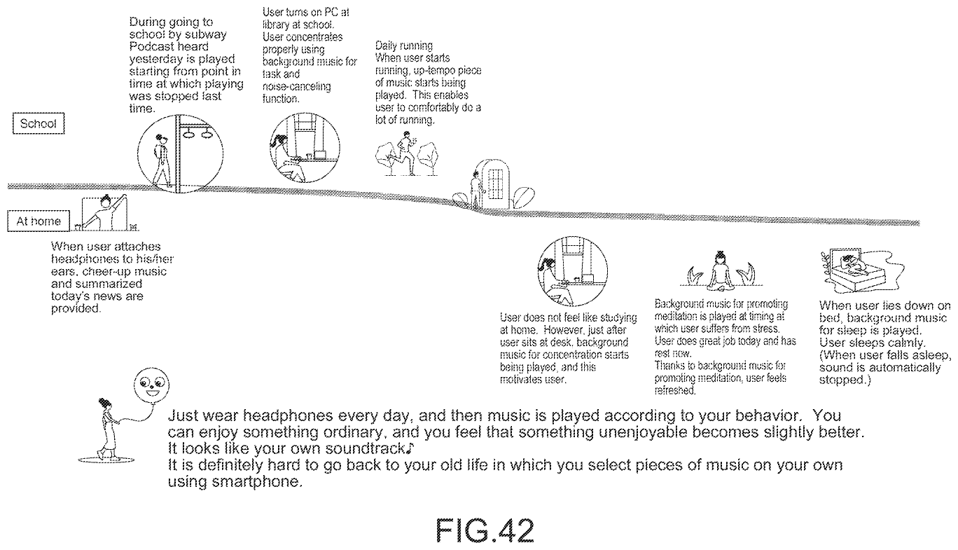

FIG. 42 illustrates another example of a user experiencing content suitable for a scene.

As an example, when the wearable device 200 is worn in the morning, the content controller 161 plays back content suitable for morning. When a user (a student in this example) goes to school, the content controller 161 resumes playing a piece of music last played (on the previous day) in a playlist set for “going to school”. When the user turns on a PC at a library, the content controller 161 plays a playlist set for “task”, and turns on a noise-canceling function.

When the user is running, the content controller 161 plays back up-tempo content. When the user sits at his/her desk at home to study, the content controller 161 plays background music for concentration. When the user is under great stress, the content controller 161 plays background music for promoting meditation. When the user lies down on a bed at night, the content controller 161 plays background music for sleep, and when the user falls asleep, the content controller 161 stops content. Accordingly, content is automatically played back according to the behavior of a user just by the wearable device 200 being worn by the user at all times. This enables the user to live comfortably.

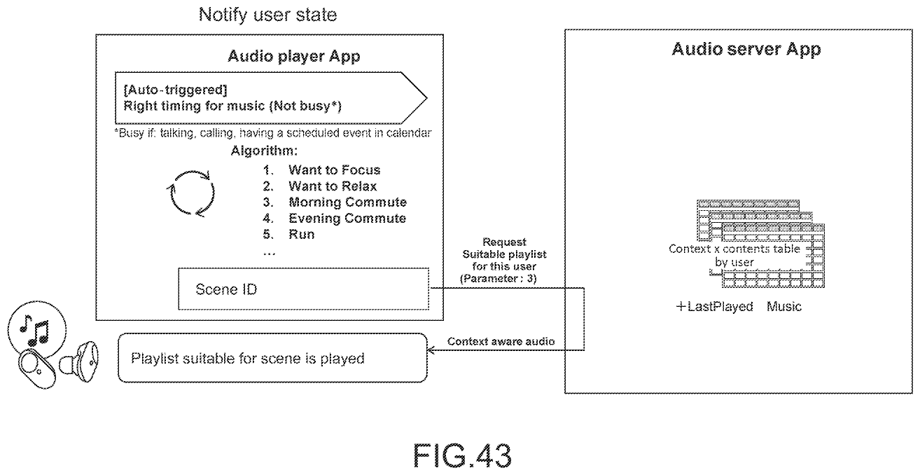

FIG. 43 illustrates a first implementation (a content control application controls the content provision application).

In the first implementation, a content control application 300 controls the content provision application 400. The content control application 300 determines a scene ID from, for example, a user state (“not busy”), and notifies the content provision application 400 of the scene ID. “Not busy” refers to a state that is not a state of “busy” (having a talk, a call, or an event scheduled in a calendar). The content provision application 400 determines, on the basis of the scene ID, a playlist suitable for a scene using a context, a user-specific content table, and last played back content, and plays the determined playlist.

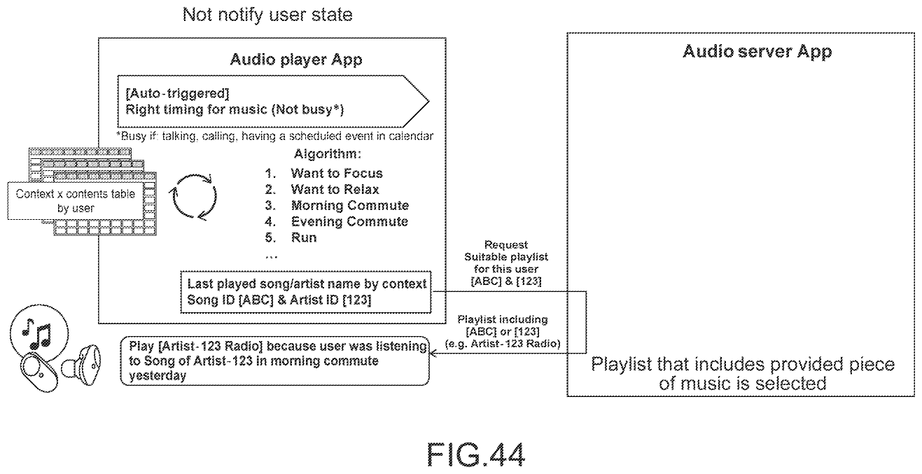

FIG. 44 illustrates a second implementation (the content control application records information regarding content last played back in a scene, and specifies a content ID for each context).

In the second implementation, the content control application 300 records information regarding content last played back in a scene, and specifies a content ID for each context. The content control application 300 determines a scene ID from, for example, a user state (“not busy”), and notifies, on the basis of the scene ID, the content provision application 400 of the scene ID and an artist ID using a context, a user-specific content table, and last played-back content. The content provision application 400 selects a playlist that includes content specified using the content ID and the artist ID, and plays the selected playlist.

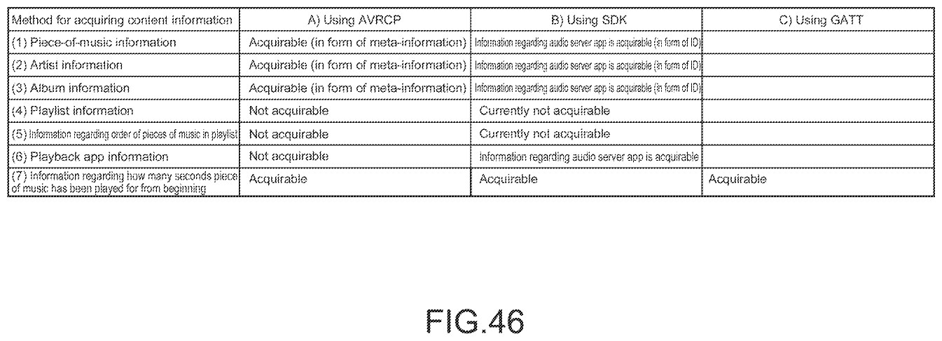

FIG. 46 illustrates an example of a method for acquiring content information.

As an example, the content controller 161 remembers information regarding content heard by a user for 30 seconds or more (the case in which playback performed for 30 seconds or more is counted as playback performed once). At this point, the content information is associated with a specified classification type of “scene”, and is recorded, in the form of a log, together with information regarding contexts such as the time, a location, and the type of behavior. Examples of the content information include piece-of-music information, artist information, album information, playlist information, information regarding the order of pieces of music in a playlist, playback app information, and information regarding how many seconds a piece of music has been played for from the beginning. When the content controller 161 detects a context in conformity to a scene determining rule, the content controller 161 performs resume play at a point in time, in the scene, at which playback was stopped last time. Note that, when the content controller 161 remembers content information, the second for which a user has heard the content may be shorter than or longer than 30 seconds, may be set by the user as appropriate, or may be automatically set for each piece of content.

When content information is acquired using Audio/Video Remote Control Profile (AVRCP), this provides advantages in that there is no need for negotiation for a partner and there are no restrictions on type of membership, that is, paid membership or free membership. This provides a disadvantage in that playing may be resumed with a low degree of reproducibility. In other words, playback app information is not acquired, and text-based meta-information is acquired as piece-of-music information. Thus, there is a possibility that the content controller 161 will make a request that a service B performs playing, on the basis of meta-information regarding a piece of music played by a user using a service A but a matched piece of music will not be found and reproduction will fail.

When content information is acquired using Software Development Kit (SDK), this provides an advantage in that resuming of playing can be reproduced for each piece of music and for each artist. An ID for a piece of music, an artist ID, an album ID, and the like that are managed by the content provision application 400 can be acquired. Thus, an album that includes the piece of music and the artist can be played.

When content information is acquired using Generic Attribute Profile (GATT), this provides an advantage in that resuming of playing can be reproduced for each piece of music, for each artist, and for each playlist, which results in a highest quality of experience. If a uniform resource identifier (URI) of a playlist, the order of pieces of music, and the like are acquired in addition to an ID for a piece of music, an artist ID, and an album ID that are managed by the content provision application 400, resuming of playing a piece of music in a playlist starting in the middle of the piece of music, can be reproduced.

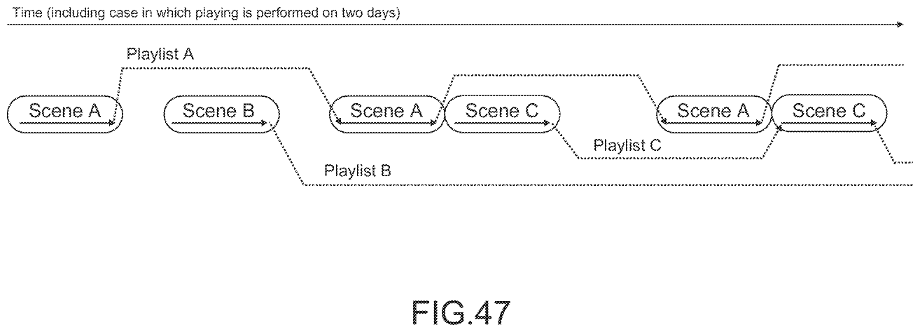

FIG. 47 illustrates a state in which one playlist is successively played for scenes that are identical to each other but occur for different periods of time.

With respect to a first example of a playlist, pieces of music are classified into categories on the basis of user's preference, and pieces of music in each category are provided to the user in the form of a playlist, where the playlist is dynamically generated on the basis of preference selected by the user. A second example of a playlist is a playlist generated by a creator selecting pieces of music (a set of pieces of music). In the second example, the following three choices are conceivable when playing of a playlist is finished: the case in which the content controller 161 returns to the beginning of the playlist to play the playlist, the case in which the content controller 161 recommends a playlist that is likely to be related to the playlist of which playing has been finished, and plays the recommended playlist when a user accepts the recommended playlist, and the case in which the content controller 161 finishes playing a playlist.

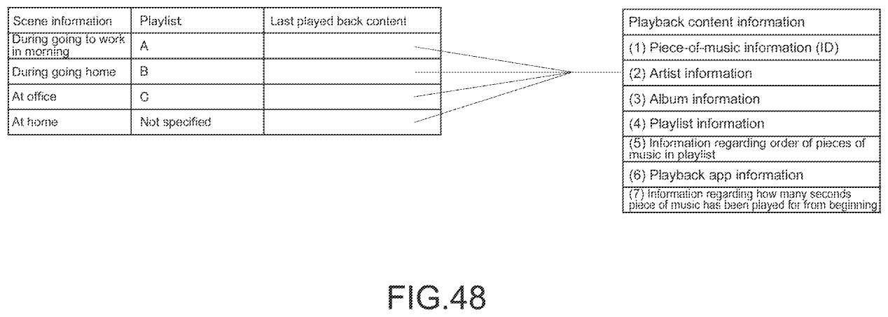

FIG. 48 illustrates an example of a table of the content playback controlling application.

When a user gets on a commuter train in the morning, content for “going to work in the morning” is recommended to the user by sound. When the user interacts by providing “Yes”, this enables the user to start hearing a piece of music last heard by the user during going to work in the morning at a point in time at which playing of the piece of music was stopped last time.

As an example of an implementation method, the content controller 161 remembers information regarding content heard by a user for 30 seconds or more (the case in which playback performed for 30 seconds or more is counted as playback performed once). Examples of the content information include piece-of-music information, artist information, album information, playlist information, information regarding the order of pieces of music in a playlist, playback app information, and information regarding how many seconds a piece of music has been played for from the beginning. At this point, the content controller 161 associates the content information with a specified classification type of “scene”, and records the content information in the form of a log together with information regarding contexts such as the time, a location, and the type of behavior. When the content controller 161 detects a context in conformity to a “scene” determining rule, the content controller 161 performs resume play at a point in time, in the scene, at which playback was stopped last time. Note that, when the content controller 161 remembers content information, the second for which a user has heard the content may be shorter than or longer than 30 seconds, may be set by a user as appropriate, or may be automatically set for each piece of content.

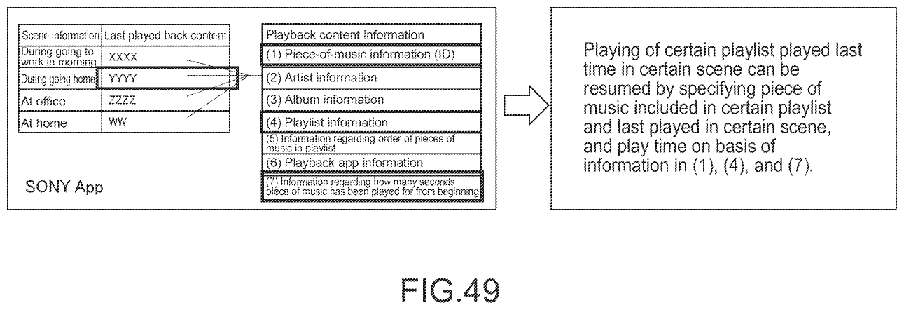

FIG. 49 illustrates an example of a table of the content playback controlling application.

For example, the content controller 161 can resume playing a certain playlist played last time in a certain scene by specifying the content “YYYY” included in the certain playlist and last played back in the certain scene, and the playback time on the basis of piece-of-music information, playlist information, and information regarding how many seconds a piece of music has been played for from the beginning.

A user may specify in advance a playlist to be played for a scene. For example, a user sets a playlist A for a scene (1), sets a playlist B for a scene (2), and sets no playlist for a scene (3).

When no playlist is specified, the content controller 161 records a playlist that is being played by a user. The content controller 161 records a playlist C when the playlist C is being played for the scene (3). The content controller 161 plays the playlist C when the wearable device 200 is worn in the scene (3).

When a user does not change playlists manually, the content controller 161 does not change a combination of a scene and a playlist.

When a user changes playlists manually in the middle of a scene, the content controller 161 starts playing the playlist A in the scene (1), and changes the playlist to a playlist D in the middle of the scene (1). When the scene (1) is over and the scene (1) starts again after the elapse of a certain period of time, the content controller 161 plays (suggests) the playlist A. When the playlist A is refused, the content controller 161 suggests the playlist C (suggests in order of priority). Suggestion may be provided using a GUI. The case in which a user is encouraged to change playlists and accepts the change, is also included.

When a user displays a GUI in order to change playlists, the content controller 161 may make a recommendation on the basis of a scene.

The content controller 161 can reflect, in a dynamically generated playlist, preference with respect to a piece of music in a scene. The content controller 161 analyses preference using “skips” and “likes” in each scene, and this enables the content controller 161 to reflect preference in content desired in each scene and in a dynamic playlist generated for each scene.

The content controller 161 keeps on playing one playlist when apparatuses of a plurality of apparatuses are used to perform playing for respective scenes identical to each other. For example, in the case in which a user plays a playlist for Saturday nights on a smartphone, stops music for some time upon arriving home, and resumes playing music on an audio apparatus after a meal, the content controller 161 resumes playing the playlist for Saturday nights.

The content control application 300 defines a scene on the basis of the behavior of a user, information regarding the user, and an environment. Examples of the behavior include walking, running, laughing, being on a train, being at home, feeling good, and not feeling good. Examples of the information regarding a user include being at a meeting, being at the office, during shopping, and being on duty. Examples of the environment include weather and a period of time. The scene is defined by combining the pieces of information described above (all of the pieces of information do not necessarily have to be included). Examples of the scene include during going to work, being at the office, and running on day off.

The content control application 300 selects a playlist according to a scene and plays the selected playlist. Specifically, a playlist is selected to be played at the time of starting playing and at the time of changing scenes during playing. A scene and a playlist may be associated with each other by a user in advance. When there is a change in playlist in the middle of a scene, replacement may be performed (when playing of a playlist is stopped for some time, a preset playlist will be played again). For example, a playlist suitable for “during going to work” is selected to be played when a user goes to work, and a playlist that promotes concentration is selected to be played when a user is at the office. A piece of music that is being played at a timing at which there is a change in scene is played to the end, and a playlist suitable for a current scene is played after the playing of the piece of music is finished. Playing is suggested according to a scene when the wearable device 200 is worn. Not playing is another choice.

When a piece of music is selected for a certain scene, the content control application 300 plays a playlist previously played for the certain scene, the playing of the playlist starting at a point in time at which playing of the playlist was stopped last time. When playing of a piece of music is stopped in the middle of a scene, the piece of music is stored, and playing of the stored piece of music may be resumed when the certain scene occurs next time.

The content control application 300 confirms with a user whether the playlist is allowed to be changed when there is a change in scene. The user can refuse the change in playlist in response to the confirmation. Notice sound is provided at the same time as a currently played piece of music to notify a user that a playlist is to be changed. In response to the change confirmation being provided using notice sound, the user can refuse or accept the change using a key operation, voice, or input of a gesture.

### 12. Example of Searching for Content by Adding Context to Content

The content controller 161 can be applied to provision or recommendation of not only music but also other content. With respect to content other than music, the content controller 161 can provide showing-target content according to a scene. In a train used to go to work, the content controller 161 plays a playlist for a video of news about the economy. In a train used to go home, the content controller 161 plays a playlist for a video of a YouTuber whom a user likes. With respect to content on social media, the content controller 161 can also change pieces of display-target content according to a scene. The content controller 161 selects news about the economy in a train used to go to work, and selects, for example, entertainment content in a train used to go home. The content controller 161 can change pieces of provision-target content according to a detected scene by defining provision-target content according to a scene for each device (for each device category).

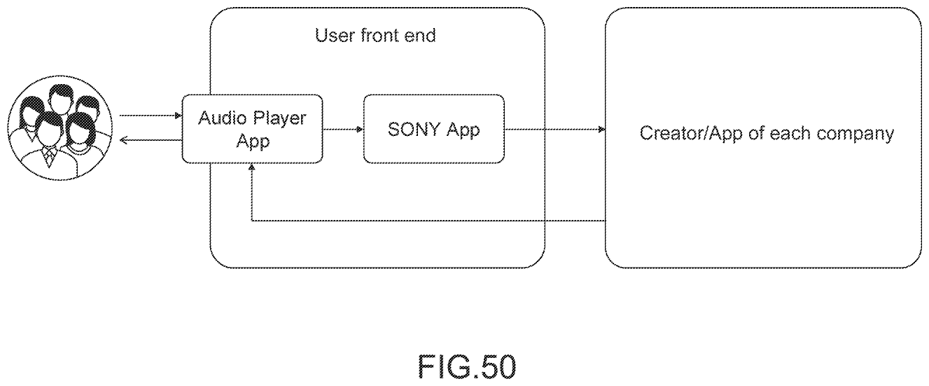

FIG. 50 illustrates an idea of characteristics of a user front end.

The wearable device 200 and the content playback controlling application 300 correspond to a user front end, and to an interface that serves to provide a creator behind the interface or an application provided by each company.

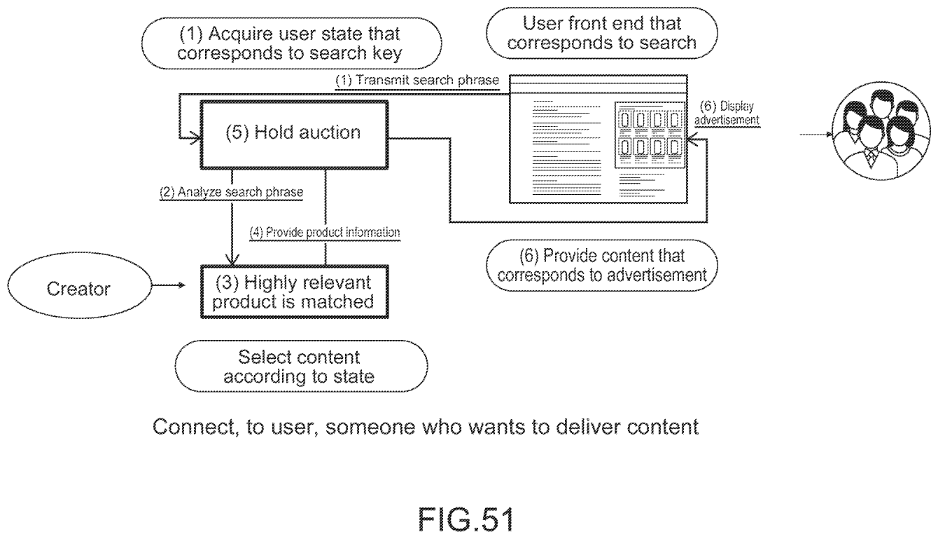

FIG. 51 is a diagram used to describe characteristics of a user front end using a search as an example.
(1) A user state that corresponds to a search key is acquired, and a search phrase is transmitted. (2) The search phrase is analyzed. (3) A highly relevant product from among products suggested by a creator is matched (content suitable for the state is selected). (4) Production information is provided. (5) An auction is held. (6) Content that corresponds to an advertisement is provided to a user. Accordingly, a creator who wants to deliver content can be connected to a user.

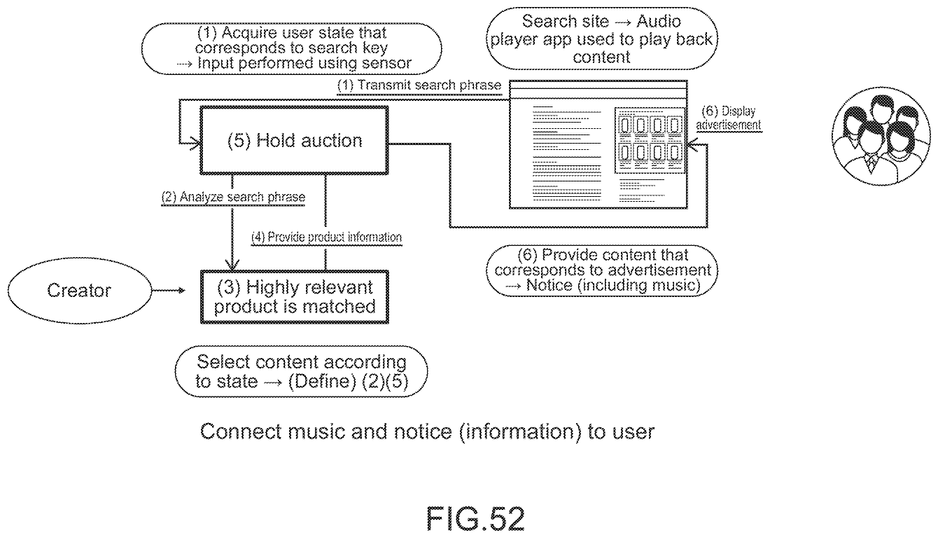

FIG. 52 is a diagram used to describe characteristics of a user front end according to the present embodiment.
(1) A user state that corresponds to input performed using a sensor, and a search phrase is transmitted. (2) The search phrase is analyzed. (3) A highly relevant product from among products suggested by a creator is matched (content suitable for the state is selected to be automatically played). (4) Production information is provided. (5) An auction is held. (6) Content that corresponds to an advertisement is provided to a user, and automatically, a notice is reproduced and music content is played back. Accordingly, a notice and music content (information) can be connected to a user.

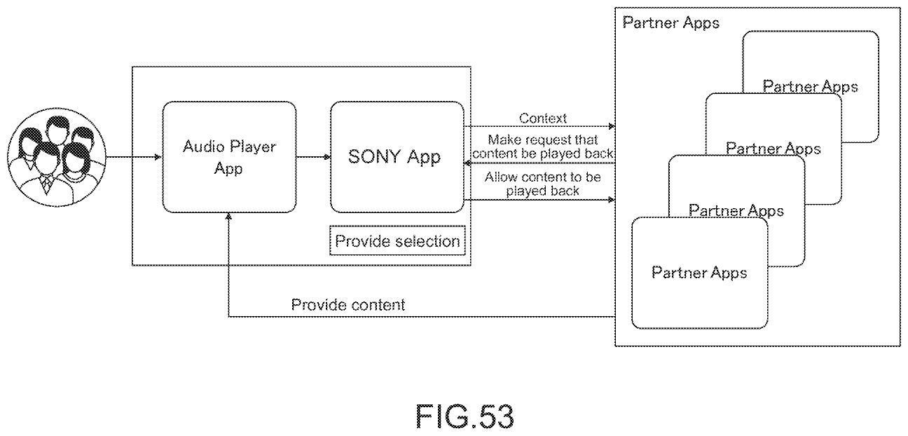

FIG. 53 is a diagram used to describe the characteristics of the user front end according to the present embodiment.

The content playback controlling application 300 provides a context of a user to the content provision application 400. The content provision application 400 makes a request that the content playback controlling application 300 allow content playback. The content playback controlling application 300 allows the content provision application 400 to play back content. The content provision application 400 provides content to the wearable device 200 to play back the content.

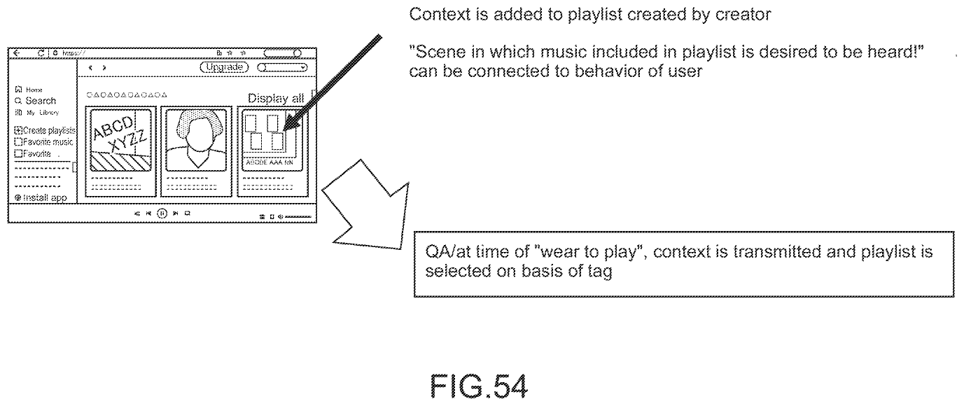

FIG. 54 illustrates a state in which a playlist is specified by a creator.

A creator adds a context to a created playlist, and this enables the creator to connect, to the behavior of a user, a scene in which music included in the created playlist is desired to be heard. At a timing at which the wearable device 200 is worn, the content playback controlling application 300 transmits a context and selects a playlist on the basis of a tag.

In order for a playlist to be specified as described above, a context list is provided to a creator in advance. The creator creates a playlist and sets a context with which the playlist is desired to be played. When a user has a specific context, the playlist provided by the creator is selected.

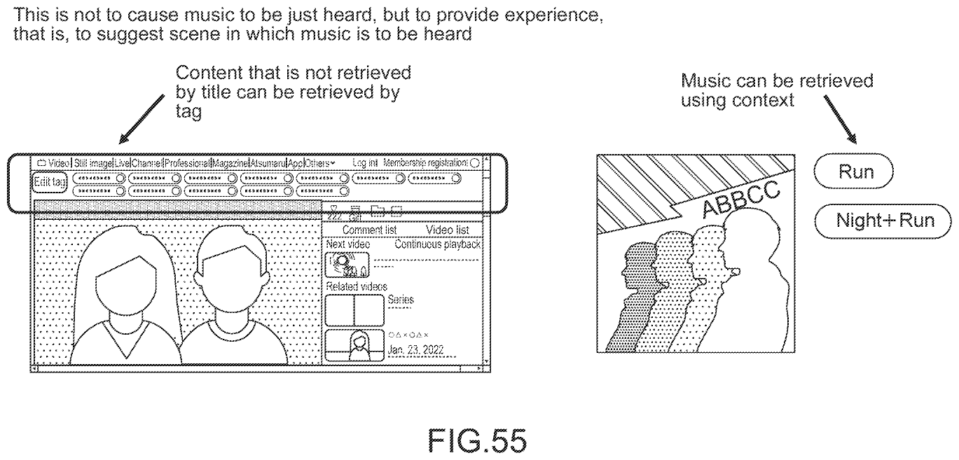

FIG. 55 illustrates a method for providing content suitable for a scene.

An object of the content playback controlling application 300 is not to cause music to be just heard, but to provide an experience, that is, to suggest a scene in which music is to be heard. The content playback controlling application 300 enables content that is not retrieved by a title to be retrieved by a tag. A tag can be attached by a user or a creator. The content playback controlling application 300 enables music content to be retrieved by a context (such as “run” or “night+run”). The content playback controlling application 300 makes it possible to retrieve a context using the behavior of a user as a search key.

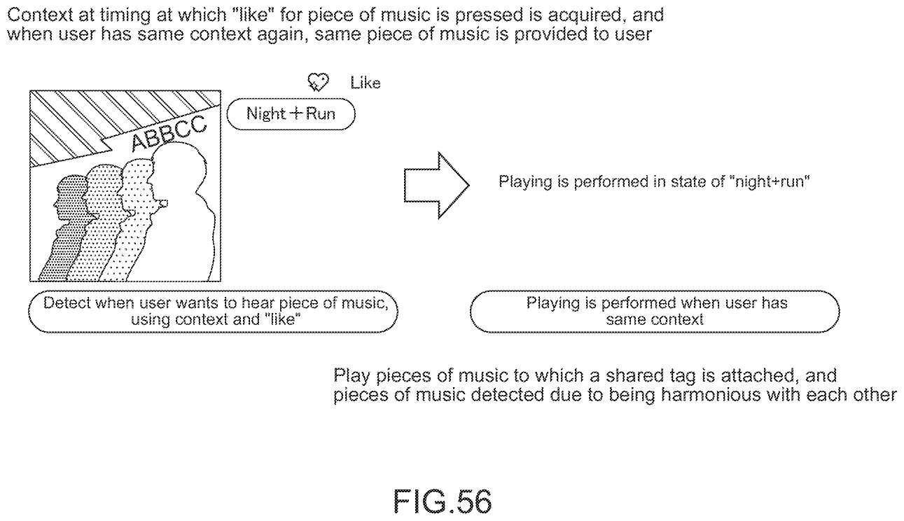

FIG. 56 illustrates a method for playing back music content when a user wants to hear.

The content playback controlling application 300 acquires a context of a user at a timing at which a “like” for music content is pressed, and when the user has the same context again, the content playback controlling application 300 plays back the same content to provide the content. For example, when the content playback controlling application 300 detects a context of and a “like” for “night+run”, the content playback controlling application 300 plays back the same content in the case in which a user has the same context (“night+run”) again. Accordingly, the content playback controlling application 300 plays pieces of music to which a shared tag is attached, and pieces of music detected due to being harmonious with each other.

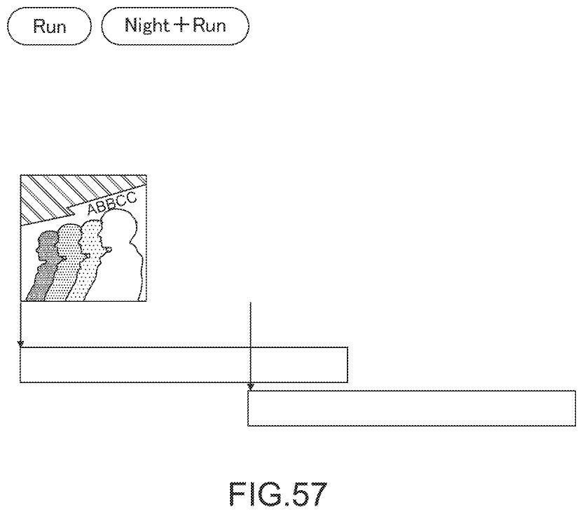

FIG. 57 illustrates an example of dynamically changing pieces of content on the basis of a tag.

For example, it is assumed that, while a user is running (tag: “run”), night falls (tag: “night+run”). The content playback controlling application 300 detects a change in tag and dynamically changes pieces of playback-target content.

### 13. Registration and Matching

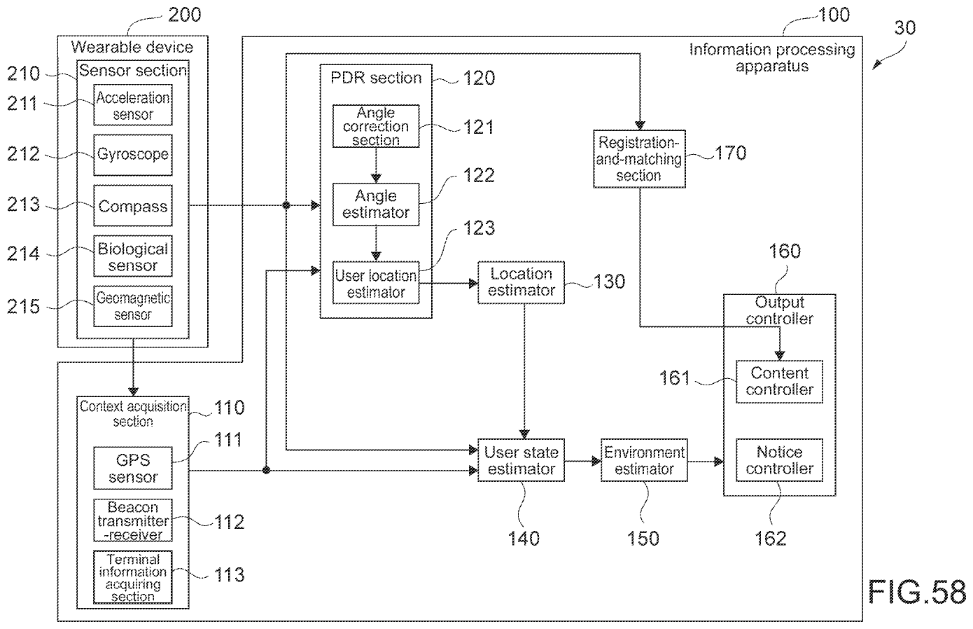

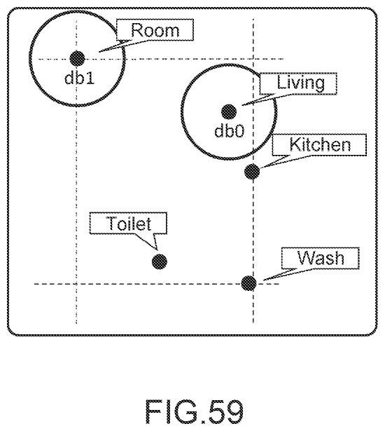

FIG. 58 illustrates a configuration of an information processing system according to another embodiment of the present disclosure. FIG. 59 illustrates an overview of a registration-and-matching section.

An information processing system 30 has a configuration obtained by adding a registration-and-matching section 170 to the configuration of the information processing system 10 in FIG. 1. The sensor section 210 further includes a geomagnetic sensor 215. The registration-and-matching section 170 of the information processing system 30 associates a detection value (a registration-use detection value) detected by the sensor section 210 with a corresponding environment state (such as “focus”), and registers the associated detection value and environment state in advance. For example, the registration-and-matching section 170 associates a detection value detected by the sensor section 210 during telecommuting at a living room with an environment state (“focus”), and registers the associated detection value and environment state in a database (db0), as illustrated in FIG. 59. Further, the registration-and-matching section 170 associates a detection value detected by the sensor section 210 at a bedroom with an environment state (“relax”), and registers the associated detection value and environment state in a database (db1). Accordingly, when a detection value that is matched to a registered registration-use detection value is newly detected, the information processing system 30 can output content that enables a user to focus his/her mind on tasks or content that enables a user to feel relaxed to sleep well, on the basis of an environment state registered in association with the registration-use detection value.

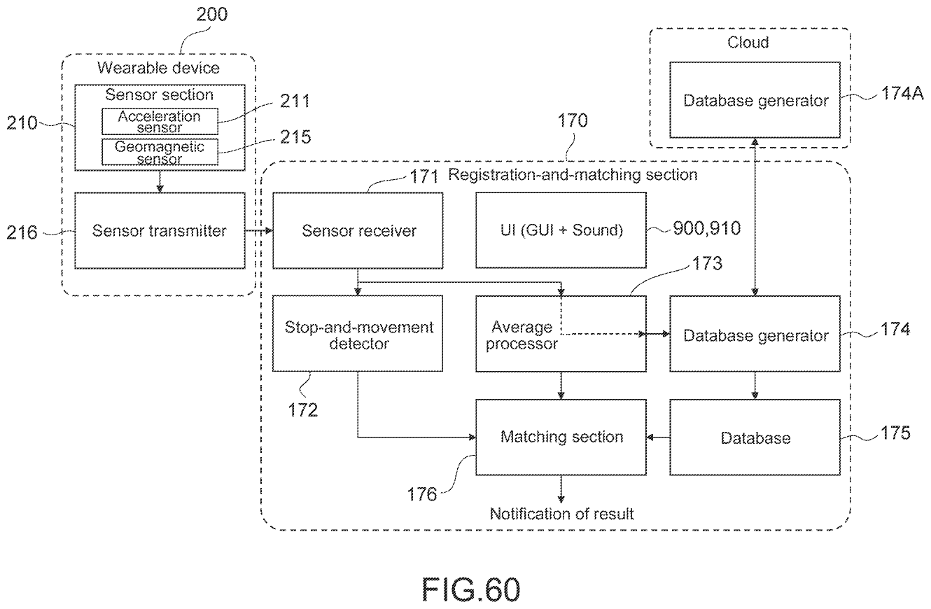

FIG. 60 illustrates a configuration of the registration-and-matching section.

The registration-and-matching section 170 includes a sensor receiver 171, a stop-and-movement detector 172, an average processor 173, a database generator 174, a database 175, and a matching section 176.

The sensor receiver 171 receives detection values detected by the sensor section 210 (the acceleration sensor 211 and the geomagnetic sensor 215) and transmitted by a sensor transmitter 216 of the wearable device 200. Note that FIG. 60 illustrates an example in which the sensor section 210 includes the acceleration sensor 211 and the geomagnetic sensor 215. Without being limited thereto, the sensor section 210 may include, for example, the gyroscope 212, the compass 213, and the biological sensor 214 (FIG. 58). In other words, the number of sensors and the type of sensor are not limited to the example illustrated in FIG. 60. The stop-and-movement detector 172 determines a stop and a movement of a user on the basis of a detection value. The average processor 173 calculates, as a registration-use detection value, an average of a plurality of detection values detected by the sensor section 210 for a specified period of time. The database generator 174 associates a registration-use detection value detected by the sensor section 210 with an environment state (such as “focus”) to be provided to a user when the registration-use detection value is detected, and registers the associated registration-use detection value and environment state in the database 175. Note that all of the database generator 174, or a portion 174A of the database generator 174 that has a large amount of computation may be arranged on a cloud without being locally arranged in the information processing apparatus 100.

The matching section 176 checks a detection value newly detected by the sensor section 210 against a registration-use detection value registered in the database 175 to perform matching, and determines whether a difference between the new detection value and the registration-use detection value registered in the database 175 is less than or equal to a matching threshold. When the difference between the detection value and the registered registration-use detection value is determined to be less than or equal to the matching threshold, the content controller 161 of the output controller 160 controls output on the basis of an environment state (such as “focus”) registered in the database 175 in association with the registration-use detection value.

Processing performed by the registration-and-matching section 170 is more specifically described below.

### (1) Variation of Registration Processing Performed by Registration-and-Matching Section 170

### (1-1) Registration and Checking

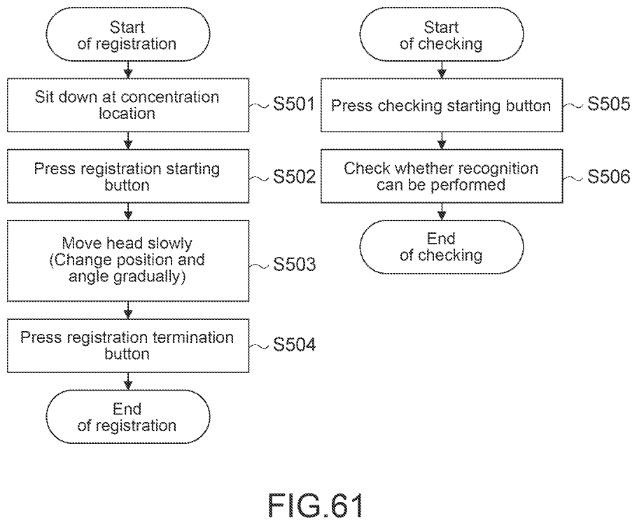

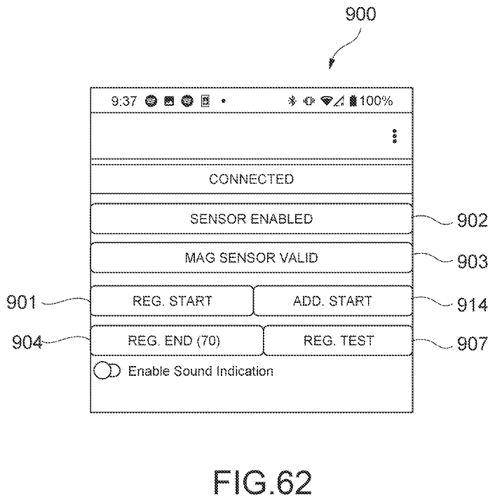

FIG. 61 illustrates a flow of an operation of processing of registration and checking. FIG. 62 illustrates an example of a GUI used for registration and checking.

A user who is wearing the wearable device 200 stops (for example, sits down) at a location (for example, a location at which the user telecommutes) for which a detection value detected by the sensor section 210 is desired to be registered (Step S501). When the sensor receiver 171 receives a valid detection value from the sensor section 210 and checks for calibration, the registration-and-matching section 170 displays, for example, a status 902 of the acceleration sensor 211 and a status 903 of the geomagnetic sensor 215 (a geomagnetic sensor) on a GUI 900 displayed on the information processing apparatus 100 (such as a smartphone). The user operates a registration starting button 901 of the GUI 900 (Step S502). Then, the registration-and-matching section 170 displays, on the information processing apparatus 100 (such as a smartphone) or another information processing apparatus (such as a personal computer used for telecommuting), an instruction screen used to give an instruction to move the head. The user moves his/her head slowly according to the instruction screen, such that a position and an angle of the head are changed gradually (Step S503). The user operates a registration termination button 904 (Step S504).

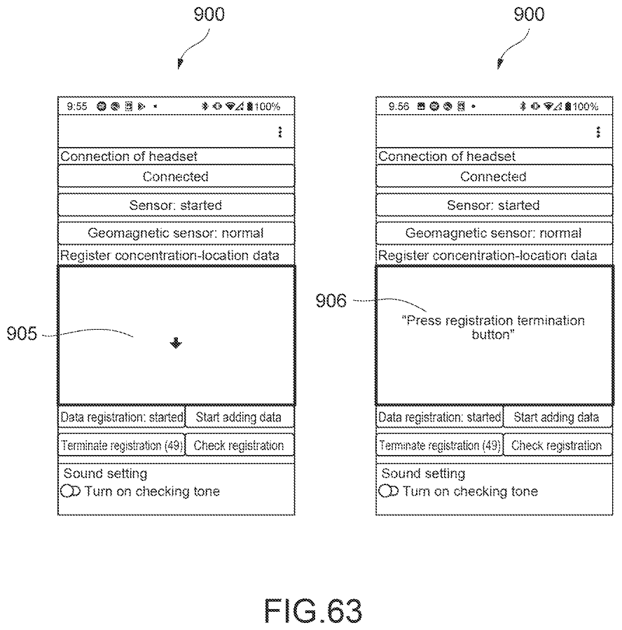

FIG. 63 illustrates an example of an instruction screen displayed on a smartphone and used to give an instruction to move the head.

When a registration starting button 901 is operated (Step S502), the registration-and-matching section 170 displays an icon 905 of, for example, an arrow on the GUI 900 displayed on the information processing apparatus 100 (such as a smartphone), and displays an animation of the icon 905 moving smoothly to trace an expected movement of a head of a user at a speed suitable for the user to move his/her head slowly (Step S503). When the movement of the icon 905 is completed, a message 906 used to make a request that the registration termination button 904 be operated (Step S504) is displayed.

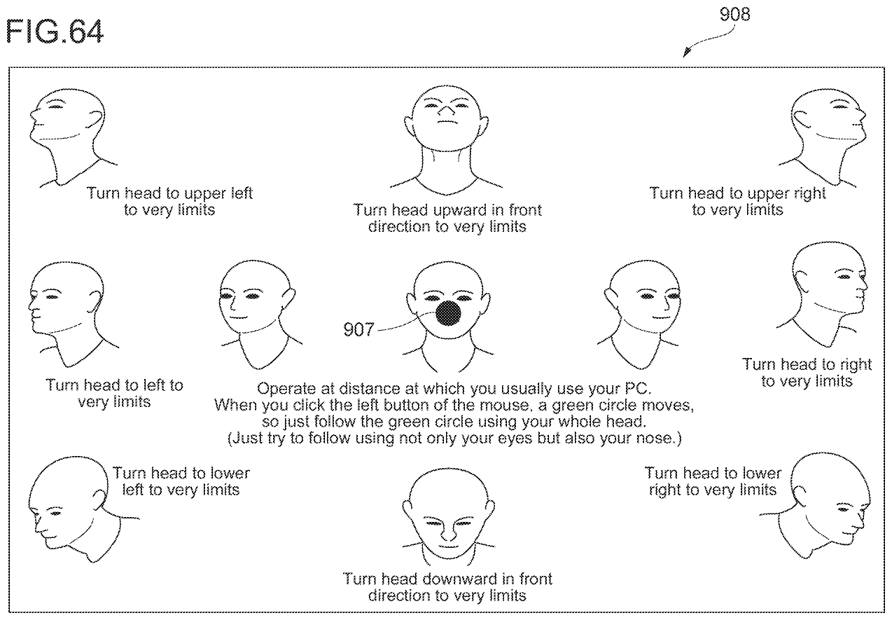

FIG. 64 illustrates an example of an instruction screen displayed on a personal computer and used to give an instruction to move the head.

When the registration starting button 901 is operated (Step S502), the registration-and-matching section 170 displays, on another information processing apparatus (such as a personal computer used upon telecommuting), an icon 907 of, for example, a circle and an instruction screen 908 on which, for example, instruction messages and pictures each showing an orientation of a face appear, and displays an animation of the icon 907 moving smoothly to trace an expected movement of a head of a user at a speed suitable for the user to move his/her head slowly (Step S503). When the movement of the icon 907 is completed, a message used to make a request that the registration termination button 904 displayed on the GUI 900 of the information processing apparatus 100 (such as a smartphone) be operated (Step S504) is displayed. Note that the icon 907 of, for example, a circle and the instruction screen 908 on which, for example, instruction messages and pictures each showing an orientation of a face appear may be displayed on the GUI 900 of the information processing apparatus 100 (such as a smartphone).

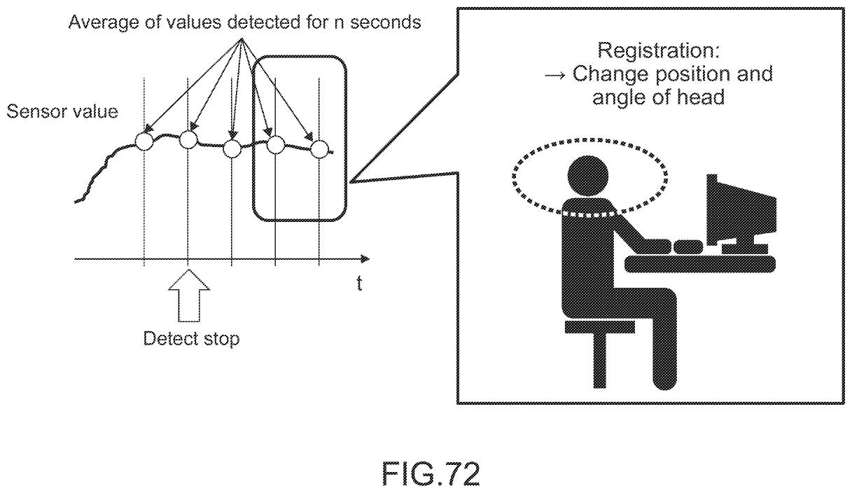

FIG. 72 illustrates calculation of an average.

When a user operates the registration termination button 904 (Step S504), the average processor 173 calculates, as a registration-use detection value, an average of a plurality of detection values detected by the sensor section 210 for a specified period of time (from a point in time just before stopping (Step S501) to a point in time of terminating registration (Step S504)), and temporarily stores the calculated registration-use detection value in a memory. The database generator 174 associates the registration-use detection value detected by the sensor section 210 with an environment state (such as “focus”) to be provided to the user when the registration-use detection value is detected, and registers the associated detection value and environment state in the database 175.

Thereafter, when the user operates a checking starting button 907 (Step S505), the matching section 176 checks whether the registration-use detection value registered in the database 175 is valid (Step S506). Specifically, the matching section 176 checks a detection value newly detected by the sensor section 210 after registration against a registration-use detection value registered in the database 175 to perform matching, and determines whether a difference between the new detection value and the registration-use detection value registered in the database 175 is less than or equal to a matching threshold. When the difference is less than or equal to the matching threshold, the registration-use detection value registered in the database 175 is determined to be valid. The matching section 176 outputs (displays, on, for example, the GUI 900) a checking result, that is, whether the registration-use detection value registered in the database 175 is valid.

### (1-2) Registration Performed for Plurality of Locations

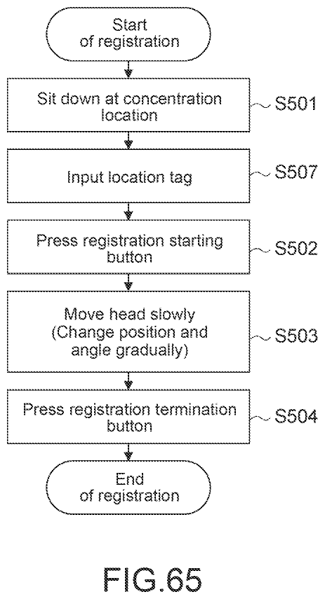

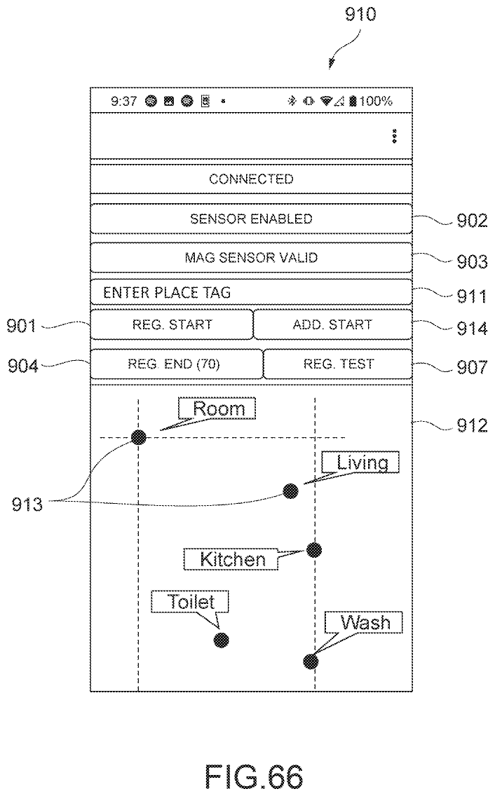

FIG. 65 illustrates a flow of an operation of performing registration for a plurality of locations. FIG. 66 illustrates an example of a GUI used to perform registration for a plurality of locations.

In addition to the display of the GUI 900 used for registration and checking (FIG. 62), a GUI 910 used to perform registration for a plurality of locations includes a location tag inputting button 911 and a layout image 912 that shows a layout of a house.

In the following description, a description of a step similar to the already described step is omitted. When a user who is wearing the wearable device 200 sits down (Step S501), the user operates one of icons 913 displayed on the layout image 912 that corresponds to a location for which registration is desired to be performed, and operates the location tag inputting button 911 (Step S507). Thereafter, the user performs operations as described above to move his/her head (Steps S502 to S504). The database generator 174 associates a registration-use detection value detected by the sensor section 210, an environment state (such as “focus”) to be provided to the user when the registration-use detection value is detected, and an input location tag (Step S507), and registers the associated detection value, environment state, and location tag in the database 175. The repetition of the processes described above makes it possible to perform registration for a plurality of locations.

For example, the registration-and-matching section 170 associates a detection value detected by the sensor section 210 during telecommuting at a living room, an environment state (“focus”), and a location tag “living”, and registers the associated detection value, environment state, and location tag in the database 175. Further, the registration-and-matching section 170 associates a detection value detected by the sensor section 210 at a bedroom, an environment state (“relax”), and a location tag “room”, and registers the associated detection value, environment state, and location tag in another database 175. Accordingly, when a detection value that is matched to a registered registration-use detection value is newly detected, the information processing system 30 can output content that enables a user to focus his/her mind on tasks or content that enables a user to feel relaxed to sleep well, on the basis of an environment state registered in association with the registration-use detection value.

### (1-3) Additional Registration Performed Using Buttons

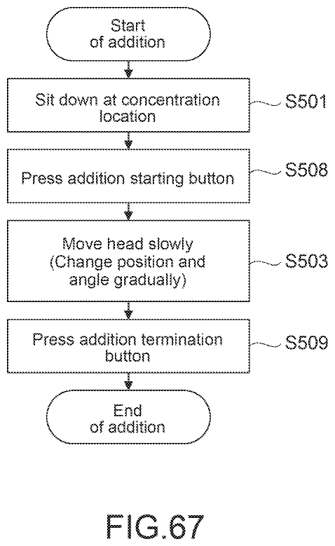

FIG. 67 illustrates a flow of an operation of additional registration performed using buttons.

The additional registration is performed when registration has failed as a result of (1) registration and checking or (2) registration performed for a plurality of locations. A GUI used to perform additional registration using buttons is similar to the GUI 900 used for registration and checking (FIG. 62).

When a user who is wearing the wearable device 200 sits down (Step S501), the user operates an additional registration button 914 (FIG. 62) (Step S508). Thereafter, the user performs operations as described above to move his/her head (Steps S502 and S503). The user operates an addition termination button (Step S509). A button dedicated to the addition termination button may be displayed on the GUI 900, or the registration termination button 904 may be used as the addition termination button (FIG. 62). The database generator 174 associates a registration-use detection value detected by the sensor section 210 with an environment state (such as “focus”) to be provided to the user when the registration-use detection value is detected, and additionally registers the associated detection value and environment state in the database 175.

### (1-4) Additional Registration Performed Using Layout

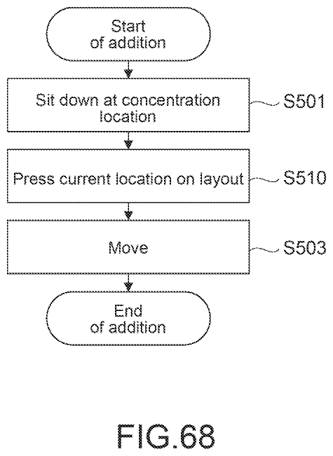

FIG. 68 illustrates a flow of an operation of additional registration performed using a layout.

A GUI used to perform additional registration using a layout is similar to the GUI 910 used to perform registration for a plurality of locations (FIG. 66).

When a user who is wearing the wearable device 200 sits down (Step S501), the user operates one of the icons 913 displayed on the layout image 912 that corresponds to a location for which additional registration is desired to be performed (Step S510). Thereafter, the user performs operations as described above to move his/her head (Step S503). The database generator 174 associates a registration-use detection value detected by the sensor section 210 with an environment state (such as “focus”) to be provided to the user when the registration-use detection value is detected, and additionally registers the associated detection value and environment state in the database 175.

### (1-5) Automatically Performed Additional Registration

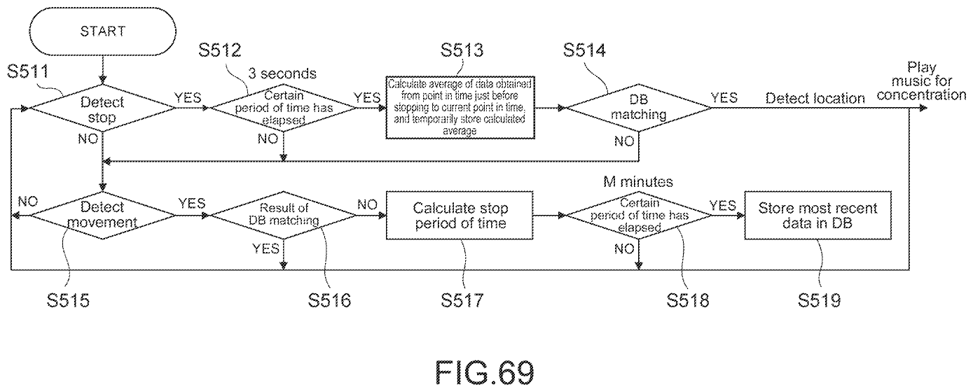

FIG. 69 illustrates a flow of an operation of automatically performed additional registration.

The stop-and-movement detector 172 determines that a user has stopped, on the basis of a detection value detected by the sensor section 210 and transmitted by the sensor transmitter 216 of the wearable device 200 (Step S511, YES). The stop-and-movement detector 172 determines that the user is at a stop for a first period of time (for example, three or four seconds) (that is, the user is at a stop for three or four seconds) (Step S512, YES). Then, the average processor 173 calculates an average of a plurality of detection values detected by the sensor section 210 for a specified period of time (from a point in time just before stopping (Step S511) to a point in time just after being at a stop for the first period of time (Step S512)), and temporarily stores the calculated average in a memory. The matching section 176 checks the new detection value temporarily stored in the memory against a registration-use detection value registered in the database 175 to perform matching (Step S514). Specifically, the matching section 176 checks an average of the new detection values that is temporarily stored in the memory against a registration-use detection value registered in the database 175 to perform matching, and determines whether a difference between the average of the new detection values that is temporarily stored in the memory and the registration-use detection value registered in the database 175 is less than or equal to a matching threshold. When the difference between the average of the new detection values and the registered registration-use detection value is determined to be less than or equal to the matching threshold, the content controller 161 of the output controller 160 controls output on the basis of an environment state (such as “focus”) registered in the database 175 in association with the registration-use detection value (Step S514, YES). Note that, when the difference between the average of the new detection values and the registered registration-use detection value is greater than the matching threshold (Step S514, NO), the average of the new detection values that is temporarily stored in the memory remains stored without being deleted from the memory since there is a possibility that the average of the new detection values will become a candidate to be registered in the database 175.

On the other hand, the case in which the user does not stop (Step S511, NO), the case in which the user is at a stop for a period of time that is less than the first period of time (Step S512, NO), and the case in which the difference between the average of the detection values and the registration-use detection value registered in the database 175 is greater than the matching threshold (Step S514, NO) are described. The stop-and-movement detector 172 determines that the user has started moving, on the basis of the detection value detected by the sensor section 210 and transmitted by the sensor transmitter 216 of the wearable device 200 (Step S515, YES). The matching section 176 checks the new detection value against the registration-use detection value registered in the database 175 to perform matching (Step S516). Since the user has started moving, the difference between the detection value and the registration-use detection value registered in the database 175 is greater than the matching threshold (Step S516, NO). The database generator 174 calculates (Step S517) a period of time (that is, a stop period of time from the user stopping to the user starting moving) for which the user is at a stop from the user stopping to the user starting moving (Step S515, YES). The database generator 174 determines whether the calculated stop period of time (that is, the stop period of time from the user stopping to the user starting moving) is longer than a second period of time (for example, M minutes) (that is, whether the user is at a stop for M minutes or more) (Step S518). When the stop period of time from the user stopping to the user starting moving is longer than the second period of time (M minutes) (Step S518, YES), the database generator 174 associates an average of a plurality of new detection values detected for a specified period of time from the user stopping to the user starting moving (Step S515, YES) with an environment state to be provided to the user when the new detection values are detected, and newly registers the associated average and environment state in the database 175 (Step S519).

The database generator 174 may update the database 175 when it is determined, from a degree of activeness of a user, that the user is in a state with a high degree of focusing or with a high degree of relaxing, the degree of activeness of the user being determined on the basis of detection values detected by the sensor section 210 (the biological sensors 214 such as a heartbeat sensor, a blood flow sensor, and a brain wave sensor in particular) and transmitted by the sensor transmitter 216 of the wearable device 200.

### (2) Variations of Registration Processing Performed by Database Generator 174

### (2-1) Using Table

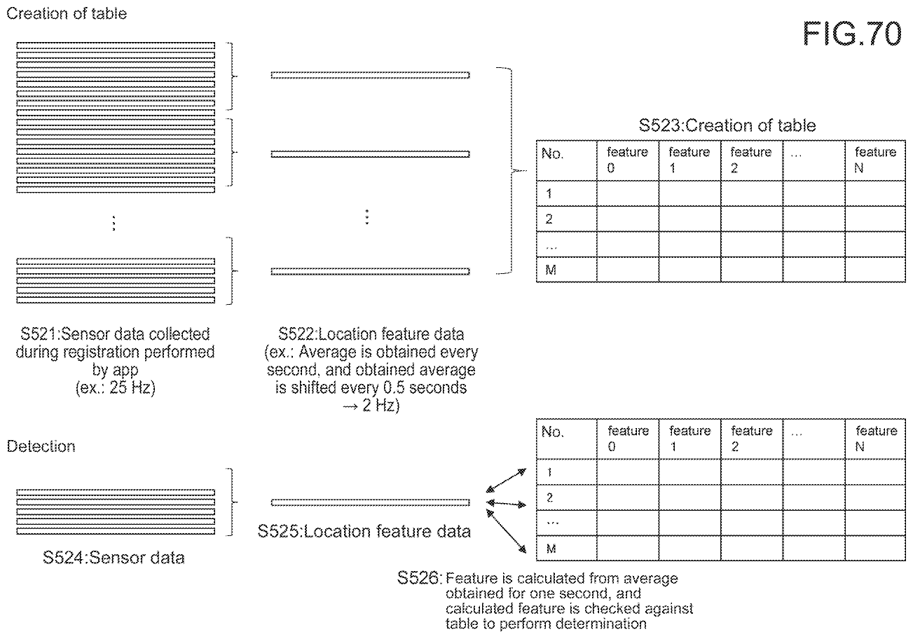

FIG. 70 illustrates a method (using a table) that includes registering a registration-use detection value and performing matching.

While a detection value detected by the sensor section 210 is being registered (Steps S501 to S504), the sensor receiver 171 receives a detection value (for example, 25 Hz) detected by the sensor section 210 and transmitted by the sensor transmitter 216 of the wearable device 200 (Step S521). The average processor 173 averages, every second, a plurality of detection values (for example, 25 Hz) detected by the sensor section 210, and shifts the average every 0.5 minutes to extract M detection values of 2 Hz (Step S522). Here, the values of 0.5 seconds and 2 Hz are merely examples, and the values are not limited thereto. The database generator 174 creates a table that registers therein M extracted detection values, and registers the created table in the database 175 (Step S523). For example, each detection value has feature amounts in eight dimensions from feature amounts 0 to 7 (N=7). The feature amounts in eight dimensions include, for example, a three-axis feature amount obtained by the acceleration sensor 211 and a three-axis feature amount obtained by the geomagnetic sensor 215 (a geomagnetic sensor).

After the detection value detected by the sensor section 210 is registered, the sensor receiver 171 receives a new detection value (for example, 25 Hz) detected by the sensor section 210 and transmitted by the sensor transmitter 216 of the wearable device 200 (Step S524). The matching section 176 calculates, for one second, an average of a plurality of detection values (for example, 25 Hz) detected by the sensor section 210 (Step S525). The matching section 176 calculates feature amounts in eight dimensions using the average for one second. The matching section 176 checks the calculated feature amounts against the feature amounts registered in the database 175 (Step S523) to perform matching (Step S526). Note that the above-described numbers of seconds, such as one second and 0.5 seconds, that are used to obtain an average, and the number of detection values extracted of 2 Hz, are merely examples, and the numbers are not limited thereto.

### (2-2) Using Machine Learning

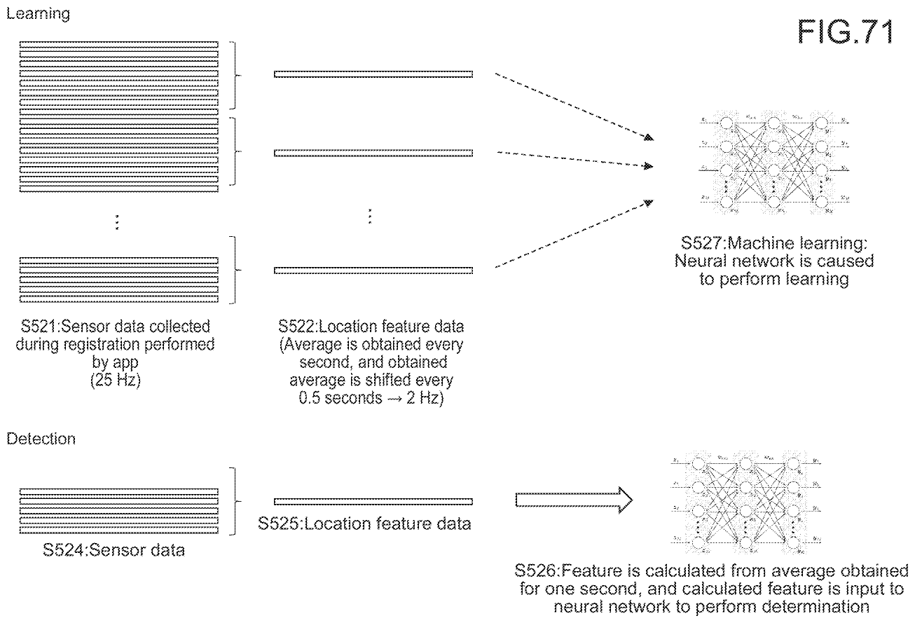

FIG. 71 illustrates a method (using machine learning) that includes registering a registration-use detection value and performing matching.

While a detection value detected by the sensor section 210 is being registered (Steps S501 to S504), the sensor receiver 171 receives a detection value (for example, 25 Hz) detected by the sensor section 210 and transmitted by the sensor transmitter 216 of the wearable device 200 (Step S521). The average processor 173 averages, every second, a plurality of detection values (for example, 25 Hz) detected by the sensor section 210, and shifts the average every 0.5 minutes to extract M detection values of 2 Hz (Step S522). The database generator 174 causes a model using a neural network to learn the M extracted detection values (Step S527). For example, each detection value has feature amounts in eight dimensions from feature amounts 0 to 7 (N=7). The feature amounts in eight dimensions include, for example, a three-axis feature amount obtained by the acceleration sensor 211 and a three-axis feature amount obtained by the geomagnetic sensor 215 (a geomagnetic sensor). Note that the number of feature amounts is not limited thereto, and any number may be accepted.

After learning is performed, the sensor receiver 171 receives a new detection value (for example, 25 Hz) detected by the sensor section 210 and transmitted by the sensor transmitter 216 of the wearable device 200 (Step S524). The matching section 176 calculates, for one second, an average of a plurality of detection values (for example, 25 Hz) detected by the sensor section 210 (Step S525). The matching section 176 calculates feature amounts in eight dimensions using the average for one second. The matching section 176 inputs the calculated feature amounts to the model using a neural network that has performed learning (Step S527) to perform matching (Step S528).

Note that a model that has performed learning at least once may continue to be used. Alternatively, learning may be performed, for example, upon starting registration (Step S502), upon performing additional registration (Step S508), or upon performing additional registration automatically (Step S511) to update the model.

According to the present embodiment, the registration-and-matching section 170 associates, in advance, a detection value detected by the sensor section 210 (a registration-use detection value) with a corresponding environment state (such as “focus”), and registers the associated detection value and environment state. Accordingly, when a detection value that is matched to a registered registration-use detection value is newly detected, the information processing system 30 can output content that enables a user to focus his/her mind on tasks or content that enables a user to feel relaxed to sleep well, on the basis of an environment state registered in association with the registration-use detection value.

The present disclosure may also include the following configurations.
(1) An information processing apparatus, including:
   a user state estimator that estimates a user state;
   an environment estimator that estimates, on the basis of the user state, an environment state to be provided to a user; and
   an output controller that controls output on the basis of the environment state.
(2) The information processing apparatus according to (1), further including:
   a user location estimator that estimates a user location on the basis of a detection value detected by a sensor section that is included in a wearable device that is worn by the user; and
   a location attribute estimator that estimates, on the basis of the user location, a location attribute that is an attribute of a location at which the user is, in which
   the user state estimator estimates the user state on the basis of the location attribute.
(3) The information processing apparatus according to (2), in which
   the user location estimator estimates the user location using pedestrian dead reckoning (PDR).
(4) The information processing apparatus according to (2) or (3), in which
   the environment estimator estimates the environment state on the basis of the location attribute.
(5) The information processing apparatus according to any one of (2) to (4), in which
   the sensor section included in the wearable device includes at least one of an acceleration sensor, a gyroscope, a compass, a biological sensor, or a geomagnetic sensor.
(6) The information processing apparatus according to any one of (3) to (5), in which
   the user location estimator includes
      an angle correction section that calculates a correction value for an azimuth corresponding to the user on the basis of the detection value detected by the sensor section included in the wearable device worn by the user,
      an angle estimator that estimates the azimuth corresponding to the user on the basis of the detection value detected by the sensor section included in the wearable device worn by the user, and on the basis of the correction value, and
      the user location estimator estimating the user location using the azimuth.
(7) The information processing apparatus according to any one of (3) to (6), in which
   the user location estimator estimates a route of movement of the user location, and
   on the basis of the route of the movement, the location attribute estimator estimates the location attribute after the movement.
(8) The information processing apparatus according to (7), in which
   the location attribute estimator holds a plurality of the routes of the movement, and performs matching by checking the estimated route of the movement against the plurality of the routes of the movement to estimate the location attribute after the movement.
(9) The information processing apparatus according to (8), in which
   when the location attribute estimator has failed to perform matching a specified number of times, the location attribute estimator outputs an alert.
(10) The information processing apparatus according to (8) or (9), in which
   the location attribute estimator performs the matching using dynamic time warping (DTW).
(11) The information processing apparatus according to any one of (1) to (10), in which
   the location attribute estimator estimates the location attribute by determining a period of time for which the user stays at a location at which the user is.
(12) The information processing apparatus according to any one of (1) to (11), further including
   a context acquisition section that acquires a context of the user, in which the user state estimator estimates the user state on the basis of the acquired context.
(13) The information processing apparatus according to (12), in which
   the context includes at least one of location information regarding a location of the user or terminal information regarding the information processing apparatus.
(14) The information processing apparatus according to any one of (1) to (13), in which
   the user state estimator estimates the user state on the basis of the detection value detected by the sensor section included in the wearable device and/or on the basis of the location attribute.
(15) The information processing apparatus according to any one of (1) to (14), in which
   the user state includes a plurality of activity states of the user.
(16) The information processing apparatus according to any one of (1) to (15), in which
   the output controller includes
      a content controller that plays back content selected on the basis of the environment state and/or
      a notice controller that controls, on the basis of the environment state, the number of notices provided to the user, and
   the content controller successively plays back related pieces of content for respective environment states that are identical to each other but provided for different periods of time.
(17) An information processing method, including:
   estimating a user state;
   estimating, on the basis of the user state, an environment state to be provided to a user; and
   controlling output on the basis of the environment state.
(18) An information processing program that causes a processor of an information processing apparatus to operate as
   a user state estimator that estimates a user state,
   an environment estimator that estimates, on the basis of the user state, an environment state to be provided to a user, and
   an output controller that controls output on the basis of the environment state.
(19) An information processing system, including:
   a wearable device; and
   an information processing apparatus that includes
      a user state estimator that estimates a user state of a user who is wearing the wearable device,
      an environment estimator that estimates, on the basis of the user state, an environment state to be provided to the user, and
      an output controller that controls output on the basis of the environment state.
(20) A non-transitory computer-readable recording medium that records therein an information processing program that causes a processor of an information processing apparatus to operate as
   a user state estimator that estimates a user state,
   an environment estimator that estimates, on the basis of the user state, an environment state to be provided to a user, and
   an output controller that controls output on the basis of the environment state.

Further, the present disclosure may also include the following configurations.
(1) A content playback system, including:
   a wearable device; and
   an information processing apparatus that includes a control circuit that executes a content playback controlling application that includes
      a user state estimator that estimates a user state of a user who is wearing the wearable device,
      an environment estimator that estimates an environment state for the user on the basis of the user state, and
      a content controller that
         generates, on the basis of the environment state, a cue used by a content provision application providing content to select the content,
         outputs the cue to the content provision application, and
         causes the content provision application to select the content on the basis of the cue to cause the content to be played back.
(2) The content playback system according to (1), in which
   the control circuit of the information processing apparatus executes a plurality of the content provision applications different from each other, and
   on the basis of the environment state, the content controller selects a specified one of the plurality of the content provision applications that is caused to play back the content.
(3) The content playback system according to (1) or (2), in which
   the control circuit of the information processing apparatus executes a plurality of the content provision applications different from each other,
   the wearable device includes an input apparatus, and
   on the basis of one of different operations that is input by the user to the wearable device, the content controller selects a specified one of the plurality of the content provision applications that is caused to play back the content.
(4) The content playback system according to any one of (1) to (3), in which
   the control circuit of the information processing apparatus executes a preset application that assigns the different operations of a plurality of the different operations to selections of the content provision applications of the plurality of the content provision applications different from each other.
(5) The content playback system according to (4), in which
   the preset application is included in the content playback controlling application.
(6) The content playback system according to any one of (1) to (5), in which
   the wearable device includes a sensor section,
   the content playback controlling application further includes
      a user location estimator that estimates a user location on the basis of a detection value input by the sensor section included in the wearable device worn by the user, and
      a location attribute estimator that estimates, on the basis of the user location, a location attribute that is an attribute of a location at which the user is, and
   the user state estimator estimates the user state on the basis of the location attribute.
(7) The content playback system according to (6), in which
   the sensor section included in the wearable device includes at least one of an acceleration sensor, a gyroscope, a compass, a biological sensor, or a geomagnetic sensor.
(8) The content playback system according to (6) or (7), in which
   the content provision application
      selects a plurality of pieces of candidate content on the basis of the cue, and
      selects a piece of playback-target content from the plurality of pieces of candidate content on the basis of the detection value input by the sensor section.
(9) The content playback system according to any one of (6) to (8), in which
   during the playback of the content, the content provision application selects an attribute of playback-target content on the basis of the detection value input by the sensor section to play back the selected content.
(10) The content playback system according to any one of (1) to (9), in which
   the content controller generates, on the basis of the environment state, a cue used by the content provision application to stop the playback of the content, outputs the cue to the content provision application, and causes the content provision application to stop the playback of the content on the basis of the cue.
(11) The content playback system according to any one of (1) to (10), in which
   the content playback controlling application further includes a context acquisition section that acquires a context of the user, and the user state estimator estimates the user state on the basis of the acquired context.
(12) The content playback system according to (6), in which
   the user location estimator includes
      an angle correction section that calculates a correction value for an azimuth corresponding to the user on the basis of the detection value detected by the sensor section included in the wearable device worn by the user, and
      an angle estimator that estimates the azimuth corresponding to the user on the basis of the detection value detected by the sensor section included in the wearable device worn by the user, and on the basis of the correction value, and
   the user location estimator estimates the user location using the azimuth.
(13) The content playback system according to (12), in which
   the sensor section included in the wearable device includes an acceleration sensor, and
   the angle correction section
      calculates an inclination of the user in a pitch direction and an inclination of the user in a roll direction, using gravitational acceleration that corresponds to the detection value detected by the acceleration sensor and occurs when the user faces the roll direction,
      calculates an inclination of the user in a yaw direction using gravitational acceleration that corresponds to the detection value detected by the acceleration sensor and occurs when the user faces the pitch direction, and using the inclination in the pitch direction and the inclination in the roll direction, and
      determines, to be the correction values, the inclination in the pitch direction, the inclination in the roll direction, and the inclination in the yaw direction.
(14) The content playback system according to any one of (1) to (13), in which
   the content controller successively plays back related pieces of content for respective environment states that are identical to each other but provided for different periods of time.
(15) The content playback system according to (7), further including:
   a database generator that associates a registration-use detection value detected by the sensor section with an environment state to be provided to the user when the registration-use detection value is detected, and registers the associated registration-use detection value and environment state; and
   a matching section that checks a new detection value detected by the sensor section against the registered registration-use detection value to perform matching, and determines whether a difference between the new detection value and the registration-use detection value is less than or equal to a matching threshold, in which
   when the difference is determined to be less than or equal to the matching threshold, the content controller generates the cue on the basis of the environment state registered in association with the registration-use detection value, and outputs the generated cue.
(16) The content playback system according to (15), in which
   when the user is at a stop for a first period of time, the matching section checks the new detection value with the registration-use detection value to perform matching, and
   when a period of time for which the user is at a stop from the user stopping to the user starting moving is longer than a second period of time, the database generator associates the new detection value detected for the period of time from the user stopping to the user starting moving with an environment state to be provided to the user when the new detection value is detected, and newly registers the associated new detection value and environment state.
(17) The content playback system according to (16), in which
   the database generator registers, as the registration-use detection value, an average of a plurality of the detection values detected by the sensor section for a specified period of time.
(18) A content playback system, including:
   a wearable device; and
   an information processing apparatus that includes a control circuit that executes a content playback controlling application that includes
      a database generator that associates a registration-use detection value detected by a sensor section included in the wearable device worn by a user with an environment state to be provided to the user when the registration-use detection value is detected, and registers the associated registration-use detection value and environment state,
      a matching section that checks a new detection value detected by the sensor section against the registered registration-use detection value to perform matching, and determines whether a difference between the new detection value and the registration-use detection value is less than or equal to a matching threshold, and
      a content controller that
         generates, when the difference is determined to be less than or equal to the matching threshold, a cue on the basis of the environment state registered in association with the registration-use detection value, the cue being used by a content provision application providing content to select the content,
         outputs the cue to the content provision application, and
         causes the content provision application to select the content on the basis of the cue to cause the content to be played back.
(19) An information processing apparatus, including
   a control circuit that executes a content playback controlling application that includes
      a user state estimator that estimates a user state of a user who is wearing a wearable device,
      an environment estimator that estimates, on the basis of the user state, an environment state to be provided to the user, and
      a content controller that
         generates, on the basis of the environment state, a cue used by a content provision application providing content to select the content,
         outputs the cue to the content provision application, and
         causes the content provision application to select the content on the basis of the cue to cause the content to be played back.
(20) A content playback controlling application that causes a control circuit of an information processing apparatus to operate as
   a user state estimator that estimates a user state of a user who is wearing a wearable device,
   an environment estimator that estimates, on the basis of the user state, an environment state to be provided to the user, and
   a content controller that
      generates, on the basis of the environment state, a cue used by a content provision application providing content to select the content,
      outputs the cue to the content provision application, and
      causes the content provision application to select the content on the basis of the cue to cause the content to be played back.
(21) A non-transitory computer-readable recording medium that records therein a content playback controlling application that causes a control circuit of an information processing apparatus to operate as
   a user state estimator that estimates a user state of a user who is wearing a wearable device,
   an environment estimator that estimates, on the basis of the user state, an environment state to be provided to the user, and
   a content controller that
      generates, on the basis of the environment state, a cue used by a content provision application providing content to select the content,
      outputs the cue to the content provision application, and
      causes the content provision application to select the content on the basis of the cue to cause the content to be played back.

The embodiments and the modifications of the present technology have been described above. Of course the present technology is not limited to the embodiments described above, and various modifications may be made thereto without departing from the scope of the present technology.

### REFERENCE SIGNS LIST

10 information processing system
100 information processing apparatus
110 context acquisition section
111 GPS sensor
112 beacon transmitter-receiver
113 terminal information acquiring section
120 PDR section
121 angle correction section
122 angle estimator
123 user location estimator
130 location estimator
140 user state estimator
150 environment estimator
160 output controller
161 content controller
162 notice controller
200 wearable device
210 sensor section
211 acceleration sensor
212 gyroscope
213 compass
214 biological sensor
215 geomagnetic sensor

What is claimed is:

1. A content playback system, comprising:
a wearable device; and
an information processing apparatus that includes a control circuit that executes a content playback controlling application that includes
a user state estimator that estimates a user state of a user who is wearing the wearable device,
an environment estimator that estimates an environment state for the user on a basis of the user state, and
a content controller that
generates, on a basis of the environment state, a cue used by a content provision application providing content to select the content,
outputs the cue to the content provision application, and
causes the content provision application to select the content on a basis of the cue to cause the content to be played back.

2. The content playback system according to claim 1, wherein
the control circuit of the information processing apparatus executes a plurality of the content provision applications different from each other, and
on the basis of the environment state, the content controller selects a specified one of the plurality of the content provision applications that is caused to play back the content.

3. The content playback system according to claim 1, wherein
the control circuit of the information processing apparatus executes a plurality of the content provision applications different from each other,
the wearable device includes an input apparatus, and
on a basis of one of different operations that is input by the user to the wearable device, the content controller selects a specified one of the plurality of the content provision applications that is caused to play back the content.

4. The content playback system according to claim 1, wherein
the control circuit of the information processing apparatus executes a preset application that assigns the different operations of a plurality of the different operations to selections of the content provision applications of the plurality of the content provision applications different from each other.

5. The content playback system according to claim 4, wherein
the preset application is included in the content playback controlling application.

6. The content playback system according to claim 1, wherein
the wearable device includes a sensor section,
the content playback controlling application further includes
a user location estimator that estimates a user location on a basis of a detection value input by the sensor section included in the wearable device worn by the user, and
a location attribute estimator that estimates, on a basis of the user location, a location attribute that is an attribute of a location at which the user is, and
the user state estimator estimates the user state on a basis of the location attribute.

7. The content playback system according to claim 6, wherein
the sensor section included in the wearable device includes at least one of an acceleration sensor, a gyroscope, a compass, a biological sensor, or a geomagnetic sensor.

8. The content playback system according to claim 6, wherein
the content provision application
selects a plurality of pieces of candidate content on a basis of the cue, and
selects a piece of playback-target content from the plurality of pieces of candidate content on a basis of the detection value input by the sensor section.

9. The content playback system according to claim 6, wherein
during the playback of the content, the content provision application selects an attribute of playback-target content on a basis of the detection value input by the sensor section to play back the selected content.

10. The content playback system according to claim 1, wherein
the content controller generates, on the basis of the environment state, a cue used by the content provision application to stop the playback of the content, outputs the cue to the content provision application, and causes the content provision application to stop the playback of the content on a basis of the cue.

11. The content playback system according to claim 1, wherein
the content playback controlling application further includes a context acquisition section that acquires a context of the user, and
the user state estimator estimates the user state on a basis of the acquired context.

12. The content playback system according to claim 6, wherein
the user location estimator includes
an angle correction section that calculates a correction value for an azimuth corresponding to the user on the basis of the detection value detected by the sensor section included in the wearable device worn by the user, and
an angle estimator that estimates the azimuth corresponding to the user on the basis of the detection value detected by the sensor section included in the wearable device worn by the user, and on a basis of the correction value, and
the user location estimator estimates the user location using the azimuth.

13. The content playback system according to claim 12, wherein
the sensor section included in the wearable device includes an acceleration sensor, and
the angle correction section
calculates an inclination of the user in a pitch direction and an inclination of the user in a roll direction, using gravitational acceleration that corresponds to the detection value detected by the acceleration sensor and occurs when the user faces the roll direction,
calculates an inclination of the user in a yaw direction using gravitational acceleration that corresponds to the detection value detected by the acceleration sensor and occurs when the user faces the pitch direction, and using the inclination in the pitch direction and the inclination in the roll direction, and
determines, to be the correction values, the inclination in the pitch direction, the inclination in the roll direction, and the inclination in the yaw direction.

14. The content playback system according to claim 1, wherein
the content controller successively plays back related pieces of content for respective environment states that are identical to each other but provided for different periods of time.

15. The content playback system according to claim 7, further comprising:
a database generator that associates a registration-use detection value detected by the sensor section with an environment state to be provided to the user when the registration-use detection value is detected, and registers the associated registration-use detection value and environment state; and
a matching section that checks a new detection value detected by the sensor section against the registered registration-use detection value to perform matching, and determines whether a difference between the new detection value and the registration-use detection value is less than or equal to a matching threshold, wherein
when the difference is determined to be less than or equal to the matching threshold, the content controller generates the cue on a basis of the environment state registered in association with the registration-use detection value, and outputs the generated cue.

16. The content playback system according to claim 15, wherein
when the user is at a stop for a first period of time, the matching section checks the new detection value with the registration-use detection value to perform matching, and
when a period of time for which the user is at a stop from the user stopping to the user starting moving is longer than a second period of time, the database generator associates the new detection value detected for the period of time from the user stopping to the user starting moving with an environment state to be provided to the user when the new detection value is detected, and newly registers the associated new detection value and environment state.

17. The content playback system according to claim 16, wherein
the database generator registers, as the registration-use detection value, an average of a plurality of the detection values detected by the sensor section for a specified period of time.

18. A content playback system, comprising:
a wearable device; and
an information processing apparatus that includes a control circuit that executes a content playback controlling application that includes
a database generator that associates a registration-use detection value detected by a sensor section included in the wearable device worn by a user with an environment state to be provided to the user when the registration-use detection value is detected, and registers the associated registration-use detection value and environment state,
a matching section that checks a new detection value detected by the sensor section against the registered registration-use detection value to perform matching, and determines whether a difference between the new detection value and the registration-use detection value is less than or equal to a matching threshold, and
a content controller that
generates, when the difference is determined to be less than or equal to the matching threshold, a cue on a basis of the environment state registered in association with the registration-use detection value, the cue being used by a content provision application providing content to select the content,
outputs the cue to the content provision application, and
causes the content provision application to select the content on a basis of the cue to cause the content to be played back.

19. An information processing apparatus, comprising
a control circuit that executes a content playback controlling application that includes
a user state estimator that estimates a user state of a user who is wearing a wearable device,
an environment estimator that estimates, on a basis of the user state, an environment state to be provided to the user, and
a content controller that
generates, on a basis of the environment state, a cue used by a content provision application providing content to select the content,
outputs the cue to the content provision application, and
causes the content provision application to select the content on a basis of the cue to cause the content to be played back.

20. A content playback controlling application that causes a control circuit of an information processing apparatus to operate as
a user state estimator that estimates a user state of a user who is wearing a wearable device,
an environment estimator that estimates, on a basis of the user state, an environment state to be provided to the user, and
a content controller that
generates, on a basis of the environment state, a cue used by a content provision application providing content to select the content,
outputs the cue to the content provision application, and
causes the content provision application to select the content on a basis of the cue to cause the content to be played back.
